(19) United States
(12) Patent Application Publication
(10) Pub. No.: US 2025/0332559 A1
(43) Pub. Date: Oct. 30, 2025

(54) SYSTEMS AND METHODS FOR COOLING AND SEPARATING CO-PRODUCTS FROM A PYROLYSIS SYSTEM

(71) Applicant: Modern Hydrogen, Inc., Woodinville, WA (US)

(72) Inventors: Erica Keenan, Kenmore, WA (US); Kristen M. Palughi, Seattle, WA (US); Christian Nubar Hovsepian Merseian, Bothell, WA (US); Patrick D. Noble, Seattle, WA (US); Sarah Whitaker, Woodinville, WA (US); Vikram Seshadri, Bothell, WA (US); John Joel Lorr, Monroe, WA (US); Matthew Gianni Equi Ibbotson, Seattle, WA (US); Nicolas Rijhwani, Woodinville, WA (US); Peter J. Scherpelz, Seattle, WA (US); Daniel Kraemer, Mukilteo, WA (US); Alex J. Pearse, Bothwell, WA (US)

(21) Appl. No.: 19/194,348

(22) Filed: Apr. 30, 2025

Related U.S. Application Data
(60) Provisional application No. 63/640,732, filed on Apr. 30, 2024.
(60) Provisional application No. 63/640,693, filed on Apr. 30, 2024.

(51) Int. Cl. B01J 6/00; B01D 53/04; C01B 3/24; C09C 1/50

(52) U.S. Cl. CPC B01J 6/008; B01D 53/0446; C01B 3/24; C09C 1/50; B01D 2256/16; B01D 2257/70; C01B 2203/0272; C01B 2203/048; C01B 2203/049; C01B 2203/0883; C01B 2203/1241

(57) ABSTRACT

Embodiments include a pyrolysis system including, in some instances, a pyrolysis reactor including a pyrolysis chamber to generate a product stream from a system feed, a plurality of separation components to separate the product stream, one or more heat exchange components coupled to one or more of the plurality of separation components, and a solids collection component to collect separated non-gas products. Some embodiments include a pyrolysis system including, in some instances, the pyrolysis reactor, the plurality of separation components including an adsorption separation component that includes a first and second adsorption component and a plurality of valves configured to control flow of the gas product stream and a flushing gas. Some embodiments include a pyrolysis system including the pyrolysis reactor, a regeneration feed, a plurality of valves, a burner, and one or more separation components. Some embodiments include a method of separating components of a product stream.

### RELATED APPLICATIONS

This application claims the benefit of U.S. Provisional Patent Application No. 63/640,732, filed Apr. 30, 2024, and U.S. Provisional Patent Application No. 63/640,693, filed Apr. 30, 2024, the entireties of each of which are incorporated herein by reference.

### FIELD

This disclosure relates generally to pyrolysis reactions. More particularly, the present disclosure relates to pyrolysis systems for separating and processing byproducts from such reactions.

### BACKGROUND

In pyrolysis of hydrocarbons, the hydrocarbon splits into hydrogen gas (H₂) and solid carbon (C). For example, the pyrolysis of the hydrocarbons (e.g., natural gas, methane, propane, and/or other suitable hydrocarbons) can produce hydrogen gas and solid carbon in a product stream, each of which can be used in downstream applications. Purely by way of example, hydrogen gas can replace a portion (or all) of the natural gas consumed by a furnace to heat a residential space (e.g., a home, apartment, and/or the like), a commercial building (e.g., a store, office building, and/or the like), and/or an industrial building or system (e.g., a datacenter, asphalt plant, steel mill, and or the like). The carbon co-product, meanwhile, can be utilized or sequestered to help prevent the carbon from being released downstream. In some embodiments, the carbon co-product is sequestered by integrating the carbon co-product into various carbon-containing products. Purely by way of example, the carbon co-product can supplement the bitumen (or other binders) in asphalt and/or other pavement products.

Before the hydrogen gas and solid carbon can be used in downstream applications, the co-products can be separated from each other. However, it can be difficult to separate the co-products of the pyrolysis reaction (for example, due to the high temperatures of the pyrolysis system).

### SUMMARY

In general, this disclosure is directed to pyrolysis reactions and, more particularly, to pyrolysis systems for separating and processing byproducts from such reactions. In one example, the present disclosure includes a pyrolysis system. The pyrolysis system can include a pyrolysis reactor including a pyrolysis chamber configured to generate a product stream from a system feed, where the system feed comprises a hydrocarbon reactant, and where the product stream comprises hydrogen gas and carbon. The pyrolysis system can also include a plurality of separation components configured to separate the product stream, where the plurality of separation components are downstream from the pyrolysis reactor. The pyrolysis system can also include one or more heat exchange components coupled to one or more of the plurality of separation components. The pyrolysis system can also include a solids collection component configured to collect non-gas products separated from the product stream by the plurality of separation components, where the non-gas products comprise at least the carbon.

In another example, the present disclosure includes a pyrolysis system. The pyrolysis system can include a pyrolysis reactor including a pyrolysis chamber configured to generate a product stream from a system feed, where the product stream comprises hydrogen gas, one or more organic compounds, and carbon. The pyrolysis system can also include a plurality of separation components downstream from the pyrolysis reactor. The plurality of separation components can include one or more separation components, where a first separation component separates the carbon from the product stream, resulting in a gas product stream. The plurality of separation components can also include an adsorption separation component, where the adsorption separation component includes: a first adsorption component comprising one or more adsorptive materials that are configured to remove the one or more organic compounds from the gas product stream, a second adsorption component comprising one or more adsorptive materials that are configured to remove the one or more organic compounds from the gas product stream, and a plurality of valves operably coupled to the first adsorption component and the second adsorption component, where the plurality of valves are configured to control a flow of the gas product stream and a flushing gas through the first adsorption component and the second adsorption component, and where the flushing gas is a process gas.

In another example, the present disclosure includes a pyrolysis system. The pyrolysis system can include a pyrolysis reactor including a pyrolysis chamber configured to generate a product stream from a system feed, where the system feed comprises a hydrocarbon reactant, and where the product stream comprises hydrogen gas and carbon. The pyrolysis system can also include a regeneration feed, where the pyrolysis reactor is configured to react a regeneration input with residual carbon in the pyrolysis chamber to generate a regeneration effluent stream that is output from the pyrolysis reactor, and where only one of the system feed and the regeneration feed can be in the pyrolysis reactor at a time. The pyrolysis system can also include a plurality of valves configured to control a flow of the system feed into the pyrolysis reactor and a flow of the regeneration input into the pyrolysis reactor. The pyrolysis system can also include a burner coupled to the pyrolysis reactor. The pyrolysis system can also include one or more separation components downstream from the pyrolysis reactor, wherein at least one of the one or more separation components is configured to separate the carbon from the product stream.

In another example, the present disclosure includes a method of separating components of a product stream. The method can include providing a pyrolysis system. The pyrolysis system can include a pyrolysis reactor including a pyrolysis chamber configured to generate the product stream from a system feed, where the product stream comprises hydrogen gas and carbon. The pyrolysis system can also include a plurality of separation components configured to separate the product stream, where the plurality of separation components are downstream from the pyrolysis reactor. The pyrolysis system can also include one or more heat exchange components coupled to one or more of the plurality of separation components. The pyrolysis system can also include a solids collection component coupled to one or more of the plurality of separation components. The method can also include controlling a flow of the product stream through the pyrolysis system.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic diagram of a pyrolysis system, according to an embodiment.

FIG. 2 is a schematic illustration of an airlock valve, according to an embodiment.

FIGS. 3A and 3B are schematic illustrations of examples of gravity settlers, according to an embodiment.

FIG. 4 is a schematic illustration of a separation component, according to an embodiment.

FIG. 5 is a schematic diagram of a pyrolysis system with a solids collection component, according to an embodiment.

FIGS. 6A and 6B are schematic illustrations of solids-gas separation components for solids collection, according to an embodiment.

FIG. 7 is a schematic diagram illustrating a modular pyrolysis system, according to an embodiment.

FIGS. 8A and 8B illustrate regeneration results graphs, according to an embodiment.

FIG. 9 is a schematic diagram of a separation component for a pyrolysis system, according to an embodiment.

FIG. 10 is a flow diagram of a method for regenerating a separation component of a pyrolysis system, according to an embodiment.

FIG. 11 is a schematic diagram of a pyrolysis system with adsorption components, according to an embodiment.

FIG. 12 is a schematic diagram of a pyrolysis system with adsorption components, according to an embodiment.

FIG. 13 is a schematic diagram of a pyrolysis system with adsorption components, according to an embodiment.

FIG. 14 is a schematic diagram of a pyrolysis system with an adsorption component, according to an embodiment.

FIG. 15 is a schematic diagram of a system with adsorption components, according to an embodiment.

FIG. 16 is a schematic diagram of a system with adsorption components, according to an embodiment.

FIG. 17 is a schematic diagram of a system with adsorption components, according to an embodiment.

FIG. 18 is a schematic diagram of a system with adsorption components, according to an embodiment.

FIG. 19 is a schematic diagram of a pyrolysis system, according to an embodiment.

FIGS. 20A and 20B are block diagrams of a simple regeneration process flow for a pyrolysis system, according to an embodiment.

FIG. 21 is a schematic diagram of a pyrolysis system with regeneration capabilities and a plurality of reactors, according to an embodiment.

FIG. 22 is a flow chart of an example method of separating components of a product stream from a reactor, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Pyrolysis reactors heat hydrocarbon reactants (e.g., methane, natural gas, ethane, propane, butane, pentane, gasoline, diesel, kerosene, and/or the like) to decompose them into hydrogen gas, solid carbon, and various products. For example, pyrolysis reactors can decompose the methane, ethane, propane, and other hydrocarbon components in natural gas to generate hydrogen gas. In the example of methane, the pyrolysis reaction is:

CH₄(gas)→C(solid)+2H₂(gas).

The hydrogen gas co-product (H₂) can then be substituted as the combustion fuel anywhere the natural gas would have been used. For example, the hydrogen gas can be consumed by various heating units (e.g., furnaces, water heaters, water boilers, steam boilers, and/or the like), combustion engines, fuel cells and/or power generators (e.g., in a backup power generator), combined heat and power systems, cooking units (e.g., gas stoves), and/or in various other suitable uses. Additionally, or alternatively, the hydrogen can be used in various industrial processes, such as producing various ammonia-based products (e.g., ammonia fertilizers), providing process heat, and/or other chemical processing industries and/or injected back into the natural gas pipeline to partially decarbonize the natural gas in the pipeline. The carbon co-product, meanwhile, can be sequestered and/or utilized to decarbonize the consumption of the natural gas. In some embodiments, the carbon co-product is sequestered by integrating the carbon co-product into various carbon-containing products. Purely by way of example, the carbon co-product can supplement the bitumen (or other binders) in asphalt and/or other pavement products.

Pyrolysis systems implement the pyrolysis reaction to break down hydrocarbons (e.g., natural gas, pure methane, ethane, propane, butane, and/or other suitable hydrocarbons) into hydrogen gas and solid carbon. Examples of suitable pyrolysis systems are disclosed in U.S. Non-Provisional patent application Ser. No. 17/337,326 filed Jun. 2, 2021, now issued as U.S. Pat. No. 11,897,768, U.S. Non-Provisional patent application Ser. No. 17/832,516 filed Jun. 4, 2021, now published as U.S. Patent Application Publication No. 2022/0387952, U.S. Non-Provisional patent application Ser. No. 17/503,187 filed Oct. 15, 2021, now published as U.S. Patent Application Publication No. 2022/0120217, U.S. Non-Provisional patent application Ser. No. 17/710,810 filed Mar. 3, 2022, now published as U.S. Patent Application Publication No. 2022/0315424, U.S. Provisional Patent Application No. 63/592,904 filed Oct. 24, 2023, and U.S. Provisional Patent Application No. 63/592,906 filed Oct. 24, 2023, the entireties of each of which are incorporated herein by reference. In such pyrolysis systems, the solid carbon (and byproducts from the pyrolysis reactor) must be removed from the product stream before the product gases (hydrogen gas, unreacted hydrocarbons, and/or various other gases) can be consumed.

The product stream, however, typically exits the pyrolysis reactor at a relatively high temperature, such as temperatures between about 500 degrees Celsius (° C.) and about 1500° C. The relatively high temperatures can be too hot for hydrogen-carbon separation systems and/or byproduct separation systems to handle. Further, handling the relatively high temperatures can be complicated by limited access to utilities such as water, inert gasses (e.g., helium, nitrogen, argon, and/or the like), and/or the like. In addition, the particles of solid carbon bin the product stream can have a wide range of sizes (e.g., ranging from about 1 micrometer (μm) to about 30 millimeters (mm)). The wide range of particle sizes cannot be captured in a single separation system. Still further, the hydrogen gas resulting from the pyrolysis system needs to be at a temperature and pressure that is compatible with various endpoints, such as existing natural gas lines connected to a furnace, water heater, water boiler, and/or the like.

Systems and methods that address these challenges to separate hydrogen gas, solid carbon, and/or byproducts in the product stream from a pyrolysis reactor are discussed herein. For example, a pyrolysis system according to the present technology can treat the hot, mixed-phase product stream from the pyrolysis reactor to isolate and/or formulate products (e.g., hydrogen gas, solid carbon, and the like) with a suitable chemical composition, pressure, and temperature for supply to a downstream location, distribution network, storage device, and/or any other suitable endpoint.

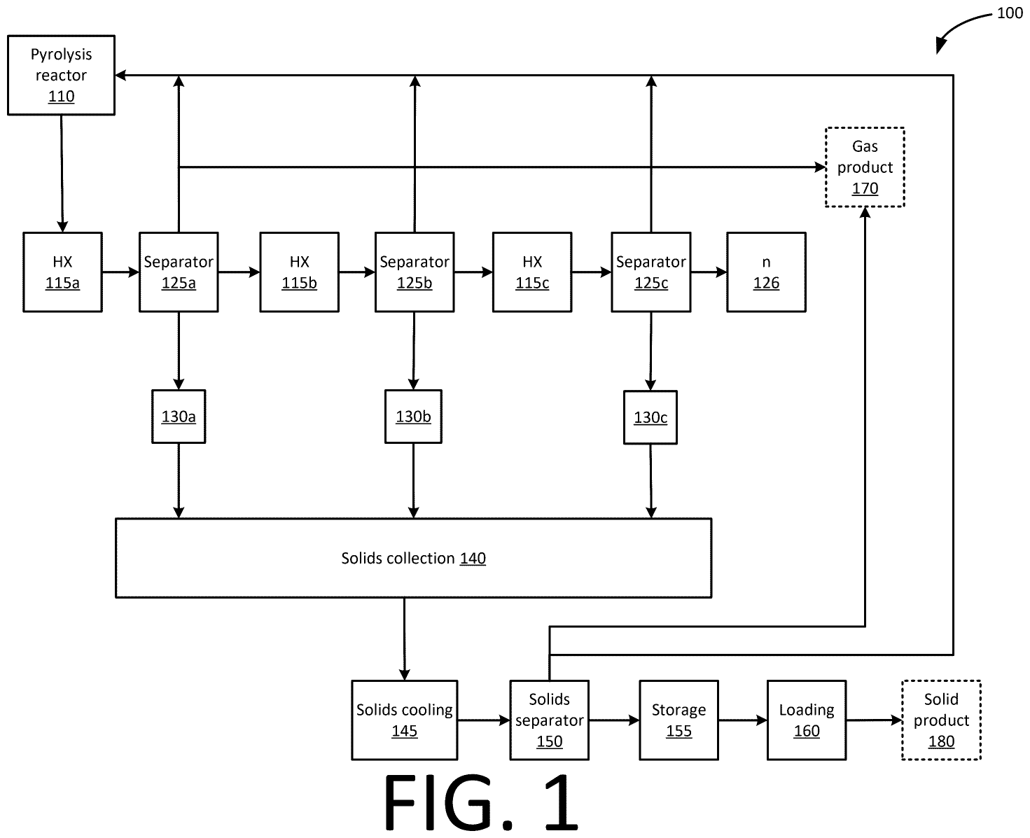

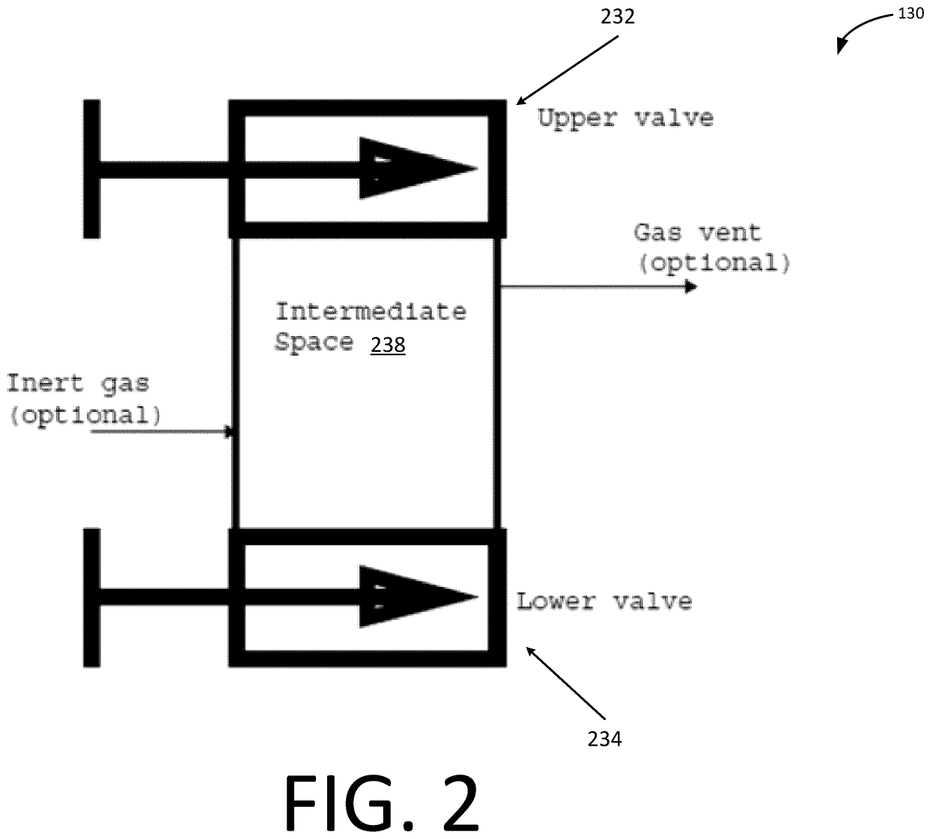

For example, FIG. 1 is a schematic diagram of a pyrolysis system 100 configured in accordance with some embodiments of the present technology. As illustrated, the pyrolysis system 100 can include a pyrolysis reactor 110 as well as a plurality of separation components 125 and a plurality of heat exchange components 115 each operably coupled downstream from the pyrolysis reactor. The separation components can include separator 125a, separator 125b, separator 125c, etc. Although three separation components/separators 125 are depicted, the pyrolysis system 100 can include any number of separation components 125.

In some embodiments, as depicted in FIG. 1, the pyrolysis system 100 can include one or more heat exchange components 115. FIG. 1 depicts a plurality of heat exchange components-HX 115a, HX 115b, HX 115c, etc. In this exemplary embodiment, each heat exchange component 115 may be a heat exchanger (HX) 115. Heat exchangers/heat exchange components 115 are used to improve the thermal efficiency of the overall system (e.g., system 100) by cooling the products; heating the pyrolysis feed, the pre-combusted fuel, the air for combustion, etc.; and/or providing heat to external users (i.e. steam generators, power generators, adsorption chillers, etc.). In some embodiments, although FIG. 1 depicts three heat exchange components 115, the pyrolysis system 100 can include any number of heat exchange components 115. For example, component n 126 is depicted to represent any additional components such as an additional HX n, additional separator n, etc.

In some embodiments, the separation components 125 can be coupled to the product stream (outputted from the pyrolysis reactor 110) sequentially to remove solids, liquids, condensable gases, and/or mixtures thereof from the product stream. The heat exchange components 115 can be positioned at various stages to adjust a temperature of the product stream to help facilitate separation in the separation components 125, transfer heat from the product stream to another location (e.g., hydrocarbon reactants coming into the pyrolysis reactor), and/or reduce downstream fouling and degradation. In some embodiments, as depicted in FIG. 1, one or more of the separation components 125 can, in some instances, be configured to transmit hydrogen gas product (and/or the product stream containing at least hydrogen gas product) back to the pyrolysis reactor 110.

In the illustrated embodiment, the heat exchange components 115 and the separation components 125 are alternatingly coupled to the product stream from the reactor 110, beginning with a first heat exchange component 115a (e.g., a first heat exchanger), followed by a first separation component 125a, a second heat exchange component 115b, and so on. As a result, as discussed in more detail below, the first heat exchange component 115a can cool the product stream to a first temperature that is suitable for the first separation component 125a; the first separation component 125a can remove one or more products and/or byproducts from the product stream; the second heat exchange component 115b can cool the product stream to a second temperature that is suitable for the second separation component 125b; and so on. In some embodiments, although FIG. 1 depicts a first heat exchange component 115a and then a first separation component 125a, the pyrolysis system 100 can include other configurations. For example, the product stream from the pyrolysis reactor 110 can be transmitted directly to a first separation component 125a, then to a heat exchange component 115b, then to a second separation component 125b, and so on.

The resulting product stream (after being transmitted through the plurality of separators 125) can be primarily (or entirely) gas products 170 from the reactor 110, such as hydrogen gas, unreacted hydrocarbons, and/or the like. The gas products 170 can then be directed/transmitted to a suitable endpoint. For example, a portion of the gas product 170 can be directed back to the reactor 110 (for example, to fuel a combustion component (e.g., combustion component 1113, discussed further herein) and provide the input heat for the pyrolysis reaction, as an input to a reaction chamber within the pyrolysis reactor 110, and/or for use with any other component(s) of the reactor 110). Additionally or alternatively to the previous example, a portion of the gas product 170 can be directed to a hydrogen consuming system (e.g., a furnace, water heater, water boiler, manufacturing facility, and/or the like).

In the illustrated embodiment, the pyrolysis system 100 includes at least three separation components 125 that remove solid carbon from the product stream and direct/transmit the solid carbon into a solids collection component 140. Therefore, in some embodiments, the solids collection component 140 is coupled to one or more separation components 125 (in this example, three separation components 125). In some embodiments, while the separation component(s) 125 may be coupled to the solids collection component 140, there may still be one or more components between the separation component(s) 125 and the solids collection component 140. For example, as discussed further herein and depicted in FIG. 1, there may be one or more airlocks 130 between the separation component(s) 125 and the solids collection component 140.

As also discussed in more detail below, the use of multiple separation components 125 allows the pyrolysis system 100 to separate a wider range of particles from the product stream. Purely by way of example, the separators/separation components 125 can be configured to focus on gradually decreasing sizes of carbon particles, resulting in an overall separation system that is effective to separate a wide range of carbon particles.

As further illustrated in FIG. 1, the solids collection component 140 then directs the solids (e.g., solid carbon, other particulates, and/or any other suitable compounds (e.g., organic compounds, pyrolysis oils, and/or the like)) to a solids cooling component 145 for further cooling. The solids cooling component 145 can then direct the solids (and/or oils and/or liquids carried thereby) to a solids separator 150 to separate carbon from other particulates, separate carbon particles of different sizes, separate fluid compounds from the solid compounds, and/or the like. While the solids collection component 140 is referred to as collecting and directing solids, these solids can include oils, liquids, etc. in addition to the solids, thus solids (as referred to herein) can be a mixture containing solids, in some instances. Various portions of the results can then be directed back to the reactor 110 (e.g., to break down organic compounds), into the resulting gas product 170 (e.g., to be fed back to a combustion component in the reactor), and/or to another suitable endpoint (e.g., storage, a carbon-sequestering endpoint, and/or the like). For example, FIG. 1 depicts at least a portion of the results (e.g., the separated carbon) being transmitted to storage 155, then to a loading component 160, and to a solid product 180 endpoint.

Multiple monitoring instruments can be used to help ensure the pyrolysis system 100 is meeting operating requirements. For example, the pyrolysis system 100 can include one or more temperature monitoring devices to help reduce the chance that downstream storage equipment is damaged and/or deteriorated by excessive heat; the pyrolysis system 100 can include one or more gas composition monitors within the product stream to measure the composition therein and check for a mixture capable of supporting combustion. Further, the measurements can be integrated with a control system that adjusts control elements to maintain product quality to customer specifications, reduce operating cost, and reduce environmental impact (e.g., carbon intensity), and/or the like. The control system can be configured with logic to perform these functions without human intervention.

In addition to the challenges discussed above, the systems and methods disclosed herein can be configured to address additional challenges and/or meet additional goals. For example, it can be advantageous for the pyrolysis system 100 to have a relatively small footprint within a target destination and/or for the pyrolysis system 100 to be relatively simple to construct at the target destination. The small footprint and/or easy construction can allow the pyrolysis system 100 to be retrofitted into existing spaces (e.g., added to homes, apartment buildings, commercial buildings, processing facilities, and/or the like) and/or constructed in a wide variety of locations. Additionally, or alternatively, the small footprint can allow the pyrolysis system 100 to be enclosed in an aesthetically pleasing housing, which can increase the chance that the pyrolysis system 100 is adopted into existing spaces to decarbonize our grid. To help meet these goals, the pyrolysis system 100 can have a modular construction that helps reduce an overall size of the system, allows the system to be tailored specifically to an end-user's requirements, be deployed in more locations, and/or reduce the cost of constructing (and/or the time required to construct) the pyrolysis system.

For example, a significant portion of the construction of the pyrolysis system 100 can be performed at a location other than the target site (e.g., in a central manufacturing location); the partially or fully constructed unit (e.g., pyrolysis system 100) can include one or more modules; the size of the modules can be at least partially dictated by transportation methods, cost of transportation, and/or transportation complexity; the partially constructed units (e.g., partially constructed pyrolysis system 100) can be shipped to various geographic locations; the partially constructed unit may be shipped by various means (e.g., on-road truck, container ship, rail, barge, etc.); final assembly of the pyrolysis system 100 can be completed at the target site; final construction can include stacking, arranging, and/or coupling multiple modules; the assembled pyrolysis system 100 can have a vertical height that is less than or equal to about 20 feet, between about 20 feet and about 40 feet, between about 40 feet and about 60 feet, between about 60 feet and about 80 feet, up to 200 feet (e.g., between 20 feet and 200 feet), etc. depending on various other aspects of the pyrolysis system 100 (e.g., flow rate of hydrocarbons into the pyrolysis reactor, available shipping methods, and/or the like); the assembled pyrolysis system 100 can be contained within a cross-sectional area (e.g., a “footprint”) between about 200 square feet (sq ft) and about 400 sq ft, between about 400 sq ft and about 600 sq ft, between about 600 sq ft and about 800 sq ft, up to 100,000 sq ft (e.g., between 200 sq ft and 100,000 sq ft), etc.; control panels for the pyrolysis system 100, required utilities (e.g., instrument air), and/or carbon storage and/or loading can be located outside the main footprint of the pyrolysis system 100; etc.

As discussed in more detail below, the fully assembled pyrolysis system 100 can be divided into containerized subassemblies that can be arranged and/or customized to a variety of product requirements. Subassembly containers can include a pyrolysis reactor container, a product conditioning container, and a solids handling container. The solids handling container can be positioned vertically below the pyrolysis reactor container and the product conditioning container. This positioning can allow the pyrolysis system 100 to have combinations of different sizes and counts of each container to be easily integrated for different overall performance considerations (e.g., hydrogen and carbon output). Purely by way of example, to adjust the size of the solids handling system and/or to incorporate different equipment, the elevation of the reactor and product conditioning containers can be adjusted through a change to the supporting structure.

In another example of the additional challenges and/or to meet additional goals, the pyrolysis systems discussed herein (e.g., pyrolysis system 100) can be deployed in locations with limited (or no) access to utilities such as water, sewer, inert gasses, and/or the like. Additionally, or alternatively, some utility streams (e.g., water) require additional inputs, outputs, and/or processing steps (e.g., chemical treatment of water, excess venting for steam, and/or the like) that can increase the cost and complexity of the overall system. Accordingly, it can be advantageous to limit (or eliminate) the need to rely on utilities aside from a supply of the hydrocarbon reactant (e.g., natural gas) or, in some instances, a supply of the hydrocarbon reactant and electricity. For example, in some embodiments, the pyrolysis system 100 does not require water from a peripheral system (e.g., via a closed-loop circulation system) and/or does not require water at all. As an example, in instances where steam is used as a regeneration gas (discussed further herein), the pyrolysis system 100 may use water, but this water can be provided by combustion of natural gas and hydrogen, which can help prevent the need for water from a separate system and/or tank. In some embodiments, the utilities are supplied by an on-site container (e.g., water tank) that requires the pyrolysis system 100 to use a limited amount of the utility for operation. The limited reliance can be useful even when access to utilities is available to, for example, eliminate (or limit) the need for peripheral plumbing systems and/or to help simplify operation of the pyrolysis system 100.

In a specific, non-limiting example, the pyrolysis systems discussed herein (e.g., pyrolysis system 100) can limit (or eliminate) water consumption through adjustments to heat management and/or cooling systems in the pyrolysis system 100. For example, the pyrolysis system 100 can use recuperative devices to recover high-temperature heat through process-to-process heat transfer (e.g., instead of direct-contact water-cooling components). The recuperative devices include a heat pipe, plate and frame, shell and tube, direct contact heat exchangers, and/or various other suitable devices. Lower-temperature heat removal can be obtained through closed-loop indirect cooling methods that do not require significant water replenishment and/or discharge rates. Components of indirect cooling systems can include air cooled heat exchangers, cooled conveyors, shell and tube heat exchangers, plate and frame heat exchangers, moving bed heat exchangers, and/or various other suitable devices. Any of the elements discussed above can be used individually or in sequence throughout the pyrolysis system 100. Further, excess heat can be recovered to colder process streams (e.g., recuperated, rejected to ambient air, and/or rejected into closed-loop cooling water systems).

Water consumption and effluent generation also frequently occurs in systems that separate solids from gases. For example, wet scrubbing devices can effectively remove a wide variety of solid particulates, but require significant amounts of fluids and can require fluid treatment systems for the effluent fluids. The systems and methods discussed herein can use only “dry” equipment to perform separations, thereby eliminating the water (or other fluids) consumption. However, as discussed in more detail below, eliminating water (and other fluid) consumption can introduce constraints on how components of the system 100 (e.g., solid separators and/or separation components 125) are arranged in the process flow. Further, in some instances, the systems and methods discussed herein may not generate or consume steam in the operation of the pyrolysis system 100. Instead, in these instances, natural gas, methane, ethane, propane, nitrogen, or other inert gases are used for adsorber regeneration, gas stripping/displacement, pressure testing, and/or the like. In some instances, steam may be generated and used as a regeneration oxidizer for the reactor (discussed further herein). In these instances, as an example, the steam can be generated from combustion of natural gas and hydrogen.

In a specific, non-limiting example, the pyrolysis systems discussed herein (such as pyrolysis system 100) can limit (or eliminate) inert gas consumption. For example, natural gas, product gas, and/or air concentrations sufficient to maintain the system below flammability limits can be used in components where nitrogen or inert is typically consumed. The reduction (or elimination) of inert gasses in the pyrolysis system 100 can help reduce operating cost and/or help simplify operation and maintenance of the pyrolysis system 100.

In another example of the additional challenges and/or to meet additional goals, the pyrolysis systems discussed herein (such as pyrolysis system 100) can include features that help the hydrogen gas product 170 and/or solid carbon product 180 resulting from the pyrolysis system 100 be compatible with endpoints. For example, the pyrolysis system 100 can operate at a pressure that helps match the pressure in the product stream to an endpoint for the hydrogen gas without requiring additional gas compression equipment. Purely by way of example, the pyrolysis system 100 can operate at a pressure between about 1 bar gauge (barg) and about 2 barg, between about 2 barg and about 3 barg, between about 3 barg and 5 barg, between about 5 barg and about 10 barg, and/or between about 10 barg and about 15 barg. However, in some embodiments, the pyrolysis system 100 includes a compression component coupled to the hydrogen gas stream flowing out of the pyrolysis system 100 and/or pyrolysis reactor 110. In such embodiments, the product stream can be compressed (e.g., to pressures as high as about 700 bar) as suitable for various endpoint uses. To help limit the pressure drop in the pyrolysis system 100, the gas-solids separation components 125 can be limited to gas flowrates between about 2 meters per second (m/s) and about 5 m/s, between about 5 m/s and about 10 m/s, between about 10 m/s and about 20 m/s, and/or between about 20 m/s and about 30 m/s. Maintaining the pressure in the pyrolysis system 100 can result in recycle and/or waste gas streams that can be reinjected into a process location without the use of a compressor. Further, the operating pressure of reinjection locations can be optimized to remain below the recycle stream generation pressure. For example, effluent gases from continuous gas analyzers can be incorporated into an energy source for the pyrolysis reactor 110 (such as a combustion fuel system and/or another type of energy source). To do so, the pressure drop through the gas analyzer must be minimized and/or some (or all) of the combustion fuel system must be maintained at a pressure lower than the analyzer exit pressure (e.g., to avoid sucking gas backward through the pyrolysis system). In some embodiments, the pyrolysis system 100 includes less complex and cheaper static devices (e.g., ejectors) instead of mechanical compressors and blowers to help maintain (or increase pressure) along the flow path.

Still further, the pyrolysis system 100 can help ensure that the resulting hydrogen gas (e.g., gas product 170) is relatively free of solid carbon (e.g., which will become carbon dioxide on combustion) and/or byproducts from the pyrolysis reaction. In some embodiments, the pyrolysis system 100 includes additional purification devices downstream from the separation components 125. These additional purification devices can include adsorption components, as discussed further herein. As a result, the pyrolysis system 100 helps minimize downstream fouling and/or emissions that undermine the effects of replacing hydrocarbons with the hydrogen gas from the pyrolysis reactor 110. In yet another example, the pyrolysis system 100 can collect, condition, and/or mix the solid carbon with other byproducts to help prepare the solid carbon product for an endpoint use.

Although primarily discussed herein as systems and methods for separating products (and byproducts) in the product stream from a pyrolysis reactor 110, one of skill in the art will understand that the scope of the technology is not so limited. For example, the systems and methods discussed herein can be employed in a variety of other settings to separate the co-products and/or byproducts of a reactor, chemical manufacturing process, and/or the like under constraints from heat, pressure, and/or attributes of the co-products and byproducts. Accordingly, the scope of the technology is not confined to any subset of embodiments discussed herein.

In some embodiments, the product stream from the pyrolysis reactor 110 (e.g., the outlet of the pyrolysis reactor 110) can have a pressure above atmospheric and/or ambient pressures. Maintaining the pressure in the product stream can allow the resulting hydrogen gas (e.g., gas product 170) to be delivered to an endpoint without requiring additional gas compression equipment and/or can maintain the resulting hydrogen gas at a pressure suitable for existing natural gas pipelines. However, the relatively high pressures can impact the operation of the solids collection component 140 and/or increase the complexity of operating the solids collection component 140. Accordingly, it is beneficial to operate the solids collection component 140 at atmospheric and/or ambient pressures. As a result, the gas/solid phase separators (i.e., separation components 125) must operate at a relatively high pressure compared to the solids collection component 140.

To help bridge between the two, the pyrolysis system 100 can include an airlock valve arrangement (comprising one or more airlocks 130). FIG. 1 depicts three airlocks, airlock 130a, airlock 130b, and airlock 130c. In some embodiments, the airlock valve arrangement can include an airlock 130 for each separation component 125 (as depicted in FIG. 1).

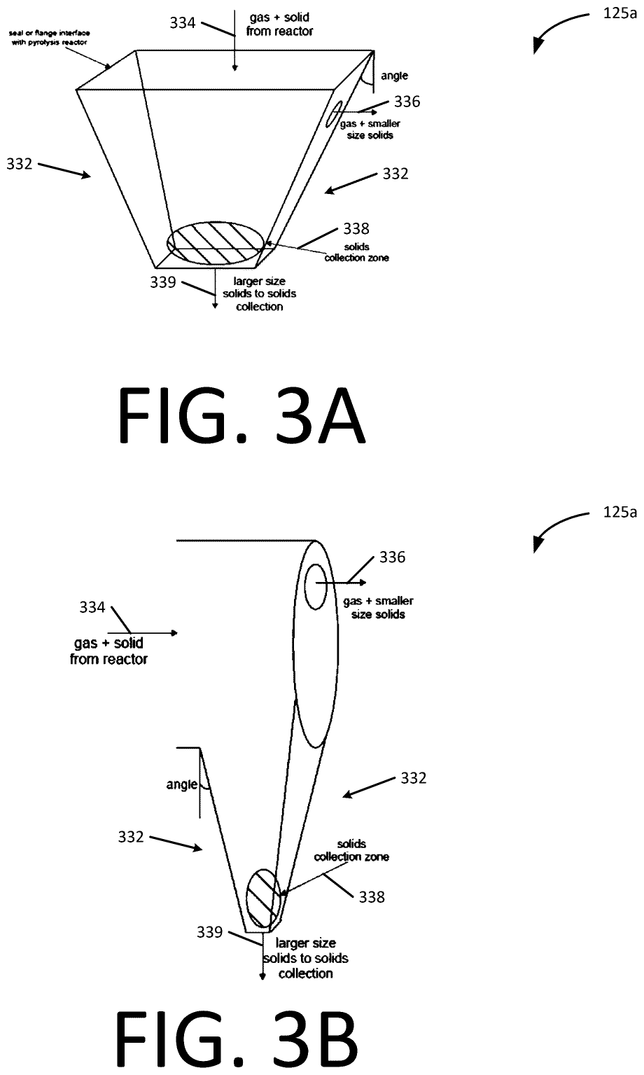

FIG. 3 illustrates an example airlock 130, according to an embodiment. As illustrated in FIG. 3, an airlock 130 can include two suitable valves (e.g., upper valve 232 and lower valve 234) and an intermediate space 238 between the valves 232, 234. The intermediate space 238 can be constructed from a piping component, hopper, small vessel, and/or any other suitable component. The valves 232, 234 can be constructed from a material that is able to withstand (and operate at) temperatures greater than about 1000° C., between about 900° C. and 1000° C., between about 700° C. and about 900° C., and/or between about 500° C. and about 700° C., depending on the stage in the separation process. Additionally, or alternatively, the valves 232, 234 can be integrated with active cooling features, additional heat exchangers, and/or internal tolerances to withstand the temperatures. In various embodiments, valves 232, 234 can include any combination of gate, ball, segmented ball, tight closure butterfly, and/or other suitable valve types.

In addition to temperature tolerances, the airlock(s) 130 (and valves 232, 234 therein) must be able to seal against a differential pressure between about 0.5 barg and about 1 barg, between about 1 barg and about 2 barg, between about 2 barg and about 3 barg, between about 3 barg and 5 barg, between about 5 barg and about 10 barg, and/or between about 10 barg and about 15 barg to limit gas flow from the product stream (high pressure system) to the solids collection component 140 (low pressure system). To help maintain a gas-tight seal, the valves 232, 234 can include any of the features above as well as (or alternatively) live loaded seals, multiple or tandem seals, high integrity scrapers, and/or components made from materials that are softer than steel (e.g., graphite).

In some embodiments, the pyrolysis system 100 includes a control to operate the valves 232, 234. In such embodiments the control system can, close both the upper valve 232 and lower valve 234 and empty the intermediate space 238 of solids. Additionally, the control system can bring the intermediate space 238 to any suitable pressure. The control system can open the upper valve 232, allowing solids to flow into the intermediate space 238 and allowing the pressure in the intermediate space 238 to equalize with the high pressure system (e.g., the product stream). The control system can then close the upper valve 232. The control system can then open the lower valve 234, allowing solids to flow into the downstream equipment (e.g., the solids collection component 140). While the lower valve 234 is open, a small volume of high pressure gas is transmitted into the low pressure system and the intermediate space 238 pressure equalizes with the low pressure system. The control system can then close the lower valve 234, thereby completing one cycle of emptying the separation component 125 coupled thereto. Because the intermediate space 238 is at a relatively low pressure when the upper valve 232 opens in the second cycle, the pressure can help pull solids into the intermediate space 238.

In some embodiments, the control system is configured to dynamically adjust the duration of any of the steps discussed above. For example, the cycles can be completed frequently enough to prevent solids from over-accumulating in the upstream equipment (e.g., the separation components 125). However, it is desirable to perform the sequence as infrequently as possible to expand the lifetime of the valves 232, 234 in the airlock 130 and/or to minimize the amount of maintenance required due to wear in the system. In various embodiments, the intermediate space 238 can be sized to transmit sufficient solids with 5 to 1 valve cycles/minute, 1 cycle/minute to 1 cycle/2 minutes, 1 cycle/2 minutes to 1 cycle/10 minutes, and/or 1 cycle/10 minutes to 1 cycle/hour.

In some embodiments, the solids collection component 140 (and/or systems downstream from the solids collection component) is capable of operating at relatively high pressures. For example, the solids collection component 140 (and/or downstream systems) can operate at pressures of about 1 barg to about 2 barg, about 2 barg to about 3 barg, about 3 barg to about 5 barg, about 5 barg to about 10 barg, and/or about 10 to about 15 barg. In such embodiments, the solids collection component 140 (and/or downstream systems) can have custom features such as cylindrical shapes, external stiffeners, thicker materials of construction, specialized seals, flanges, and/or gaskets that help the systems tolerate the relatively high pressures.

Referring back to FIG. 1, as discussed above, the pyrolysis system 100 (e.g., the separation components 125 within the pyrolysis system 100) must reliably remove solid carbon (and various byproducts) from the product stream to avoid fouling downstream components. Additionally, any carbon remaining in the product stream after the separation components 125 will eventually be transformed into carbon dioxide emissions when the hydrogen gas is combusted, thereby increasing a carbon intensity of the pyrolysis process and/or undermining one of the goals of the pyrolysis system overall. Further, the separation system (e.g., including separation components 125) should be operable at relatively high temperatures (e.g., upward of 500° C.) and pressures (e.g., upward from 1 barg) while removing particles with widely varying sizes. Still further, in some embodiments, the pyrolysis system 100 has limited access to utilities such as water and/or inert gasses to support the operation of the separation system/separation components 125 (e.g., to support particle separation in a wet gas scrubber, venturi scrubber, and/or the like that used in other settings to separate particles with a diameter less than about 10 μm). Still further, the separation system/separation components 125 should be able to remove solid particles (and byproducts) with relatively small residence times to support continuous (or generally continuous) operation of the pyrolysis reactor 110 and to meet demands for hydrogen gas (e.g., gas product 170). As a result, the separation system/separation components 125 typically cannot rely on low superficial gas velocity, long residence time, and/or only gravitational effects to provide separation because such systems cannot support the flow rate of the product stream.

To address these challenges, the separation system of the pyrolysis system 100 can include a plurality of gas/liquid/solid phase separation components 125 that are arranged sequentially. Each of the separation components 125 can be have a different design and/or operation principle such that each of the separation components 125 can remove solids of a different size and/or remove specific byproducts in the product stream (e.g., organic compounds, pyrolysis oils, and/or the like). In some embodiments, the separators/separation components 125 are positioned to remove particles in order of largest to smallest, then to remove various liquids and/or gasses. This arrangement of the separation components 125 can help limit equipment fouling and plugging. In some embodiments, the separation components 125 (and/or heat exchangers/heat exchange components 115) are sequenced from high to low temperature to help increase a thermal efficiency of the pyrolysis system 100 (e.g., by avoiding a need to re-heat the product stream).

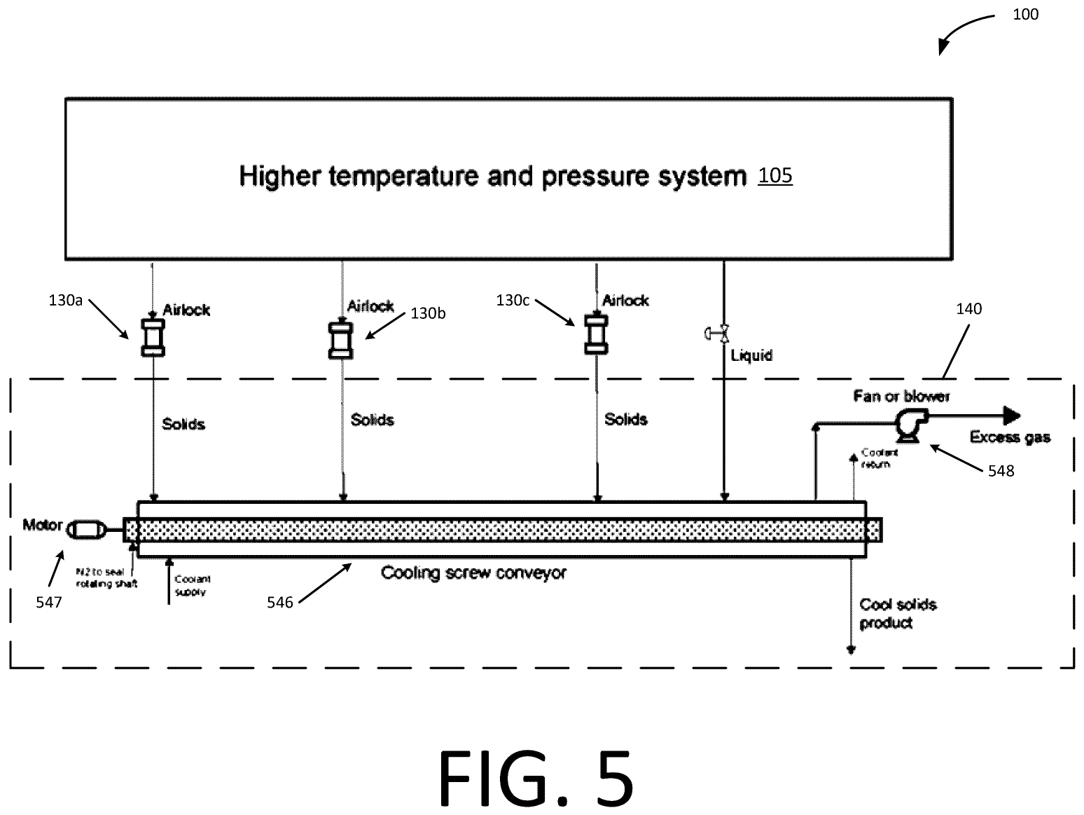

Purely by way of example, the first separator/separation component 125a of FIG. 1 can include a gravity settler that is configured to remove solids with a particle size of between about 50 μm and about 100 μm, between about 100 μm and about 500 μm, and/or between about 500 μm and about 25 mm. Examples of suitable gravity settlers are illustrated in FIGS. 5A and 5B.

Because the first separator/separation component 125a is closest to the pyrolysis reactor 110, the first separator 125a can operate at the highest temperatures in the separation system, such as temperatures that are greater than about 1000° C., between about 900° C. and 1000° C., between about 700° C. and about 900° C., and/or between about 500° C. and about 700° C. To help withstand the temperatures and/or increase a service life of the first separator 125a, the first separator 125a can include various alloys that are resistant to hydrogen embrittlement and wear at the elevated temperatures. In specific, non-limiting examples the first separator 125a can include (or be made entirely of) austenitic stainless steels 316, 316H; nitrided alloys such as Nitronic 50, Nitronic 60; hardfaced coatings; and/or the like. Additionally, or alternatively, the first separator 125a can include seals and/or flanges (e.g., class 300, ASME B16.5) that are suitable for hydrogen-rich gas pressure in the product stream.

As illustrated in FIGS. 3A and 3B, the first separation component 125a can include sloped walls 332, an inlet 334 on one side of the settler, a gas outlet 336 (for example, opposite the inlet 334), and a solids collection zone 338 located at the bottom of the settler. The solids collection zone 338 can be connected to the airlock components (e.g., airlocks 130). The sloped walls 332 can have an angle of between about 5 degrees (“deg”) from vertical to about 15 deg from vertical, between about 15 and about 30 deg, between about 30 deg and about 45 deg, and/or between about 45 and about 60 deg to prevent solids accumulation along the sidewalls and/or anywhere else in the vessel aside from the collection zone 338. Further, the first separation component 125a can have a larger cross-sectional area than a flow path upstream from the first separator/separation component (e.g., the reactor, pipes coupled to the reactor, and/or the like). The larger cross-sectional area can decrease gas velocity through the first separator/separation component 125a to help promote solids settling into the solids collection zone 338 due to gravitational forces. That is, separation can be accomplished in the first separation component 125a without the use of internal penetrations such as mesh pads, screens, filters, baffles, and/or louvers that can create collection points for carbon fouling and/or require maintenance during operation.

As discussed above, the first separation component 125a may target only the largest solid particles in the product stream. As a result, solids smaller than 50 μm, 100 μm, and/or 500 μm will be present in the product stream that exits the first separation component 125a through the gas outlet 336. To help avoid fouling in the gas outlet 336 from these smaller particles, the gas outlet 336 can have a diameter that is greater than about 50 mm, 75 mm, 100 mm, and/or 400 mm. Additionally, or alternatively, the gas outlet can be positioned to help direct the outlet flow perpendicular to the flow of solids in the first separation component 125a to help ensure that the targeted solids are not inadvertently carried downstream.

In some embodiments, the first separation component 125a is integrated with the pyrolysis reactor 110 shell. In such embodiments, the first separation component 125a can omit high temperature and pressure seals and/or flanges. However, the integration can make it more difficult to service and/or replace the first separation component 125a.

Returning to the description of FIG. 1, the second separation component 125b can include, for example, a cyclone separator that is configured to remove solids having a particle size between about 1 μm and about 3 μm, between about 3 μm and about 10 μm, and/or between about 10 μm and about 100 μm. These particle sizes can be relatively common in the product stream, thereby requiring the second separation component 125b to handle relatively high solids loading and/or to withstand additional exposure to the relatively high temperatures of the product stream. Accordingly, the second separation component 125b can be constructed from high temperature alloys, (e.g. ASTM Gr 321 stainless steel, 316H steel, and/or the like) to help extend a lifetime of the second separation component 125b. Additionally, or alternatively, the second separation component 125b can include seals and/or flanges (e.g. class 300, ASME B16.52, and/or the like) that are suitable for hydrogen-rich gas pressure containment at the relatively high temperatures and/or pressures of the product stream. However, similar to the discussion above, the second separation component 125b can be incorporated into the reactor 110 shell to eliminate the need for a high temperature and pressure seal. In some embodiments, the second separation component 125b can include a high temperature ceramic filter.

The third separation component 125c can include, for example, a pulse jet baghouse filter that is configured to remove solids having a particle size between about 100 nanometers (nm) and about 1 μm, and/or between about 1 μm and about 3 μm. Although the third separation component 125c is farther down the line (e.g., the flow path), the third separation component 125c is still exposed to relatively high temperatures (e.g., between about 150° C. and about 200° C., between about 200° C. and about 300° C., and/or between about 300° C. and about 350° C.) and the pressures discussed above. Accordingly, the baghouse filter can include one or more seals and flanges (e.g., class 300, ASME B16.5, and/or the like) that are suitable for hydrogen-rich gas pressure containment at the relatively high temperatures and/or pressures discussed above. Additionally, or alternatively, the third separation component 125c can have a baghouse filter that has a cylindrical shape and/or external stiffeners to help withstand the pressures. Non-limiting examples of suitable materials include Carbon steel, ASTM Gr 312, 316, 316L, and/or the like. Further, the filter bags can be constructed of PTFE for enhanced temperature resistance compared to polyester or polypropylene bags.

Solids can be dislodged from the filter bags with a pulse of gas. In other settings, jet baghouse filters use air to dislodge solid particles from the filter bags into downstream collection systems. However, air is incompatible with the pyrolysis system 100 because it would introduce oxygen into the product stream which could form a combustible mixture. Instead, various embodiments of the present technology use a modified design to use an alternative pulse fluid. For example, control valves, venturi nozzles, and/or other design elements are modified to natural gas, methane, ethane, propane, nitrogen, other inert gases, and/or the like as the pulse fluid. In some embodiments, the pulse gas is drawn from the input line to the pyrolysis reactor 110 (that is, a portion of the hydrocarbon reactant (e.g., natural gas) is used as the pulse fluid). While the use of the hydrocarbon reactant can decrease a purity of the resulting product slightly (e.g., introducing the hydrocarbon gas into the hydrogen gas stream), the hydrocarbon reactant does not create a threat of combustion, does not need to be separated by later filtering processes, and may not require additional compression components to match the product stream.

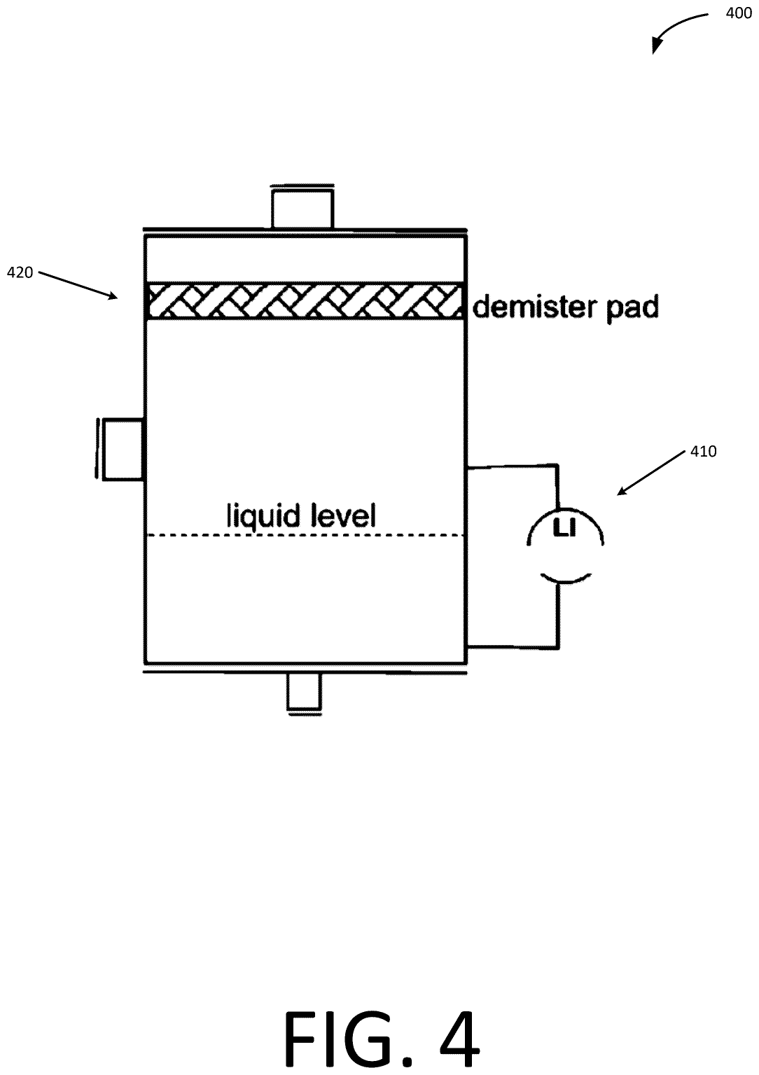

A fourth separation component (for example, n 126) can include a separator vessel 400 to collect condensable liquids (e.g., organic compounds, pyrolysis oils, and/or the like), an example of which is illustrated in the schematic diagram of FIG. 4. In some embodiments, a fourth heat exchange component may follow (i.e., be connected to) the third separation component 125c, and the separator vessel 400 may be connected to/may follow the fourth heat exchange component. The design of the separator vessel 400 can be optimized to minimize fouling and/or solidification of liquids.

For example, the fourth separation component (e.g., the separator vessel) 400 can include minimal internal components to reduce (or avoid) fouling and/or solids accumulation. That is, the separator vessel 400 can mostly include open space within the vessel. In some instances, the separator vessel 400 can include heat tracing and insulation to maintain a suitable operating temperature within the vessel to help avoid over-cooling that can solidify the liquid therein. A vessel level of the separator vessel 400 can be controlled by modulating the liquid outlet flow rate.

For example, the fourth separation component (e.g., separator vessel 400) can include a flow control valve 410 that helps control the vessel level. The flow control valve can additionally, or alternatively, create a seal to help prevent product gasses from the separation and cooling system from leaking into the solids collection system. In some embodiments, as depicted in FIG. 4, the separator vessel 400 can include a demister pad 420 to help remove/separate the liquid from the product stream so that the resulting product stream is a gas product stream (e.g., a hydrogen gas product stream).

Returning to the description of FIG. 1, the pyrolysis system 100 can, in some embodiments, include a fifth separation component which can include a separator vessel generally similar to the fourth separation component (e.g., separator vessel 400). The repetition of cooling and liquid separation vessels can allow the system to target and/or remove compounds from the product stream that liquify and/or freeze at varying temperatures, such as varying hydrocarbons and/or byproducts with a boiling point between about 80° C. and about 60° C., between about 60° C. and about 40° C., and/or between about 40° C. and about 20° C. Further, the cooling and separation vessels can be repeated any suitable number of times to remove compounds from the product stream, resulting in hydrogen gas (e.g., gas product 170) that meets a downstream demand for purity. In some embodiments, one or more of the separation components 125 can be an adsorption component. For example, the pyrolysis system 100 can include a sixth separation component that can be an adsorbent bed to collect hydrocarbons that condense at temperatures at or below about 60° C., about 40° C., about 20° C., and/or about 0° C. In some embodiments, one or more of the separation components 125 can be a high temperature filter.

In various embodiments, the pyrolysis system 100 can include a variety of alternative (or additional) gas-solids separation components 125, such as electrostatic precipitator, cartridge filter, impingement baffles, ceramic filter, and/or other suitable components that do not require water for the separation. In some instances, the pyrolysis system 100 can include various liquid scrubbers and/or separators to achieve the separation and/or cooling objectives. For example, a scrubber can be designed to contact the product stream with condensed liquid pyrolysis products (e.g., pyrolysis oils), with the effluent (solids and liquids) routed to the solid collection component 140. Additionally, or alternatively, the pyrolysis system 100 can include a closed-loop liquid system to provide a water separation component 125 without (or with limited) access to water. In such embodiments, however, the pyrolysis system 100 can have filtering devices that can be prohibitively complex and/or costly to maintain.

The separation components 125 discussed herein can be arranged in various alternate orders. Additionally, or alternatively, one or more of the components can be omitted entirely. In a specific, non-limiting example, the separation system of the pyrolysis system 100 can include: a first heat exchange component/device 115a; a first separation component 125a; a second separation component 125b (e.g., without a heat exchange component 115b between separation component 125a and separation component 125b), such as a high temperature ceramic filter; a second heat exchange component (e.g., HX 115c) downstream from the second separation component 125b that can drop the temperature in the product stream from a hot side temperature (e.g., greater than about 1000° C., between about 900° C. and 1000° C., between about 700° C. and about 900° C., and/or between about 500° C. and about 700° C.) to a cold side temperature (e.g., between about 80° C. and about 60° C., between about 60° C. and about 40° C., and/or between about 40° C. and about 20° C.), without requiring a third solid-separation component (e.g., separator 125c) and/or another heat exchange component; and one or more liquid separation components.

In some embodiments, the pyrolysis system 100 can include various liquid-gas separators/separation components that do not include normal pressure vessels (e.g., coalescers, hydrocyclones, or liquid draws directly from heat transfer devices). Further, the pyrolysis system 100 can include various other removal systems to remove byproducts from the reaction stream.

Purely by way of example, the pyrolysis system 100 can include regenerable gas-liquid absorbers, consumable carbon beds that are not regenerated in place, refrigerant systems that enable removal of low-temperature condensates, and the like.

As discussed herein, the pyrolysis system 100 can include one or more heat exchange components 115 (for example, a plurality of heat exchange components). The heat exchange components 115 can, in some instances, be positioned in sequence from high temperature to low temperature along the process flow, avoiding a need to reheat the product stream during the separation processes (for example, by separation components 125). Further, in the illustrated embodiment, the heat exchange components 115 are heat exchangers (HX) 115 positioned between each of the separation components 125. Although this is what is depicted in FIG. 1, the technology disclosed herein is not so limited. In various other embodiments, the pyrolysis system 100 can include multiple heat exchange components 115 (e.g., multiple heat exchangers, one or more active cooling components, and/or the like) between one or more pairs of the separation components 125 and/or no heat exchange components 115 between one or more pairs of the separation components 125. In any of the embodiments discussed below, the heat exchange components 115 can include active cooling components and/or heat exchangers. The heat exchangers/heat exchange components can include a variety of heat transfer devices, such as bayonet heat exchangers, shell and tube heat exchangers, plate and frame heat exchangers, brazed plate heat exchangers, moving bed heat exchangers, direct contact heat exchangers, air cooled heat exchangers, heat pipe heat exchangers, and/or any other suitable device.

The number, device selection, and sequence of the heat exchange components 115 can be determined by the temperature limitations in one or more of the separation components 125, properties of the compounds in the product stream (e.g., condensation temperatures of hydrocarbon liquids), and/or the like. Similar to the features discussed herein, the selection of heat exchange components 115 can also be limited by peripheral considerations, such as access to utilities (e.g., water), the temperature of the product stream coming out of the pyrolysis reactor, and/or the like.

For example, the first heat exchange component 115a can include a high temperature heat exchanger that is positioned within the pyrolysis reactor 110 and/or coupled to an outlet of the pyrolysis reactor 110 (as depicted in FIG. 1). As a result, the first heat exchange component 115a can condition the product stream to a suitable temperature for the first separation component 125a. In various embodiments, the first heat exchange component 115a can include high-temperature alloys and/or non-metallic (e.g. ceramic) components to tolerate operating temperatures of about 1000° C., about 1250° C., and/or about 1500° C. Fouling from contact with the solid carbon in the product stream (from the pyrolysis reactor 110) can be reduced (or minimized and/or eliminated) by maintaining wide passageways (e.g., passageways that are at least about 3 times wider, about 5 times wider, about 10 times wider, and/or about 15 times wider than the largest particles of solid carbon) for the flow path of the product stream (and, e.g., not including narrow gaps and/or narrow passageways such as passageways beneath the thresholds discussed above). The wide passageways can also help reduce (or minimize) a pressure drop through the first heat exchange component 115a to maintain a pressure in the product stream.

In some embodiments, heat can be recovered (e.g., recuperated) by transferring the heat to one or more other locations in the pyrolysis system 100, such as a hydrocarbon input channel for the pyrolysis reactor 110. As a result, heat in the product stream can help preheat combustion air, hydrocarbon fuels for the pyrolysis reactor, combustion fuel gas, and/or the like to help improve an efficiency of the pyrolysis reactor 110.

In some embodiments, a dedicated heat transfer fluid (e.g., oils stable at high temperature, air, inert gas, molten metal, water, aqueous solution, and/or the like) can be used as an intermediate between the product stream and the other components of the pyrolysis system 100. Additionally, or alternatively, heat can be recuperated into a separate system and/or process thermally couplable to the pyrolysis system 100. Examples include providing input heat to various power generators, input heat for the generation of steam, chemical processing, HVAC systems, and/or the like.

In some embodiments, the second heat exchange component 115b (i.e., HX 115b) can be coupled to the product stream upstream from the second separation component 125b to condition the product stream for the second separation component 125b. In various embodiments, the second heat exchange component 115b can be constructed from high-temperature alloys (e.g., ASTM Gr 321 stainless steel, 316H steel, and/or the like) to extend a lifetime of the second heat exchange component 115b at temperatures that exceed about 500° C., about 700° C., about 900° C., and/or about 1000° C. The second heat exchange component 115b can, in some instances, include one or more seals and flanges (e.g., class 300, ASME 16.5, and/or the like) that are suitable for hydrogen-rich gas pressure containment of at the elevated pressure of the product stream. In some embodiments, the second heat exchange component 115b needs to be able to tolerate thermal stresses associated with heating and cooling from ambient temperatures to the elevated temperatures multiple times during the equipment life. The frequency can be based on how often the pyrolysis reactor 110 needs to be maintained (e.g., once per week, once per month, once per quarter, and/or the like). To help tolerate the cooling and heating cycles, the second heat exchange component 115b can include one or more expansion joints, machined slots, precisely engineered and manufactured clearances, and/or the like.

In various embodiments, the second heat exchange component 115b can includes a shell-and-tube and/or a bonded/welded plate design. In some instances, internal clearances, tube diameters, and return/U bends can be specified in a range to: maintain superficial gas velocity between about 1.5 m/s and about 5 m/s, about 5 m/s and about 10 m/s, between about 10 m/s and about 20 m/s, between about 20 m/s and about 30 m/s, and/or between about 30 m/s and about 45 m/s to limit carbon fouling and/or accumulation, and/or to enhance heat transfer coefficient via turbulence in the second heat exchange component 115b; maintain a pressure drop below about 0.01 bar, about 0.1 bar, about 0.3 bar, and/or about 0.5 bar to help maintain the pressure of the product stream; and/or provide a surface area sufficient to cool the exit product gas to temperatures between about 200° C. and about 400° C., between about 400° C. and about 600° C., and/or between about 600° C. and about 800° C.

In some embodiments, the second heat exchange component 115b includes a compact area exposed to a cooling water, another cooling aqueous solution, cooling oil, and/or the like that is integrated in a closed-loop to help provide efficient heat transfer in the second heat exchange component 115b.

In some embodiments, as depicted in FIG. 1, the pyrolysis system 100 can include a third heat exchange component 115c. The third heat exchange component (HX 115c) can be coupled to the product stream upstream from the third separation component 125c to condition the product stream for the third separation component 125c. In various embodiments, the third heat exchange component 115c can control the exit temperature of the product stream to a temperature between about 150° C. and about 200° C., between about 200° C. and about 250° C., between about 250° C. and about 300° C. to limit an impact of the temperature of the product stream on the filter bags in the third separation component 125c while reducing (or minimizing) the amount of liquid and/or solid condensation in the filter bags that can cause irreversible fouling and/or increased bag replacement frequency. The temperature control in the third heat exchange component 115c can be monitored by one or more sensors at an outlet of the third heat exchange component 115c. In some embodiments, the amount of cooling the third heat exchange component 115c does is at least partially controlled using a cooling media (e.g., water and/or some other fluid) in a closed-loop system coupled to the third heat exchange component 115c and/or a heating media (e.g., electric heaters) coupled to the third heat exchange component 115c.

The pyrolysis system 100 can also include any other suitable number of heat exchange components 115 (e.g., fourth, fifth, sixth, and/or any other suitable number) to further reduce and/or control the temperature of the product stream for downstream separators 125. For example, the pyrolysis system can include additional heat exchangers (i.e., heat exchange components 115) that control the temperature of the product stream as necessary to help condense and/or freeze other compounds (e.g., organic compounds, pyrolysis oils, and/or the like) out of the product stream. In each of the heat exchange components 115, the pyrolysis system 100 can include a temperature monitoring component and/or various cooling media to help control the temperature to specific ranges. In some embodiments, the relatively low temperatures can result in various solid foulants (e.g., frozen compounds) collecting the heat exchange components 115. In such embodiments, the pyrolysis system 100 can periodically heat the heat exchange components 115 to reliquefy a portion (or all) of these solids and clean the heat exchange components 115 in-place.

As illustrated in FIG. 1, multiple liquid and/or solid products (e.g., solid carbon of different sizes, organic compounds, pyrolysis oils, and/or the like) separated from the product stream (for example, by separators 125) can be combined in a single collection device (e.g., solids collection component 140) to form a blended product. That is, rather than directing the compounds (including a carbon co-product) separated from the product stream according to the methods discussed above to independent endpoints, the products separated by different separation components 125 can be recombined into a single product (e.g., a conditioned, cooled, and processed solid carbon product). In some embodiments, however, one or more of the compounds are maintained separate and/or reseparated in the solids collection component (e.g., distinct solid and liquid components that can be directed to separate endpoints).

The recombination of products (for example, by combining the separated products into a single solids collection component 140) can have several benefits. For example, the recombination can simplify handling of the solid co-products (e.g., creating a single carbon co-product) and/or simplifying bulk transportation of the solid carbon (e.g., solid product 180) away from the pyrolysis system 100; direct all of the carbon to single storage device that can be emptied periodically (e.g., every day, every week, every month, and/or the like); reduce a footprint required to handle each of the compounds separated from the product stream; and/or pre-process the carbon as necessary for downstream applications (e.g., to replace bitumen in asphalt products).

FIG. 5 is a schematic diagram illustrating the pyrolysis system 100 with additional details of the solids collection component 140, in an embodiment. As illustrated in FIG. 5, the solids collection component 140 can be isolated from the gaseous product stream by one or more airlocks 130. As a result, the solids collection component 140 can operate at a pressure between about −0.2 barg and about 0.2 barg, as opposed to the elevated pressures in the gaseous product stream. The higher temperature and pressure system 105 depicted in FIG. 5 can represent the components of the pyrolysis system 100 that operate at a high temperature and pressure such as the pyrolysis reactor 110, the separation components 125, the heat exchange components 115, etc. In some embodiments, carbon collected from one or more separation components 125 (for example, within the higher temperature and pressure system 105) feeds one or more cooling screw conveyors 546. Although FIG. 5 depicts a single cooling screw conveyor 546, the solids collection component 140 can include any number of conveyors 546. The conveyor 546 provides simultaneous cooling, mixing, and transport for the solid carbon.

Liquid condensed from the gas by one or more heat exchangers and separators (e.g., by separation components 125 such as a fourth, fifth, and/or sixth separation component, as an example), can be introduced to the conveyor 546 to form a single product with the solids. The screw conveyor 546 can include rotating equipment (e.g., screws) with shafts extending outside of the process cavity. The shafts, in turn, can be coupled to one or more motors 547 to drive rotation of the screws, and therefore drive the solid carbon through the screw conveyor 546. The exit point for the shaft can be sealed to help reduce (or prevent) leakage from the screw conveyor 546 to the atmosphere.

In some embodiments, moving equipment (rotating shafts, plungers, and/or the like) extending from a process area of the screw conveyor 546 are coupled with specialized seals that are designed to operate in hydrogen-rich environments and/or at ambient or elevated temperatures and pressures. The seals can use an inert gas or aqueous purge, positive or vacuum pressure, with lubricated or unlubricated sealing components. Additionally, or alternatively, the seals can include components made from specialty alloys that are resistant to hydrogen embrittlement and wear at elevated temperatures, such as austenitic stainless steels 316, 316H, nitrided alloys such as Nitronic 50, Nitronic 60, or hardfaced coatings.

A blower, fan, ejector, compressor, and/or other suitable component can be connected to the solids handling equipment to help prevent a pressure in the solids handling system from equalizing with a pressure in the gas separation system (e.g., to help prevent a high pressure in the solids collection component 140). FIG. 5 illustrates a fan/blower 548 as an example.

In embodiments using a blower or fan 548, the blower or fan 548 can modulate with a variable frequency drive to control pressure in the solids handling equipment to a desired set point. In embodiments using an ejector, the motive (high pressure) gas flow or pressure can be varied or the product gas can be recycled to the suction to control pressure in the solids handling equipment to a desired set point. Excess gas processed by the blower, fan, compressor, or ejector can be routed to, as an example, a combustion component in the pyrolysis reactor 110 to be combusted to provide heat for the pyrolysis reaction. The excess gas could additionally and/or alternatively be routed to other components of the pyrolysis system and/or pyrolysis reactor 110. Recycling gas from the product stream to the combustion component can help improve the pyrolysis system's thermal efficiency (e.g., by using hot gasses in the combustion component) and/or help reduce emissions to the atmosphere (e.g., by combusting hydrogen gas in place of a hydrocarbon gas).

However, hydrogen-rich product gas can be combustible in the presence of oxygen from ambient air. Accordingly, in some embodiments, the solids collection component 140 can separate residual product gas (e.g., hydrogen-rich gas) from the solid carbon before exposing the solids stream to air in a downstream conveyor, container, or other atmospheric processing, storage, or transport system.

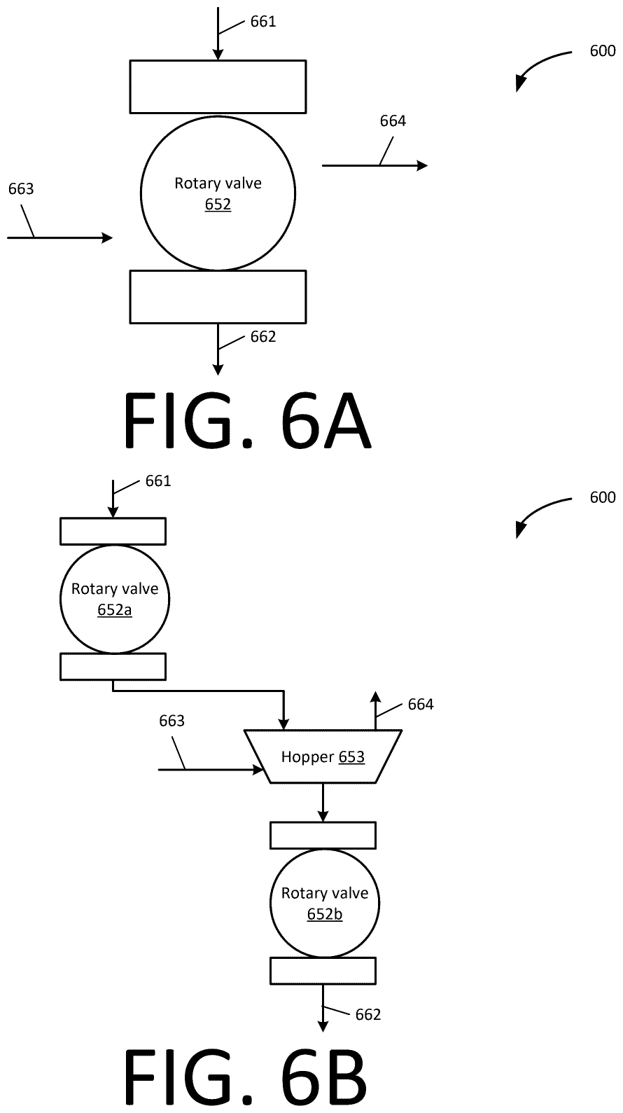

Examples of suitable solids-gas separation components 600 for the solids collection component 140 are illustrated in the schematic diagrams of FIGS. 6A and 6B. In some embodiments, the illustrated components can be coupled to the solids collection component 140 downstream from one or more cooling screw conveyors. Thus, in some instances, the product gas inlet 661 can be from the one or more cooling screw conveyors. The separation component 600 can include one or more rotary valves 652 (e.g., a single rotary valve 652 (as depicted in FIG. 6A), a plurality of rotary valves 652a and 652b (as depicted in FIG. 6B), etc.). In some embodiments, inert gas 663 can be introduced (for example, into the rotary valve 652) at one or more locations to displace the product gas with a non-combustible fluid. In various such embodiments, a hopper (such as hopper 653), pipe spool, vessel and/or other suitable mixing component can be provided to help facilitate inert gas 663 mixing with the solid/product gas mixture. FIG. 6B illustrates one such exemplary hopper 653.

Additionally, or alternatively, inert gas inlets can be designed to help facilitate gas-solids mixing. For example, the system (e.g., separation component 600) can include multiple ports in the same container, mechanical vibration, pulsed flow, and/or any combination thereof. The product gas and diluent mixture can be routed (for example, through inert and product gas outlet 664) to an endpoint for the hydrogen gas product, the pyrolysis reactor (e.g., as a pyrolysis reactant or a combustion fuel), to the atmosphere at a safe location, and/or any other suitable location. In some embodiments, a blower, fan, compressor, or ejector can be provided to pressurize the effluent gas as necessary based on the desired location. The cooled, low pressure, degassed solids product can then be conveyed (for example, through outlet 662) to a storage system. The downstream conveyance can be performed with a pneumatic system with air as the motive fluid and/or any other suitable conveyor. The conveyor can directly feed a container, tank, trailer, car, and/or other suitable storage device that is equipped to receive the solid carbon product. Once filled, the container, tank, trailer, car, and/or other suitable storage device (e.g., a silo, hopper, cylindrical vessel, tank, railcar, pressurized hopper container, bin, bulk bag, drum, gaylord box, and/or the like) can then be transported to a desired destination (e.g., by truck, rail, ship, barge, and/or the like) and/or emptied into another container.

In some embodiments, the carbon is diverted to a smaller intermediate container when the container is emptied and/or changed so that upstream processes are not interrupted. Suitable intermediate containers include silo, hopper, cylindrical vessel, tank, railcar, pressurized hopper container, bin, bulk bag, drum, gaylord box, and/or the like. In some embodiments, the system (e.g., separation component 600) includes multiple containers. In such embodiments, the carbon can be directed to a first container while a second container is emptied and/or changed; then the carbon can be directed to the second container while the first container is emptied and/or changed.

In various embodiments, the solids collection component 140 can include a moving bed heat exchanger to cool the carbon product. The solids collection component 140 can, in some instances, include a direct contact heat exchanger (with cooling media) to cool the carbon product. The cooling media can include a closed-loop water system, water, cooled product gas, air, and/or any other suitable media. In some embodiments, the solids collection component 140 can include additional, or alternative, solids conveyance devices, such as dense or dilute phase pneumatic, disc, belt, tubular, uncooled screw, bucket elevator, and/or the like.

In a specific, non-limiting example, product gas from the pyrolysis reactor 110 can be recycled to pneumatically convey the solids. This is suitable for high-temperature solids transport since no oxygen is introduced and can be performed at lower pressures that require a blower instead of a compressor. In another specific, non-limiting example, an inert gas can be used at high operating temperatures if supplied from an in-place nitrogen concentrator. The nitrogen concentrator can help reduce the system's reliance on bulk delivery and/or storage to incorporate the nitrogen gas.

The solids collection component 140 can include ejectors in any location where a blower or fan is specified to provide pressure increase without moving parts. Natural gas, inert gas, or any other compatible gas at higher pressure than the desired discharge pressure can be used as the motive fluid in any such ejectors. In some embodiments, the solids collection component 140 (and/or systems coupled thereto) are designed such that the combustible product gas leaked into the solids collection component 140 is diluted without additional equipment elements or separate processes. For example, pneumatic system air rates may be so much higher than the rate of leaking that adequate dilution occurs in the pneumatic system. The solids collection component 140 can include additional monitoring instruments and high availability shutdown system(s) to help reduce a chance that the combustible gasses exceed a predetermined concentration.

The dilution of the product gas can be combined with the airlock valves 130 described above. For example, inert gas is supplied to a nozzle on the intermediate space. In some such embodiments, the intermediate space includes a vent and the supply and vent can be controlled with valves to only introduce or release gas during specific steps in the airlock's cycle. Carbon may be transferred between any combination of the above prior to shipping from the system.

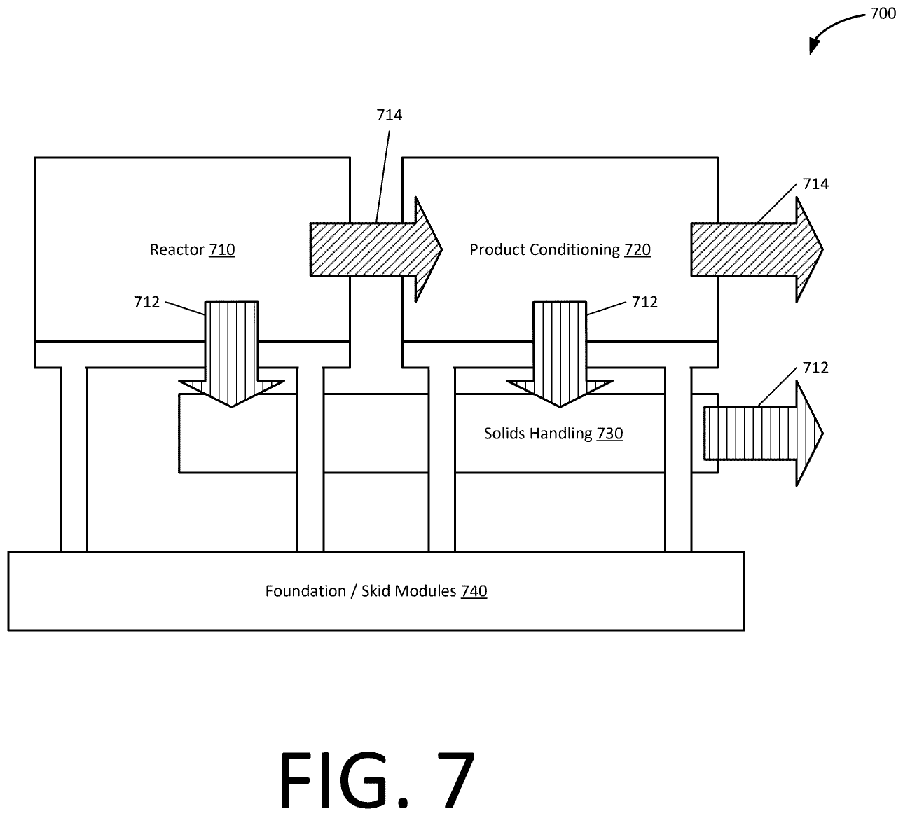

FIG. 7 is a schematic diagram illustrating yet further details on the pyrolysis system in accordance with some embodiments of the present technology. As illustrated in FIG. 7, the pyrolysis system 700 can be constructed in one or more modules and/or blocks. Pyrolysis system 700 can correspond to pyrolysis system 100 (FIG. 1), in some embodiments. Pyrolysis system 700 includes a reactor module/container 710, a product conditioning module/container 720, and a solids handling module/container 730. These modules 710, 720, and 730 can be constructed on a foundation 740 or tiled together using skid modules 740 (which can also be referred to herein as tiling skids 740), in some instances. The reactor module 710 can include components such as the pyrolysis reactor (e.g., pyrolysis reactor 110). The product conditioning module 720 can include components such as the separator components (e.g., separator components 125) and/or the heat exchange components (e.g., heat exchange components 115). The solids handling module 730 can include components such as the airlocks (e.g., airlocks 130), solids collection component (e.g., solids collection component 140), solids cooling component (e.g., solids cooling component 145), solids separator (e.g., solids separator 150), etc.

As discussed herein, the modular construction of the pyrolysis system 700 can help allow the system 700 to meet various footprint requirements, be constructed offsite and installed on-site in a relatively short time (e.g., allowing the pyrolysis system 700 to be implemented in a wider variety of locations), etc. Accordingly, in some instances, individual modules and/or blocks typically may not exceed defined size and weight requirements for on-road freight for various countries. Completed modules and/or blocks can be packaged in a manner suitable for transport via truck without damage or degradation under normal conditions. The shipped modules and/or blocks can be received at a desired location and assembled. Assembly can include welding, pipe fitting, electrical connections, and/or the like. Further, the modules and/or blocks (e.g., 710, 720, and 730) may be stacked vertically and/or arranged in lateral positions. Once constructed, the pyrolysis system 700 (and/or individual modules and/or blocks therein) can be covered by panels, grates, roofs, tarps, or scaffolds for aesthetic appearance, weather protection, access control, and/or the like.

Further, individual modules and/or blocks (e.g., the reactor module 710, product conditioning module 720, and/or solids handling module 730) can be defined by desired flow sequence of fluids and solids, individual device and component sizes, interconnecting piping sizes and orientations to allow uninterrupted process flow, other piping details to ensure reliable operation, and/or the like. The flow sequences can include a gas flow 714 from the reactor module 710 to the product conditioning module 720 and a solids flow 712 from the reactor module 710 and/or the product conditioning module 720 to the solids handling module 730.

Additionally, or alternatively, the modules and/or blocks (e.g., the reactor module 710, product conditioning module 720, and/or solids handling module 730) can be designed in a way where multiple configurations for the pyrolysis system 700 are possible (e.g., multiple reactor modules and/or blocks feeding a single product conditioning system module and/or block). Still further, the relative orientation of individual modules and/or blocks (e.g., the reactor module 710, product conditioning module 720, and/or solids handling module 730) is set by the needs of the process flows discussed above (e.g., the gas flow 714 and/or the solids flow 712) and/or to allow for simple modification for future design changes. For example, the solids collection component (as part of the solids handling module 730) is situated at the lowest level of the assembly to facilitate a downward flow of solids (e.g., using gravity). The individual modules and/or blocks positioned above the solids collection component and the solids handling module 730 can be raised or lowered for any changes to the solids collection component by, for example, varying the selection of structural support members. The modules (e.g., 710, 720, and 730) and sizing discussed herein in relation to pyrolysis system 700 are exemplary. For example, system 700 can include additional and/or different modules than discussed herein, different arrangements of modules, different sizing constraints (for example, the system 700 and corresponding module(s) can be scaled up in size), etc.

In some embodiments, for pyrolysis systems (such as pyrolysis system 100, pyrolysis system 700, etc.) and pyrolysis reactors (such as pyrolysis reactor 110, for example), the product stream for the pyrolysis reactor can contain other materials in addition to hydrogen and carbon. For example, in addition to hydrogen and carbon, the product stream from the pyrolysis reactor can contain partial reaction byproducts and other materials such as aromatic hydrocarbon byproducts, as well as various other organic compound byproducts (e.g., pyrolysis oil; asphaltenes; acetylene; carbon monoxide; carbon dioxide; water vapor; organic compounds such as volatile organic compounds (VOCs) (e.g., hexane, propane, butane, butadiene, toluene, benzene, trimethylbenzene, ethanol, formaldehyde, naphthalene, polycyclic aromatic hydrocarbons (PAHs), and/or the like) and/or semivolatile organic compounds (SVOCs) (e.g., decane, fluorene, bibenzofuran, chrysene, pyrene, fluroanthene, octadecane, penanthrene, anthracene, naphthalene, caprolactum, and/or the like); other oils; waxes; and/or the like). If left in the product stream from the pyrolysis reactor, the byproducts can also threaten to damage and/or clog processing equipment, and/or serve as unwanted impurities in a downstream process. Accordingly, it is desirable to remove the byproducts from the product stream and/or utilize them in further processes.

For example, the organic compounds can be captured from the product stream in a separation component that includes one or more adsorption components. The separation component can be a separation component such as separation component 125 (FIG. 1), in some instances. The adsorption components can remove the organic compounds from the product stream and retain them within the separation component. However, the adsorption components eventually become saturated, thereby requiring the separation component to be regenerated (e.g., emptied, cleaned, desorbed, and/or otherwise reset). For example, the adsorption component could be physically removed from the pyrolysis system to be discarded in favor of a new adsorption component and/or processed in another apparatus. However, the removal and/or disposal of the adsorption component creates waste, can increase maintenance costs for the pyrolysis system, and/or can require downtime during which no hydrocarbons are being decomposed.

In another example, the pyrolysis system can periodically run a flushing gas (e.g., steam, air, inert gasses such as Argon and/or Nitrogen, and the like) through the adsorption component at an elevated temperature and/or a reduced pressure. The flushing gas can desorb and carry the organic compounds away from the adsorption component, thereby regenerating the adsorption component without removing the adsorption component (or components thereof) from the pyrolysis system. The organic compounds can then be combusted in a thermal or catalytic oxidizer unit. Alternatively, the organic compounds can then be removed from the flushing gas via condensation. However, the use of inert gasses requires a system for generating them and/or a supply of inert gasses, which can increase a cost associated with maintaining the pyrolysis system. Additionally, the mixture of inert gasses and organic compounds must be treated by a separate processing component, further increasing a cost associated with maintenance of the pyrolysis system. If air or steam is used as the flushing gas, the resulting air/steam organic-compound mixture can be thermally or catalytically oxidized. However, additional safety precautions are needed to handle the flushing gas due to the presence and concentration of flammable gases. Further, in each of the examples discussed above, the combustion and/or oxidization of the organic compounds can produce carbon dioxide (CO₂), thereby increasing a carbon footprint associated with the pyrolysis system.

In yet another example, the organic compounds can be oxidized in situ using air as the flushing gas. However, the oxidation of the organic compounds typically requires an additional process unit to combust the organic compounds, increasing the complexity of maintenance costs for the pyrolysis system. Further, the in-situ process can cause delays in the regeneration process while the organic compounds are destroyed. Still further, as discussed above, the oxidization process can produce carbon dioxide and water, thereby increasing a carbon footprint of the pyrolysis system.

Systems and methods for regenerating the adsorbent components using process gasses (e.g., gasses present in the process flow of the pyrolysis system) are discussed herein. For example, the process gasses can include hydrocarbon reactants (e.g., natural gas, methane, and/or the like), hydrogen gas in the product stream, flue gas from a combustion component (e.g., containing nitrogen gas and steam), mixtures thereof, and/or various other suitable gasses. As discussed in more detail below, the process gasses can be supplied to the adsorbent components at a suitable temperature and/or pressure to regenerate (e.g., desorb) the adsorbent components without removing them from the pyrolysis system. As a result, the regeneration processes described herein can reduce the complexity of maintaining the adsorbent components and/or reduce (or eliminate) downtime associated with the regeneration.

Further, the desorbed stream can be recycled back to the pyrolysis reactor for pyrolysis, combustion, and/or another suitable chemical reaction that decomposes the organic compounds. Put differently, the pyrolysis reactor can be configured to use the desorbed stream in a chemical reaction (such as pyrolysis, combustion, etc.). In a specific, non-limiting example, the natural gas can be used to flush the adsorbent components and the desorbed stream of natural gas and organic compounds can be provided to a reaction chamber in the pyrolysis reactor. There, the natural gas can undergo the pyrolysis reaction discussed above while the organic compounds are pyrolyzed to produce solid carbon and hydrogen gas. In another specific, non-limiting example, a portion of the hydrogen gas co-product is used to flush the adsorbent components and the desorbed stream of hydrogen gas and organic compounds can be provided to a combustion component of the pyrolysis reactor. There, the hydrogen gas and organic compounds can be combusted to provide input heat to the pyrolysis reactor. In another example, at least a portion of the hydrogen gas co-product can be sent back through the reaction chamber (i.e., the hydrogen gas co-product can be recycled back through the pyrolysis reactor).

In some embodiments, the systems and methods described herein provide a closed loop for the pyrolysis system that uses process gasses to desorb the adsorption components and recycle the organic compounds through the pyrolysis reactor to be converted to carbon and hydrogen. As a result, the closed loop can reduce costs associated with maintaining the adsorption components and/or operating the pyrolysis system. For example, the pyrolysis system may not rely on a supply of inert gasses, may not require separate handling systems for the flushing gas after desorbing the adsorption unit, may not require an oxidation system for the organic compounds, and/or may not require a handling system for flushing gasses containing the organic compounds. Additionally, or alternatively, by recycling the organic compounds through the pyrolysis reactor, the closed loop can increase throughput from the pyrolysis reactor (e.g., increase the percentage of a hydrocarbon reactant that is ultimately decomposed into solid carbon and hydrogen gas) and/or reduce the carbon footprint associated with the hydrocarbon reactant (e.g. by reducing (or eliminating) the volume of organic compounds that must be oxidized downstream from the pyrolysis reactor).

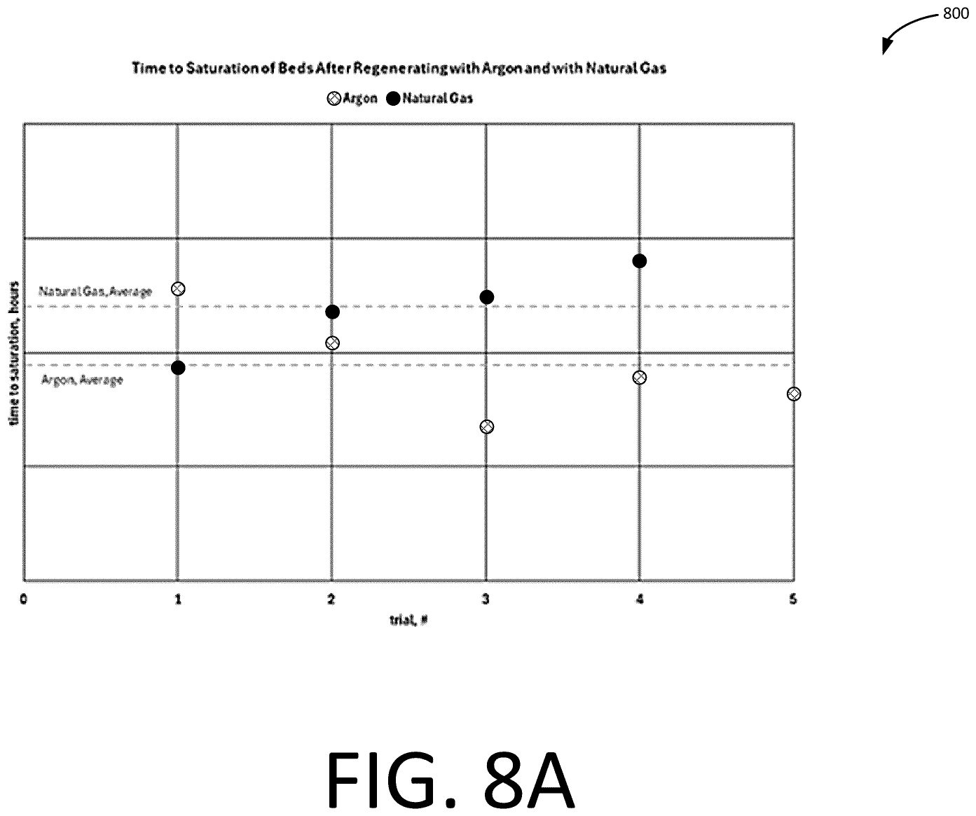

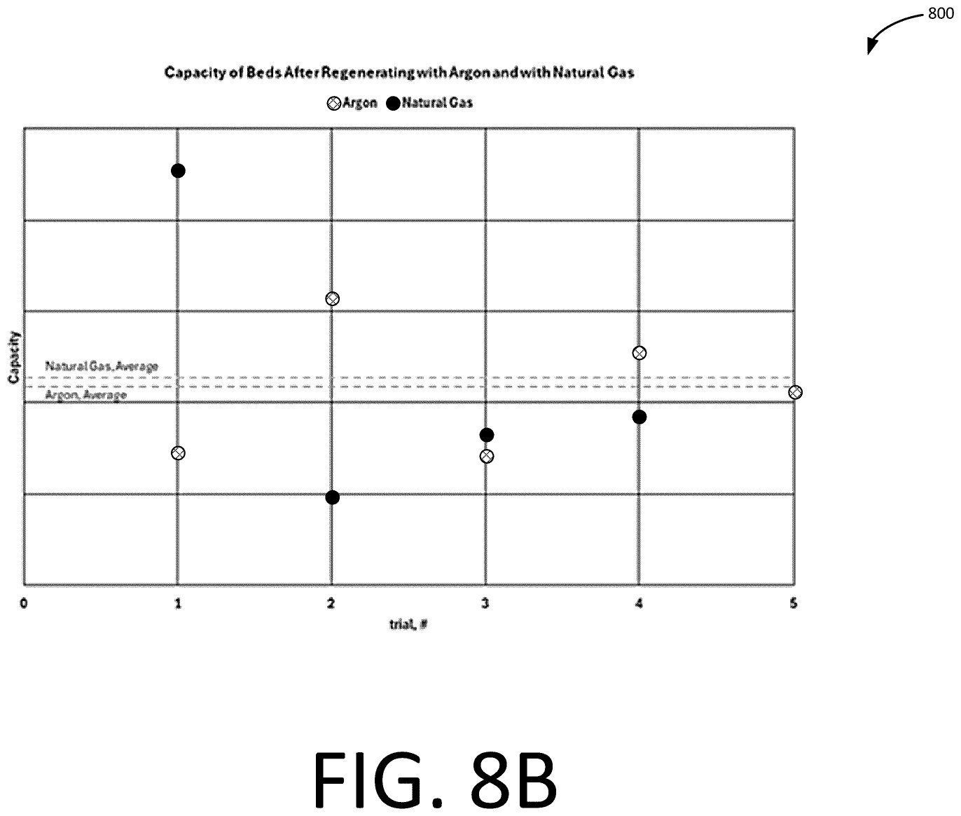

Still further, as discussed in more detail below, the process gasses can be as efficient (or more efficient) at desorbing the adsorbent components than air, steam, and/or inert gasses. As a result, the closed loop can reduce (or eliminate) the downtime required for regeneration, thereby allowing for continuous (or nearly continuous) operation of the pyrolysis system. For example, FIGS. 8A and 8B illustrate graphs 800 of results obtained from regenerating a separation component of a pyrolysis system with process gasses against results obtained from regenerating the separation component with Argon gas. The results were obtained in lab tests where a carbon adsorber media was used as the adsorption component and was regenerated using either natural gas or Argon. After each regeneration, a time to saturation (requiring another regeneration) of the regenerated adsorbent component and a capacity of the regenerated adsorbent component were measured.

FIG. 8A illustrates a graph 800 of the measured time to saturation for the adsorption component, in hours, after being regenerated with natural gas and after being regenerated with Argon. As illustrated in FIG. 8A, the average time to saturation varied by about 8 minutes between natural gas and Argon, with natural gas providing a slightly longer time to saturation. The results suggest that natural gas can regenerate the adsorption component at least as well as Argon and/or that using natural gas as a flushing gas will not require the pyrolysis system to regenerate the adsorption components more frequently.

FIG. 8B illustrates a graph 800 of the measured capacities for the adsorption component after being regenerated with natural gas and after being regenerated with Argon. As illustrated in FIG. 8B, the average capacities of the regenerated adsorption component varied by about 1.1% between cycles regenerated with natural gas and cycles regenerated with Argon. The results also suggest that natural gas can regenerate the adsorption component at least as well as Argon and/or that using natural gas as a flushing gas will not limit the amount of organic materials the adsorption components can remove from a product stream after a regeneration cycle.

As also discussed in more detail below, the systems and methods discussed herein can manage the temperature and/or pressure of the process gasses throughout the system. Purely by way of example, the system can manage the pressure of an incoming desorbing stream (sometimes referred to herein as a recycle stream) is higher than the pressure in the corresponding adsorption component being regenerated. As a result, the system can help prevent gasses from flowing backward in the recycle stream (e.g., thereby helping prevent organic compounds from flowing backward toward a source of the recycle stream), and/or allow the recycle stream to be injected into another location in the pyrolysis system after desorbing the adsorption component without additional pressurization (e.g., the pyrolysis chamber and/or combustion component of the pyrolysis reactor). Additionally, or alternatively, the system can manage the pressure of the recycle stream downstream from the adsorption component. Purely by way of example, the system can include a vacuum component positioned to reduce the pressure downstream from the adsorption component (e.g., creating a pressure drop through the adsorption component) to help ensure that the recycle stream only flows forward through the adsorption component. Additionally, or alternatively, the vacuum component can help reduce a temperature required for the incoming process gasses to desorb the adsorption components.

In some embodiments, the system can heat (or cool) the incoming recycle gasses to a temperature between about 25 degrees Celsius (° C.) to about 600° C., between about 200° C. and about 500° C., or between about 250° C. and about 350° C. before they enter the adsorption component. The temperature can be based on the organic compounds being desorbed, a material in the adsorption component, whether the system includes a vacuum component, a strength of bonds between the adsorption component and the organic compounds, and/or various other suitable factors to help improve the process gas' ability to regenerate the adsorbent components. In some embodiments, the pyrolysis system can use heat in combustion flue gasses and/or the product stream from the pyrolysis reactor to heat incoming recycle gasses.

In some embodiments, the system includes two or more adsorption components connected in parallel. In such embodiments, one or more adsorption components can be used to adsorb materials from the product stream gas while one or more other adsorption components are being desorbed in situ (e.g., providing simultaneous adsorption and desorption processes). That is, one or more of the adsorption components are available to adsorb organic compounds from the product stream while one or more of the adsorption components can be simultaneously regenerated (for example, desorbing organic compounds from the adsorption component(s)). The parallel adsorption and desorption can allow, for example, the pyrolysis system to operate continuously (or generally continuously), without needing to pause to regenerate the adsorption components. Additional details on the separation component, the adsorbent component(s), and related systems and methods are discussed herein.

As used herein, “continuous” operation (and/or “continuously” operate) can refer to generally continuous operation of the pyrolysis system, which can include operating the pyrolysis system without needing to pause to exchange, empty, desorb, or otherwise regenerate adsorption components of the pyrolysis system for periods of at least 3 hours, 6 hours, 12 hours, 24 hours, 48 hours, 72 hours, 168 hours, 730 hours, 2190 hours, 8760 hours, and/or longer periods. Continuous operation can include operation of the pyrolysis system that periodically pauses (e.g., when demand for hydrogen gas goes down (or goes to zero)) and/or pauses to allow components of the pyrolysis reactor to be serviced (e.g., for maintenance).

Further, although primarily discussed herein in the context of regenerating adsorbent components in a pyrolysis system, one of skill in the art will understand that the scope of the invention is not so limited. For example, process gasses of a system can be employed in various other settings requiring the adsorptive removal of a species (e.g., organic compounds) from a liquid or gas stream followed by regeneration of the adsorbent component when the process gasses do not react with the relevant adsorption components, such as combustion of biomass to generate energy, petroleum refining, chemical manufacturing, and/or the like. Further, it will be understood that the use of hydrogen gas and/or hydrocarbon gas as a desorbing agent is not limited to systems with closed loops for the flushing gas. Instead, for example, hydrogen gas and/or hydrocarbon gas can be used to regenerate adsorbent components anywhere the presence of oxygen, water, inert gasses, and/or other components would be problematic (e.g., systems sensitive to combustion when oxygen is introduced, systems with exposed electronics, and/or the like) and/or to reduce the cost of regeneration (e.g., by eliminating a need for inert gasses). Still further, although discussed primarily herein in the context of a regeneration process that has sufficient thermal and/or vacuum pressure to desorb the adsorption components without chemical reactions, one of skill in the art will understand that the scope of the invention is not so limited. For example, the processes disclosed herein can be applied even in systems requiring some amount of chemical reactions between the adsorbate and the desorbing agent. In such embodiments, the process requires that the effluent gas can be recycled to the reactor (e.g., to be thermally oxidized, combusted, and/or used in another suitable process) or collectible to be disposed of by another system. Accordingly, the scope of the invention is not confined to any subset of embodiments disclosed herein.

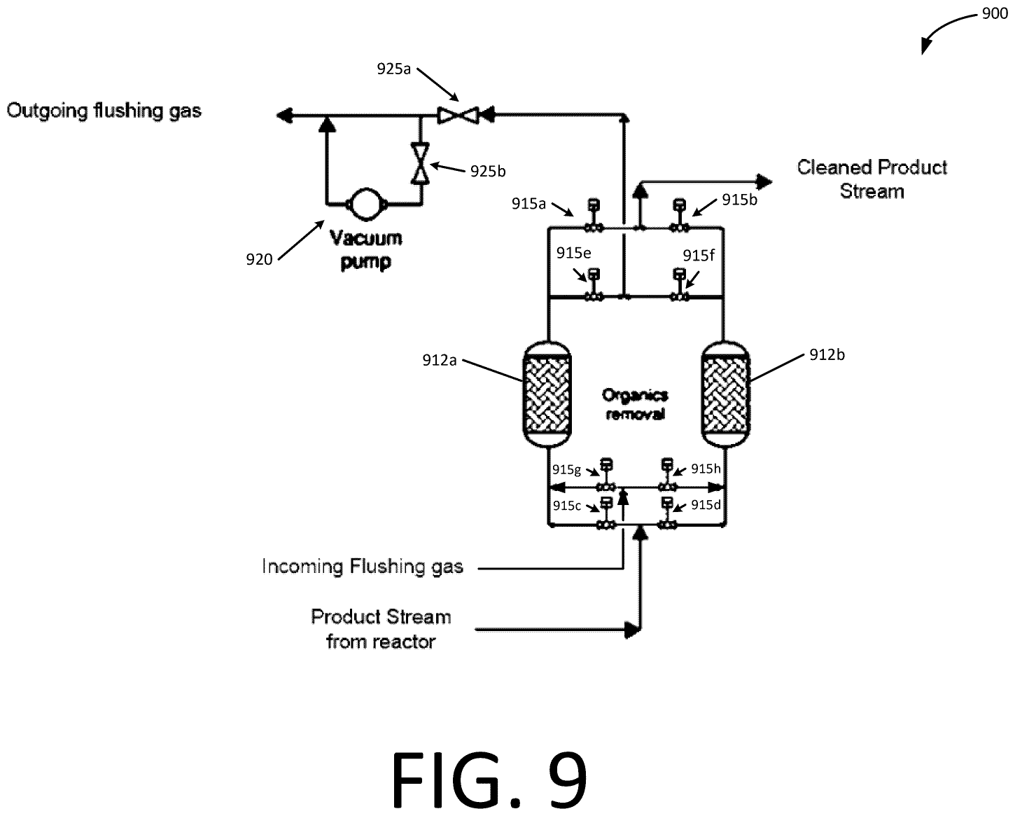

FIG. 9 is a schematic diagram of a separation component 900 for a pyrolysis system configured in accordance with some embodiments of the present technology. The separation component 900 may be referred to herein as an adsorption separation component. In some embodiments, the pyrolysis system is a system such as pyrolysis system 100 and/or 700. In some instances, the adsorption separation component 900 is one of the separation components (e.g., 125) in the pyrolysis system 100. In some instances, separation components 125 may be solid separation components, liquid separation components, and/or liquid-gas separation components, and the adsorption separation component 900 may be a later separation component (e.g., n 126). For example, the pyrolysis system (e.g., system 100) can include a plurality of solid separation components (e.g., separators 125a, 125b, and 125c) and may also include one or more liquid separation components. In this example, the adsorption separation component 900 may be a fifth or sixth separation component in the pyrolysis system (e.g., 100) that is downstream from the solid separation components and the liquid separation component(s). In such pyrolysis systems (e.g., system 100 and/or 700), it is beneficial to remove the organic compounds (e.g., resulting from incomplete reactions, byproduct reactions, secondary reactions, and/or the like) from the product stream before the product gases (hydrogen gas, unreacted hydrocarbons, and/or various other gases) are consumed to, for example, increase a purity of the product gasses, lower carbon dioxide emissions associated with the product gasses, and/or the like.

To help remove the organic compounds, the pyrolysis system can include one or more separation components of the type illustrated in FIG. 9 (e.g., one or more of adsorption separation component 900). As illustrated in FIG. 9, the adsorption separation component 900 can include multiple adsorption components 912 (two illustrated-912a and 912b, referred to collectively as 912) and a set of valves (e.g., 915a-h, referred to collectively as 915) that control gaseous flow through the adsorption components 912. For example, a first subset of the valves, valves 915a-d, controls the flow of a product stream from the pyrolysis reactor (e.g., pyrolysis reactor 110 (FIG. 1)) into and out of the adsorption components 912 (e.g., adsorbers 912). Further, a second subset of the valves, valves 915e-h) control the flow of an incoming flushing gas and the flow of an outgoing flushing gas. Specifically, as an example, valves 915g and 915h can control the flow of the incoming flushing gas and valves 915e and 915f can control the flow of the outgoing flushing gas.

The product stream can be the result of a pyrolysis reaction of the type discussed herein, such as the breakdown of methane (and/or another hydrocarbon) into hydrogen gas and solid carbon. The pyrolysis reaction can be done within a pyrolysis reactor (e.g., reactor 110), in some embodiments, and therefore the product stream can be an outlet from the pyrolysis reactor (e.g., reactor 110). Accordingly, the product stream can include hydrogen gas, solid carbon, organic compounds, unreacted hydrocarbons (e.g., methane that did not break down in the reactor), and/or various other compounds. In some embodiments, the adsorption separation component 900 is downstream from one or more separation components (e.g., separation components 125a, 125b, 125c, and/or any other separation components (e.g., 126)) such that the product stream at the inlet of the adsorption separation component 900 contains only trace amounts of (or no) solid carbon. In these embodiments, the product stream directed into the adsorption separation component 900 is a gas product stream, as the solid and/or liquid particles (including the carbon) have already been separated/removed from the product stream.

The adsorption components 912 can include one or more adsorptive materials that are configured to remove one or more organic compounds from the product stream. For example, the adsorbent components 912 can include adsorptive materials such as activated carbon, zeolite (“molecular sieves”), polymers, metal-organic frameworks, bentonite clay, and/or the like. In some embodiments, the adsorption components 912 include a plurality of the adsorptive materials so that the adsorption components 912 are capable of adsorbing a plurality of different components in the gas (e.g., the gas that remains in the product stream). For example, different adsorbents can be used as mixtures. In another example, different adsorbents can be in multistage adsorption components 912 where each stage contains a different adsorbent material to remove different organic compounds in series. Additionally, or alternatively, different grades of the adsorptive materials (e.g., different grades of activated carbon and/or zeolites) can be used to target specific organic compounds and/or to conform the adsorption components 912 to operating parameters.

In various embodiments, the adsorption components 912 can include fixed-bed adsorption components and/or moving-bed adsorbers (such as rotary adsorbers). Purely by way of example, the adsorption components 912 can include a rotating drum. In some such embodiments, the product stream flows through a section of the drum in a direction parallel to a rotational axis of the drum while a heated flushing gas flows through another section of the drum simultaneously. As a result, the adsorption component 912 can be continuously regenerated as it rotates.

The incoming flushing gas can include one or more process gasses already consumed, used, and/or produced by the pyrolysis system (e.g., system 100, 700, etc.). For example, the flushing gas can include a hydrocarbon reactant (e.g., natural gas, methane, and/or the like), combustion fuel for the pyrolysis reactor (e.g., hydrogen gas, natural gas, methane, and/or the like), flue gas from a combustion component, and/or a portion of the hydrogen gas from the cleaned product stream. As a result, the outgoing flushing gas (also referred to herein as a desorbed stream, as it is a stream of the outgoing gas(es) such as the flushing gas and any desorbed organic compounds) can be sent back to the pyrolysis reactor (e.g., reactor 110), or another suitable endpoint in the pyrolysis system (e.g., 100, 700, etc.), to be consumed. For example, as discussed in more detail below, when the hydrocarbon reactant is used in the incoming flushing gas, the outgoing desorbed stream (i.e., the hydrocarbon reactant carrying the desorbed organic compounds) can be fed into the pyrolysis reactor (e.g., 110). There, the hydrocarbon undergoes the pyrolysis reaction discussed above while the organic compounds decompose into hydrogen gas, solid carbon, and/or various other suitable gasses. As a result, a separation component of the type illustrated in FIG. 9 (e.g., adsorption separation component 900) can establish a closed loop in the pyrolysis system (e.g., 100, 700, etc.) for capturing and processing the organic compounds. The closed loop can help reduce (or eliminate) the volume of organic compounds that must be processed in later systems (e.g., oxidized). For example, the outgoing flushing gas (i.e., desorbed stream) can be transmitted/vented to an oxidizer. Further, the closed loop can help reduce (or eliminate) the carbon dioxide emissions associated with treating the organic compounds.

In the embodiment illustrated in FIG. 9, the adsorption separation component 900 includes a vacuum component 920 coupled to the flow path for the outgoing flushing gas. The vacuum component 920 can help support the desorption process by creating a pressure drop through the adsorption components 912 to pull the flushing gas through the adsorption components 912 and/or can help maintain an appropriate pressure in the adsorption components 912 to ensure interactions between the flushing gas and the adsorption components 912. Additionally, or alternatively, the vacuum component 920 can help reduce a temperature required for the incoming process gasses to desorb the adsorption components 912. The separation component 900 can include valves 925a and 925b to help control the flushing gas flow through the adsorption separation component 900 and to and from the vacuum component 920. The valves 925a and 925b can be a part of the second subset of valves (e.g., valves 915e-h and 925a-b), in some embodiments. In some embodiments, the adsorption separation component 900 does not include the vacuum component 920. For example, the incoming flushing gas can be pressurized and/or have a naturally sufficient pressure to cause the desorption to occur and push the flushing gas into another point in the pyrolysis system. In these embodiments, the adsorption separation component 900 may not include valve 925b, which can control the flow to the vacuum component 920.

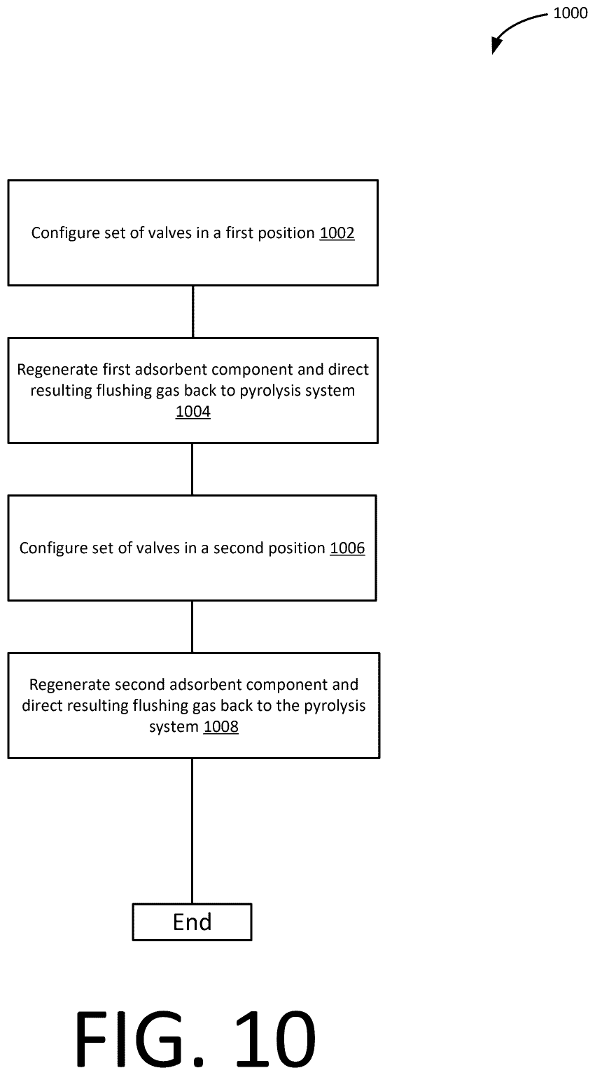

FIG. 10 is a flow diagram of a method 1000 for regenerating (e.g., including desorbing) a separation component (e.g., adsorption separation component 900) of a pyrolysis system (e.g., system 100, system 700, etc.) in accordance with some embodiments. The method 1000 can be implemented by a controller of a pyrolysis system in communication with one or more components of the pyrolysis system to direct a flow of gasses through the system. For example, in some instances, pyrolysis system 100 and/or 700 can include a controller, and the controller can be in communication with one or more components of the system 100 and/or 700.

The method 1000 begins at block 1002 by configuring a set of valves in a first position to regenerate one or more first adsorption components of the pyrolysis system. For example, referring to FIG. 9, the method 1000 at block 1002 can close a subset of the valves (e.g., valves 915d and 915b) controlling the flow of the product stream into and out of the adsorption component 912b while opening a subset of the valves (e.g., valves 915h and 915f) controlling the flow of incoming and outgoing flushing gas to the adsorption component 912b. In some instances, valve 925a can also be open. That is, in the first position, the valves are positioned to prevent the product stream from flowing into the adsorption component 912b and to allow the incoming flushing gas to flow through the adsorption component 912b. Thus, the first position can include valves 915d and 915b in a closed position, and valves 915h and 915f in an open position. As a result, the flushing gas can desorb organic compounds from the adsorption component 912b (e.g., to regenerate the adsorption component 912b). Further, in the first position, the valves (e.g., valves 915f and 925a, and, in some instances, 925b) direct outgoing gas from the adsorption component 912b (e.g., the outgoing flushing gas) back toward the pyrolysis system (e.g., into the pyrolysis reactor (e.g., 110)) rather than toward an endpoint for the cleaned product stream.

Still further, in the first position, the valves (e.g., valves 915c, 915a, etc.) direct the product stream through the adsorption component 912a while preventing the flushing gas from flowing into the adsorption component 912a. As an example, the first position can further include having valves 915c and 915a in open positions (so that the product stream can be directed through the adsorption component 912a) and valves 915g and 915e in closed positions (to prevent the flushing gas from flowing through the adsorption component 912a). As a result, the adsorption component 912a can continue to process the product stream while the adsorption component 912b is regenerated, thereby allowing the pyrolysis system to continue to operate during regeneration. After the product stream flows through the adsorption component 912a, the valves in the first position (e.g., 915a in an open position and 915b in a closed position) can direct gas flowing out of the adsorption component 912a (e.g., cleaned hydrogen gas) toward an endpoint (e.g., a hydrogen-consuming unit such as a furnace, water heater, power generation component, and/or the like; another process unit to condition the product such as a compressor, membrane separator, and/or the like; and/or a hydrogen storage unit, or natural gas pipeline, storage tank, and/or the like) and/or back to the pyrolysis reactor (e.g., 110) to help power the reactor.

Referring to FIG. 10, at block 1004, the method 1000 includes regenerating the first adsorption component(s) (e.g., the adsorption component 912b of FIG. 9) and directing the resulting flushing gas back to the pyrolysis system. That is, at block 1004, the method 1000 allows the flushing gas to flow through the first adsorption component(s) 912b to desorb the first adsorption component(s) and directs the organic compound-carrying flushing gas back to the pyrolysis system. The regeneration process at block 1004 can be implemented for a predetermined time period (e.g., 1 minute, 2 minutes, 5 minutes, 30 minutes, 1 hour, 2 hours, and/or any other suitable time period), until a sensor in the adsorption component 912b detects a predetermined amount of organic compounds have been removed therefrom (e.g., a weight sensor, chemical sensor and/or the like), until a chemical sensor in the flow returning to the pyrolysis reactor detects a concentration of organic compounds below a threshold level, and/or the like.

At block 1006, the method 1000 includes configuring the set of valves in a second position to regenerate one or more second adsorption components of the pyrolysis system. In some embodiments, the second position is generally opposite the first position to reverse which adsorption components are being regenerated. For example, referring again to FIG. 9, the method 1000 at block 1004 can close a subset of the valves (e.g., valves 915c and 915a) controlling the flow of the product stream into and out of the adsorption component 912a while opening a subset of the valves (e.g., valves 915g and 915e) controlling the flow of incoming and outgoing flushing gas to the adsorption component 912a. That is, in the second position, the valves are positioned to prevent the product stream from flowing into the adsorption component 912a (by closing valves 915c and 915a) and to allow the incoming flushing gas to flow through the adsorption component 912a (by opening valves 915g and 915e). As a result, the flushing gas can desorb organic compounds from the adsorption component 912a (e.g., to regenerate the adsorption component 912b). Further, in the second position, the valves direct outgoing gas from the adsorption component 912a (e.g., the outgoing flushing gas) back toward the pyrolysis system (e.g., into the pyrolysis reactor 110) rather than toward the endpoint for the cleaned product stream.

Still further, in the second position, the valves direct the product stream through the adsorption component 912b (for example, by opening valves 915d and 915b) while preventing the flushing gas from flowing into the adsorption component 912b (for example, by closing valves 915h and 915f). As a result, the adsorption component 912b can continue to process the product stream while the adsorption component 912a is regenerated, thereby allowing the pyrolysis system to continue to operate during regeneration. After the product stream flows through the adsorption component 912b, the valves in the second position can direct gas flowing out of the adsorption component 912a (e.g., cleaned hydrogen gas) toward an endpoint (e.g., a hydrogen-consuming unit such as a furnace, water heater, power generation component, and/or the like; another process unit to condition the product such as a compressor, membrane separator, and/or the like; and/or a hydrogen storage unit, or natural gas pipeline, storage tank, and/or the like).

At block 1008, the method 1000 includes regenerating the second adsorption component(s) (e.g., the adsorption component 912a of FIG. 9) and directing the resulting flushing gas back to the pyrolysis system. That is, at block 1008, the method 1000 allows the flushing gas to flow through the second adsorption component(s) to desorb the second adsorption component(s) and directs the organic compound-carrying flushing gas back to the pyrolysis system. Similar to the method 1000 at block 1004, the method 1000 at block 1008 can regenerate the second adsorption component(s) for any suitable period of time and/or until any suitable condition is detected (e.g., that a predetermined volume of organic compounds has been desorbed from the second adsorption component(s)).

In some embodiments, the method 1000 then returns to block 1002 and repeats to continuously cycle through regenerating the first and second adsorption components. In some embodiments, the method 1000 completes after block 1008. In such embodiments, the method 1000 can be periodically triggered by a detection of a regeneration condition (e.g., a predetermined time since last regeneration, a detection of a predetermined volume of organic compounds in the first and/or second adsorption components, and/or the like). In some embodiments, the method 1000 continues to configure the valves (e.g., valves 915a, 915b, 915c, 915d, 915e, 915f, 915g, 915h, 925a, and/or 925b) in yet further positions to regenerate still further adsorption component(s) in the pyrolysis system while using the first and second adsorption components to remove organic compounds from the product stream.

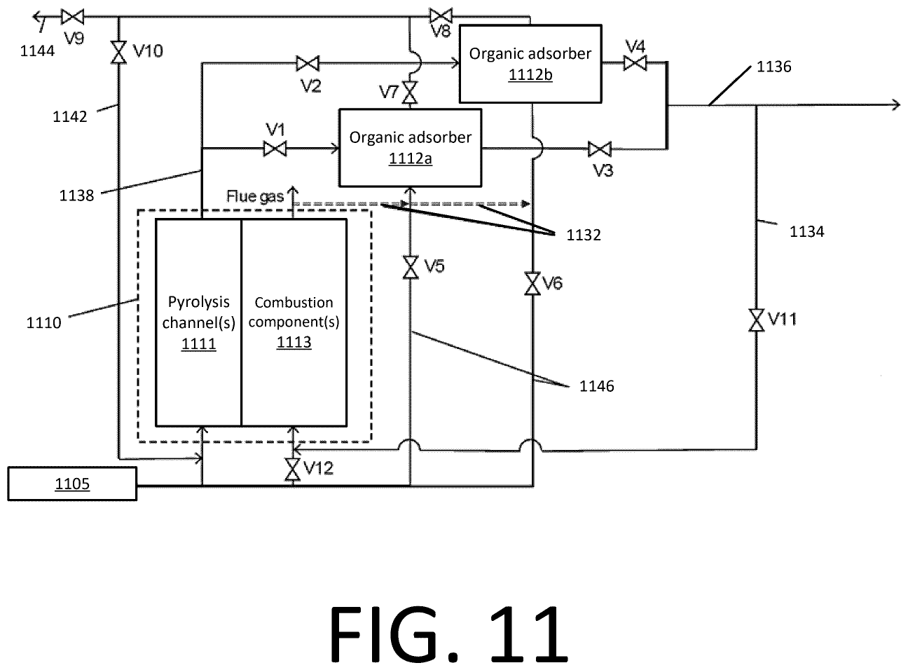

FIG. 11 is a schematic diagram of a pyrolysis system 1100 with adsorption components 1112a and 1112b configured in accordance with some embodiments. In some embodiments, as discussed herein and depicted in FIG. 9, the adsorption components 1112a and 1112b are part of a separation component (for example, the same as and/or similar to separation component 900). More specifically, FIG. 11 is a schematic illustration of a pyrolysis system 1100 configured to use a hydrocarbon reactant 1105 (sometimes also referred to herein as a “process feedstock,” a “process inlet gas,” “system feed,” and/or the like) to regenerate the adsorption components 1112a and 1112b (referred to collectively as adsorption components 1112). The adsorption components 1112 can be the same as and/or similar to adsorption components 912, in some embodiments. As discussed above, the hydrocarbon reactant 1105 can include natural gas, methane, renewable natural gas, biogas, and/or any other suitable hydrocarbon gas. In some embodiments, pyrolysis system 1100 can be the same as/similar to pyrolysis system 100 and/or 700.

In pyrolysis system 1100, a system feed 1105 may be fed into a pyrolysis reactor 1110. Although the system feed 1105 may be referred to herein as a hydrocarbon reactant 1105, the system feed 1105 can be a hydrocarbon reactant, process feedstock, process inlet gas, etc. In some embodiments, as depicted in FIG. 11, the pyrolysis reactor 1110 can include one or more pyrolysis channels 1111 and one or more combustion components 1113. Although the pyrolysis channel 1111 and the combustion component 1113 may be referred to herein in a singular form, the pyrolysis channel 1111 can include any number of pyrolysis channels and the combustion component 1113 can include any number of combustion components. In some embodiments, the pyrolysis reaction of the system feed 1105 occurs in the pyrolysis channel 1111. The combustion component 1113 can provide the input heat for the pyrolysis reaction in the pyrolysis channel 1111, in some embodiments.

To regenerate the adsorption components 1112, the system 1100 can follow a process generally similar to (or identical to) the method 1000 discussed above with reference to FIG. 10. For example, to configure the illustrated valves in the first position (e.g., block 1002 of FIG. 10), valves V1 and V3 are opened and valves V5 and V7 are closed, allowing the product stream/product gas 1138 effluent from the pyrolysis reactor 1110 to flow through organic adsorption component 1112a while preventing the hydrocarbon reactant 1105 from flushing the organic adsorption component 1112a. As a result, the organic adsorption component 1112a can selectively remove organic byproducts from the product stream 1138 by adsorption. The organic byproducts can be recycled 1142 to the reactor 1110 and/or take an alternate path 1144. When organic byproducts are removed from the product stream 1138, the product stream 1138 can become a purified product 1136 (for example, partially purified, fully purified, etc.) (also referred to herein as a purified product stream). In some embodiments, at least a portion of the purified product 1136 can be recycled 1134 to the reactor 1110. In some embodiments, at least a portion of the purified product 1136 can be transmitted to other separators, purifiers, etc. and/or can be transmitted to some other product gas endpoint.

Further, in this example, valves V6 and V8 are opened and valves V2 and V4 are closed, allowing the hydrocarbon reactant 1105 to pass through organic adsorption component 1112b while preventing the flow of product gas 1138 through the organic adsorption component 1112b. The hydrocarbon reactant 1105 can be used as a flushing gas 1146 (also referred to as a desorption gas), in this instance. As a result, the hydrocarbon reactant 1105 can desorb organic compounds from the organic adsorption component 1112b (e.g., regenerate the organic adsorption component 1112b) and then be fed into the pyrolysis reaction chamber(s)/channel(s) 1111 and/or the combustion component(s) 1113 of the pyrolysis reactor 1110. In some embodiments, heat 1132 can be provided to the flushing/desorption gas 1146 from hot flue gas.

To configure the valves in the second position (e.g., block 1006 of FIG. 10), valves V5 and V7 are opened and valves V1 and V3 are closed, allowing the hydrocarbon reactant 1105 to pass through the organic adsorption component 1112a while preventing the flow of product gas 1138 through adsorption component 1112a. As a result, the hydrocarbon reactant 1105 can desorb organic compounds from organic adsorption component 1112a and then be fed into the pyrolysis reactor 1110 (e.g., the pyrolysis channel(s) 1111 of the reactor 1110) and/or the combustion component(s) 1113. Further, valves V2 and V4 are opened and valves V6 and V8 are closed, allowing the product stream 1138 effluent from the pyrolysis reactor 1110 to flow through organic adsorption component 1112b while preventing the hydrocarbon reactant 1105 from flushing the organic adsorption component 1112b. As a result, the organic adsorption component 1112b can selectively remove organic byproducts from the product stream 1138 by adsorption.

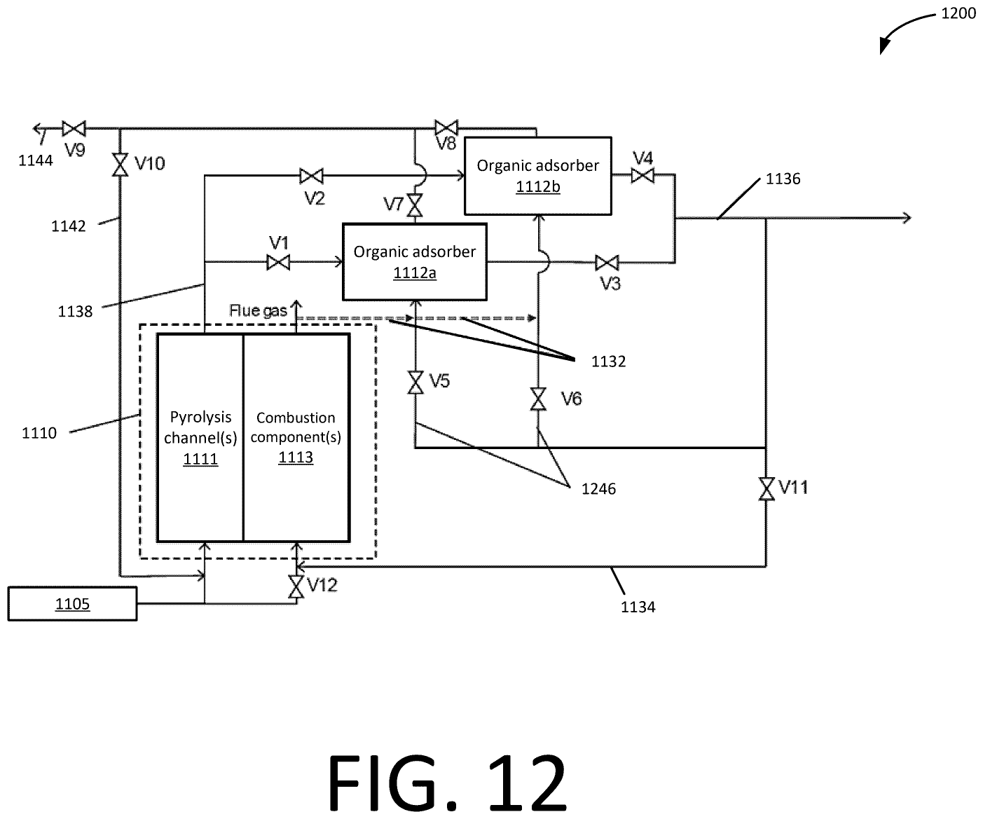

FIG. 12 is a schematic diagram of a pyrolysis system with a pyrolysis system 1200 configured in accordance with some embodiments of the present technology. As illustrated in FIG. 12, the pyrolysis system 1200 is generally similar to the pyrolysis system 1100 discussed above with reference to FIG. 11. For example, valves V1-V12 can be configured in generally similar positions to those discussed above with reference to FIG. 11 to regenerate the adsorption components 1112. However, in the embodiments illustrated in FIG. 12, the valves V1-V12 are positioned to direct partially (or fully) purified product gas 1136 (e.g., hydrogen gas) through the adsorption components 1136 as the flushing gas 1246 (also referred to herein as a desorption gas). The effluent hydrogen gas and organic compounds can then be directed 1134 to the combustion component(s) 1113 in the pyrolysis reactor 1110 to supply input heat to drive the pyrolysis reaction (in the pyrolysis channel(s) 1111) and to destroy the organic compounds (e.g., producing steam, carbon dioxide, and/or the like), and/or to the pyrolysis reaction chamber(s)/channel(s) 1111 of the pyrolysis reactor 1110 where the organic compounds can be converted into carbon, hydrogen, or other molecules.

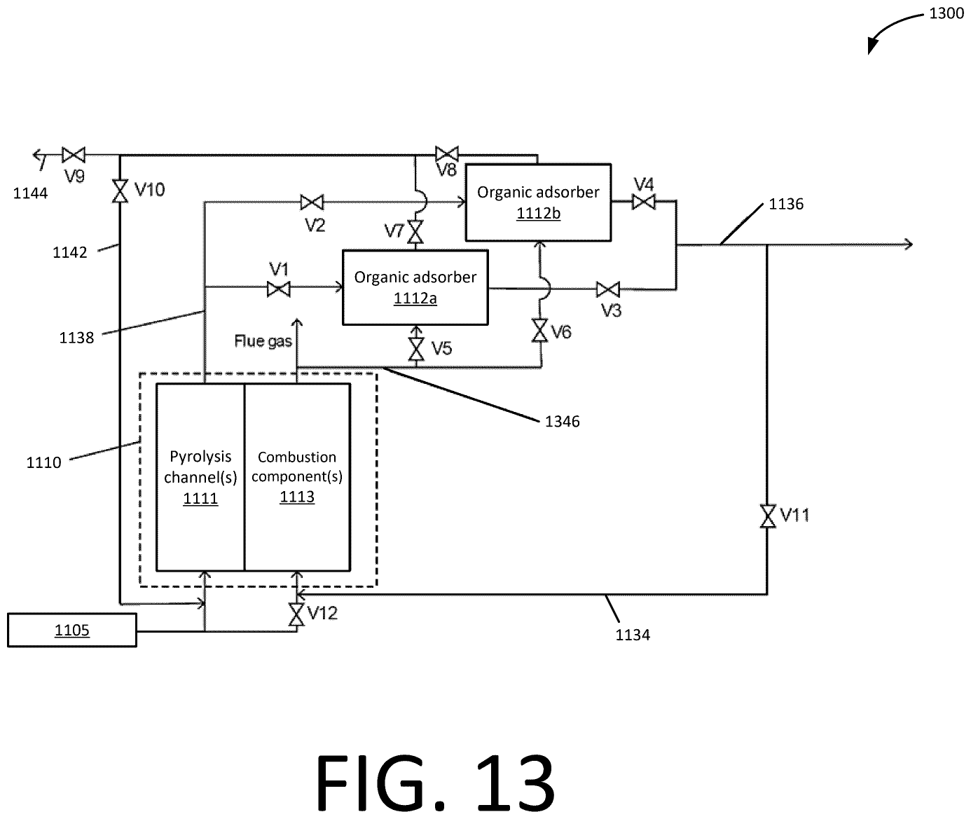

Similarly, FIG. 13 is a schematic diagram of a pyrolysis system 1300 configured in accordance with some embodiments of the present technology. As illustrated in FIG. 13, the pyrolysis system 1300 is generally similar to the pyrolysis system 1100 discussed above with reference to FIG. 11. For example, valves V1-V12 can be configured in generally similar positions to those discussed above with reference to FIG. 11 to regenerate the adsorption components 1112. However, in the embodiments illustrated in FIG. 13, the valves V1-V12 are positioned to direct combustion flue gas through the adsorption components 1112 as the flushing gas 1346. Put differently, in pyrolysis system 1300 the flushing gas/desorption gas 1346 is the combustion flue gas. In some instances (not depicted), the effluent flue gas and organic compounds can then be directed to a collection component in the pyrolysis system 1300 to destroy, contain and/or transport the organic compounds. While using flue gas to desorb the adsorption component 1112 requires later processing on the effluent gas, the flue gas does not require additional heating components and/or heat transfer components since it is already sufficiently hot. Further, because the flue gas primarily includes nitrogen gas and steam (especially when hydrogen gas is burned in the combustion component), the flue gas can act as an effective substitute for a pure inert gas to safely desorb the adsorption components 1112. In some embodiments, the pyrolysis system 1300 can include a three-way-catalyst component that treats the flue gas before and/or after the adsorption component 1112 to oxidize the organic compounds carried therein.

In any of the embodiments discussed above with reference to FIGS. 11-13, a pressure inside either (or both) of the organic adsorption components 1112 can be set based on whether the organic adsorption components 1112 are acting to remove organic material from the product stream (e.g., normal operation) or are in a regeneration state. For example, regenerating the adsorption component 1112 at a higher pressure than what is used under normal operation allows the effluent from the regeneration process to be recycled into the pyrolysis reactor 1110 without additional pressurization. For example, the pressure inside the organic adsorption components 1112 can be between about 20 pounds per square inch gauge (psig) and about 25 psig during normal operation, and between about 30 psig and about 35 psig during regeneration. In various other examples, the pressure inside the organic adsorption components 1112 can be between about 0 psig and about 25 psig during normal operation, and between about 10 psig and about 40 psig during regeneration; between about 25 psig and about 100 psig during normal operation, and between about 35 psig and about 200 psig during regeneration; between about 100 psig and about 1,000 psig during normal operation, and between about 110 psig and about 1,100 psig during regeneration; or between about 1,000 psig and about 10,000 psig during normal operation, and between about 1,100 psig and about 11,000 psig during regeneration. The elevated pressure can be supplied by one or more compressors integrated into the pyrolysis system (e.g., 1100, 1200, 1300, etc.) and/or by the pressure of the incoming hydrocarbon reactant 1105.

Further, the organic adsorption components 1112 can be designed to handle a wide range of adsorption and regeneration flows. For example, the organic adsorption components 1112 can be regenerated using a fraction or all of the hydrocarbon reactant 1105 (e.g., natural gas, propane, and/or other suitable hydrocarbons) used for pyrolysis, and can recycle the effluent stream back to the pyrolysis reactor 1110. For example, the adsorption flow of the product stream (e.g., the volume of the product stream flowing through the organic adsorption components 1112 to be treated) can be about 300 standard cubic meters per hour (Sm³/h), while regeneration flow (e.g., the volume of the product stream flowing through the organic adsorption components 1112 to regenerate the organic adsorption components 1112) can be about 50 Sm³/h (where standard temperature and pressure conditions for Sm³/h are defined as 15° C. (59 degrees Fahrenheit) and 1 atmosphere (14.696 pounds per square inch atmospheric (psia) or 101.325 kilopascals (kPa))). In various other examples, the adsorption flow can be between about 0.1 Sm³/h and about 300 Sm³/h while the regeneration flow is between about 0.01 Sm³/h and about 200 Sm³/h; the adsorption flow can be between about 300 Sm³/h and about 10,000 Sm³/h while the regeneration flow is between about 200 Sm³/h and about 9,000 Sm³/h; the adsorption flow can be between about 10,000 Sm³/h and about 1,000,000 Sm³/h while the regeneration flow is between about 9,000 Sm³/h and about 900,000 Sm³/h; or the adsorption flow can be between about 1,000,000 Sm³/h and about 10,000,000 Sm³/h while the regeneration flow is between about 900,000 Sm³/h and about 9,000,000 Sm³/h.

Further, as discussed above, the regeneration processes can be continuously cycled and/or periodically implemented. For example, in embodiments with periodic implementation, each of valves V1, V2, V3, and V4 can be opened during normal operation so that the product stream 1138 flows through both organic adsorption components 1112, while valves V5, V6, V7, and V8 are closed. Further, other valve configurations can be used during startup, shutdown, emergency conditions, or other conditions, to selectively route either the product stream 1138 or hydrocarbon reactant 1105 through none, some, or all adsorption units (e.g., to fully close off one of the organic adsorption components 1112 in response to a detected error).

As further illustrated in FIGS. 11-13, the pyrolysis system also includes valves V9 and V10 to selectively route the mixture of flushing gas and desorbed organics (shown as flow 1142) (sometimes referred to herein as “effluent gas” and/or “effluent flushing gas” from the adsorption unit) back into the pyrolysis reactor 1110. As discussed above, the pyrolysis reactor 1110 can then convert the effluent gas into hydrogen, carbon, and other products. Additionally, or alternatively, the valves V9 and V10 can route the effluent gas to an alternate location (shown as flow 1144), such as a storage container or oxidation unit for treatment and/or later consumption in the pyrolysis system (e.g., 1100, 1200, 1300, etc.). Additionally, or alternatively, the valves V9 and V10 can route the mixture of desorbed organics and flushing gas into the combustion component(s) 1113 of the pyrolysis reactor 1110 to be combusted to provide heat to the pyrolysis chamber/channel 1111 while destroying the organic compounds.

The pyrolysis system can also include valves V11 and V12 that allow either product gas 1136 or hydrocarbon reactants 1105 to be delivered into the combustion component 1113 of the pyrolysis reactor 1110 (e.g., to combust a portion of the cleaned hydrogen gas to provide heat to the pyrolysis reaction). While the schematic diagrams of FIGS. 11-13 illustrate gas in the product stream 1136 being recycled to the combustion component 1113 from a point downstream from the organic adsorption components 1112 (e.g., after being cleaned) (shown by flow 1134), the recycle stream 1134 can additionally (or alternatively) be drawn from a point upstream from the organic adsorption components 1112. In such embodiments, a portion of the product stream (e.g., product stream 1138 prior to being fed into the adsorber(s) 1112) can be directed to the combustion component before the organic compounds are removed, thereby allowing the organic compounds in that portion of the product stream 1138 to be destroyed in the combustion component 1113 without needing to be adsorbed and desorbed from the organic adsorption components 1112. As a result, directing a portion of the product stream 1138 to the combustion component 1113 upstream from the organic adsorption components 1112 can help reduce the flow through the organic adsorption components 1112 and therefore reduce the frequency the organic adsorption components 1112 need to be regenerated.

As further illustrated in FIGS. 11 and 12, the hot flue gas from the combustion component 1113 can be thermally coupled to the desorption flushing gas 1146, 1246 (e.g., to an input of the hydrocarbon reactant 1105) upstream from the organic adsorption components 1112. For example, the pyrolysis system (e.g., 1100, 1200, etc.) can include a heat exchanger between an outlet for the hot flue gas from the combustion component 1113 and an input channel for the flushing gas to the adsorption components 1112 (e.g., the hydrocarbon reactant 1105, partially purified product gas, and/or the like). As a result, the hot flue gas can help support a thermal swing regeneration process to more efficiently desorb the organic compounds from the organic adsorption components 1112. Additionally, or alternatively, the hot product gas can be thermally coupled to the desorption flushing gas 1146, 1246 (e.g., to an input of the hydrocarbon reactant 1105) upstream from the organic adsorption components 1112 to provide the heat for the thermal swing regeneration process. Additionally, or alternatively, the pyrolysis system (e.g., 1100, 1200, etc.) can include an electric heater and/or another suitable source of heat to help ensure that the hydrocarbon reactant 1105 is hot enough to desorb the organic adsorption components 1112. A target temperature for the hydrocarbon reactant 1105 during regeneration can be based on an interaction energy of the adsorbent material in the organic adsorption components 1112 and the organic compounds adsorbed therein. In various embodiments, for example, the target temperature for the hydrocarbon reactant 1105 during regeneration is between about 25° C. and about 600° C.; between about 200° C. and about 500° C.; between about 50° C. and about 400° C.; between about 70° C. and about 300° C.; or between about 250° C. and about 350° C.

In some embodiments, the thermal coupling between the incoming flushing gas 1146, 1246 (e.g., the incoming hydrocarbon reactant 1105) and the various sources of heat are controllable. For example, once a regeneration process is complete, the incoming flushing gas 1146, 1246 can be thermally decoupled from the sources of heat such that the desorption flushing gas flows through the organic adsorption components 1112 until the adsorbent material therein reaches an adequate temperature for adsorption. In various embodiments, for example, the adsorption temperature can be between 10 about ° C. and about 55° C., between about 15° C. and about 50° C., or between about 20° C. and about 45° C.

In embodiments that include a vacuum component downstream from the organic adsorption components 1112, however, the target temperature for the hydrocarbon reactant 1105 during regeneration is lowered. For example, the target temperature for the hydrocarbon reactant 1105 during regeneration can be lowered to between about −20° C. and about 50° C. As a result, embodiments that include a vacuum component can omit the cooling process after the regeneration process since the adsorbent material in the organic adsorption components 1112 will already be at an adequate temperature for adsorption.

In some embodiments, the pyrolysis system (e.g., 1100, 1200, 1300, etc.) includes additional valves that allow the pyrolysis system to continuously select the flushing gas from the hydrocarbon reactant (e.g., flushing gas 1146), the product stream (e.g., flushing gas 1246), the combustion flue gas (e.g., flushing gas 1346), inert gas, air, steam, and/or any combination thereof. In such embodiments, the pyrolysis system can also include other components (e.g., electrical- or combustion-based heaters, cooling devices, compressors, and/or the like) to modulate the amount of heat delivered to the adsorption components 1112 during regeneration and/or the pressure of the flushing gas. In a specific, non-limiting example, the pyrolysis system can include one or more heating and/or cooling components (e.g., heat exchange components) directly coupled to the adsorption components 1112 to help control the temperature therein. Additionally, or alternatively, the pyrolysis system can control the flow rate of the flushing gas (e.g., 1146, 1246, 1346, etc.) such that the energy carried in the flushing gas to the adsorption component 1112 exceeds the sum of the energy required to heat the adsorbent component 1112 plus the energy required to desorb the organic compounds from the adsorption component 1112. As a result, the pyrolysis system can help ensure sufficient energy is delivered by the flushing gas (e.g., 1146, 1246, 1346, etc.) to regenerate the adsorption components 1112.

Further, the pyrolysis system can also include one or more components to monitor and/or control the adsorption components 1112. For example, the pyrolysis system (e.g., 1100, 1200, 1300, etc.) can include one or more sensors coupled to the adsorption components 1112 (or other suitable components) to measure the total amount (e.g., by volume and/or weight) of organic compounds that have been collected in the adsorption components 1112 since the last regeneration period. As a result, the pyrolysis system can detect when the adsorption components 1112 are nearing capacity and/or becoming less effective at removing the organic compounds from the product stream. In a specific, non-limiting example, the total amount of the organic compounds that have been adsorbed since the last regeneration cycle can be determined through measurements of the concentrations of the organic compounds before and after the adsorption components 1112 and/or flowrates of the product stream through the adsorption components 1112. Similarly, the total amount of the organic compounds that have been removed from the adsorption components 1112 during regeneration can be determined by measuring the concentrations of the organic compounds before and after the adsorption components 1112 and/or flowrates of the flushing gas (e.g., 1146, 1246, 1346, etc.) through the adsorption components 1112 during regeneration.

Additionally, or alternatively, the total amount of the organic compounds that have been adsorbed or removed (desorbed) can also be determined through measurements of the temperature of the adsorption components 1112. The determination is based on the exothermic nature of the adsorption, which causes an increase in the temperature of the adsorption components. That is, the magnitude of the temperature increase can be proportional to the amount of the organic compounds that have been adsorbed. Similarly, temperature change can also be used to determine the amount of the organic compounds that have been removed from the adsorption components 1112 during regeneration. The specific relationship between the temperature change in the adsorption components 1112 and the amount of organic compounds that have been adsorbed or removed may be established experimentally, using calibrations, direct calculations using known parameters of the pyrolysis system (e.g., the enthalpy of adsorption, heat capacity of the adsorbent(s), and/or other suitable factors), and/or a combination thereof.

In response to these measurements, a controller can recommend and/or implement changes to the operating conditions of the pyrolysis system (e.g., 1100, 1200, 1300, etc.). For example, the controller may detect that an adsorption component 1112 is close to reaching its full capacity (or some suitable fraction of full capacity) and, in response, can configure sets of the valves V1-V12 to regenerate the adsorption component 1112 while directing the product stream into another adsorption component 1112 to adsorb organic compounds from the product stream. Alternatively, or additionally, as discussed above, the controller can implement the operational changes based on the elapsed time since the last regeneration period, a combination of elapsed time and other factors such as feed rate of reactants into the pyrolysis reactor, reactor temperature(s), and/or the like.

In some embodiments, the controller uses external data sources (such as the price of the hydrocarbon reactant, price of hydrogen, price of carbon co-product, product purity requirements, carbon dioxide emissions requirements, price of electricity, price of carbon dioxide emissions credits, and/or the like), to determine whether to route the desorbed organic compounds to a reaction chamber(s)/channel(s) 1111 in the pyrolysis reactor 1110, to an oxidation unit, to the combustion component 1113 of the pyrolysis reactor 1110, or to some other destination. For example, the selection of the injection point of the mixture of flushing gas and desorbed organic compounds and the selection of flushing gas can impact an operational efficiency of the pyrolysis reactor 1110. In a specific, non-limiting example, when the price of hydrogen is sufficiently high, the controller can route the desorbed organic compounds to a destination other than the pyrolysis reactor 1110 to maximize hydrogen production and therefore the value generated by the pyrolysis system (e.g., 1100, 1200, 1300, etc.). Additionally, or alternatively, the controller can use the external inputs (e.g., price of the hydrocarbon reactant, price of hydrogen, price of carbon co-product, product purity requirements, carbon dioxide emissions requirements, price of electricity, price of carbon dioxide emissions credits, and/or the like) to select between using the hydrocarbon reactant, product gas, combustion flue gas, inert gas, air, steam, and/or another suitable gas as the desorption flushing gas.

In some embodiments, the controller is coupled to one or more heat sources (e.g., togglable heat exchangers, electric heaters, and/or the like) to modulate the amount of heat delivered to the adsorption components 1112 during regeneration. For example, the controller can operate (or position) the heat sources to directly heat the adsorption components 1112 and/or to pre-heat the desorption flushing gas (e.g., 1146, 1246, 1346, etc.). In another example, the controller can operate (or position) the heat sources (and/or heat exchange components) to directly cool the adsorption components 1112 and/or to cool the desorption flushing gas (e.g., 1146, 1246, 1346, etc.).

Further, in various embodiments, the controller can be manually or automatically switched to other states, such as an emergency state, a startup state, a shutdown state, and/or any other suitable state. In these states, the controller can configure the valves V1-V12 in a variety of other positions. For example, the controller can configure the valves V1-V12 to divide the flow of the product stream between multiple adsorption components 1112, to override normal operation states, and/or to bypass adsorption component(s) 1112.

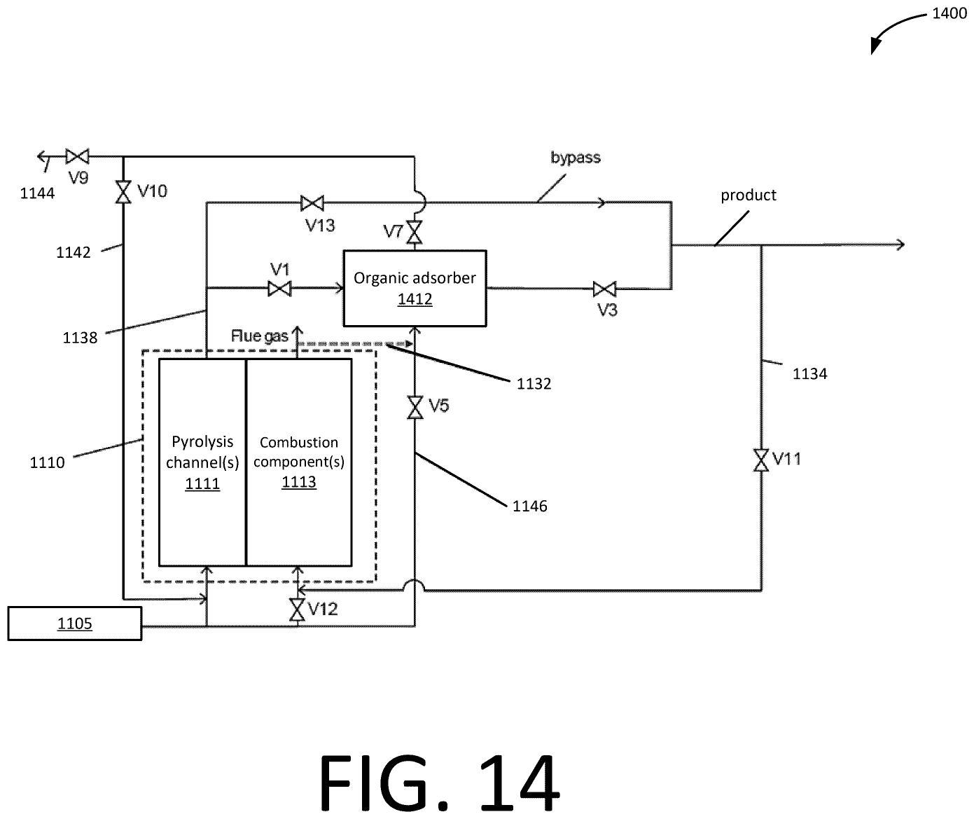

While the embodiments discussed above with reference to FIGS. 9-13 have been discussed in the context of a pyrolysis system (e.g., 1100, 1200, 1300, etc.) that includes multiple adsorption components 1112, it will be understood that the technology disclosed herein is not so limited. FIG. 14 is a schematic diagram of a pyrolysis system 1400 configured in accordance with some embodiments. As illustrated in FIG. 14, the pyrolysis system 1400 is generally similar to the pyrolysis system 1100 discussed above with reference to FIG. 11. For example, the system 1400 includes valves that can be configured in generally similar positions to those discussed above with reference to FIG. 11 to regenerate the adsorption component 1412 (for example, with the adsorption component 1412 being a part of a separation component). In some embodiments, a separation component and/or the pyrolysis system 1400 includes a single adsorption component 1412. To regenerate the single adsorption component 1412, the valves can be configured to stop a flow of the product stream 1138 through the adsorption component 1412 (e.g., closing a first valve V1). Additionally, or alternatively, the operation of the pyrolysis reactor 1110 can be reduced (or shut off entirely) to slow (or stop) the flow of the product stream 1138 during regeneration (e.g., to avoid pressure build-up upstream from the adsorption component 1412 while the first valve V1 is closed). Alternatively, the product stream 1138 can include a bypass valve (e.g., a thirteenth valve V13) to direct the product stream 1138 around the adsorption component 1412 during regeneration.

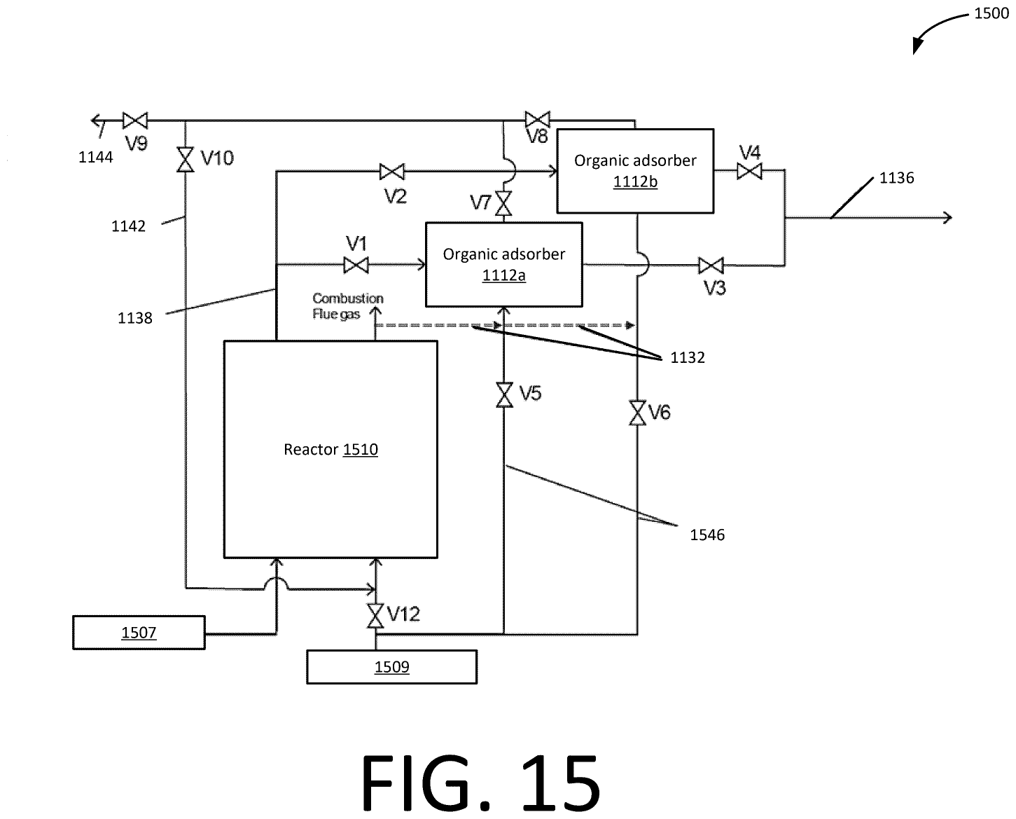

Further, as noted above, the systems and methods disclosed herein are not limited to use within a pyrolysis system (e.g., pyrolysis system 100, 700, 1100, 1200, 1300, 1400, etc.). For example, the regeneration processes discussed above can be used in any system requiring the adsorptive removal of species (e.g., an organic compound) from a liquid or gas stream followed by regeneration of the adsorbent component. Purely by way of example, the regeneration processes discussed above can be employed in the combustion of biomass to generate energy, petroleum refining, chemical manufacturing, and/or various other suitable settings. FIGS. 15-18 are schematic diagrams of generic systems with separation components configured in accordance with further embodiments of the present technology.

For example, FIG. 15 illustrates a system 1500 that includes adsorption components 1112 (in some instances, as part of the separation component) and set of valves that are generally similar to those discussed above with reference to FIGS. 11-13. Further, in the illustrated embodiment, the system includes a reactor 1510 with two input streams (1507 and 1509). A first input stream 1507 contains reactants that are a precursor for making a desired product, and a second input stream 1509 contains fuel for combustion in the reactor 1510. In the illustrated embodiment, part of the combustion fuel 1509 is diverted (shown by flow 1546) from the reactor 1510 and used as a desorption gas (referred to herein as desorption gas 1546 and/or flushing gas 1546) in the adsorption components 1112 using a set of valves generally similar to those discussed above with reference to FIGS. 11-13. The effluent from the adsorption components 1112 during regeneration (mixture of desorption flushing gas and desorbed organic material) can then be recycled to the combustion fuel inlet of the reactor 1510. Similar to the systems shown in FIGS. 11 and 12, heat 1132 from the combustion flue gas and/or the reactor product stream can be used to heat the flushing gas 1546 before it enters an adsorption component 1112 during regeneration.

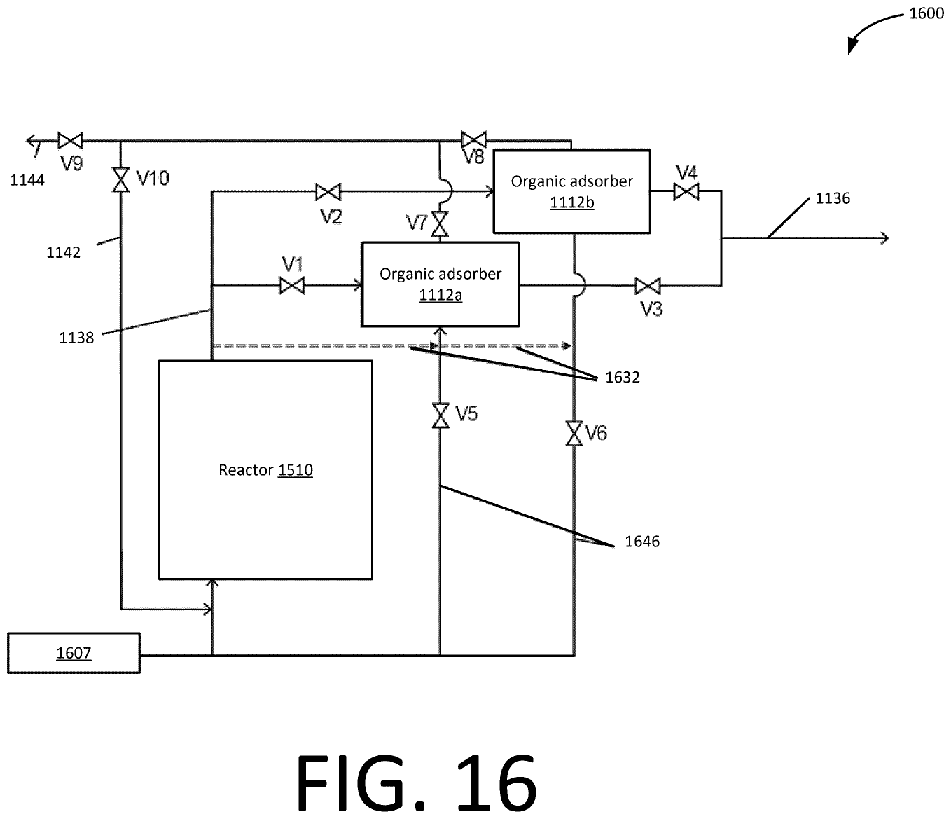

FIG. 16 is a schematic diagram of a system 1600 generally similar to the system 1500 discussed above with reference to FIG. 15. In the illustrated embodiment, however, the reactor 1510 has a single input stream of reactants 1607. The single stream of reactants 1607 can include one or more chemical compounds that are pre-mixed and/or flow through multiple inputs in parallel to mix within the reactor 1510. In the illustrated embodiment, a portion of the reactants 1607 are diverted for use as a flushing gas/desorption gas 1646 before being directed into the reactor 1510. As a result, the reactants (as flushing gas 1646) can desorb the adsorption components 1112 and carry organic compounds (and/or various other suitable chemical species) into the reactor to be converted mostly into hydrogen and carbon. In some embodiments, heat 1632 can be provided to the desorption gas (e.g., 1646) from the product gas 1138.

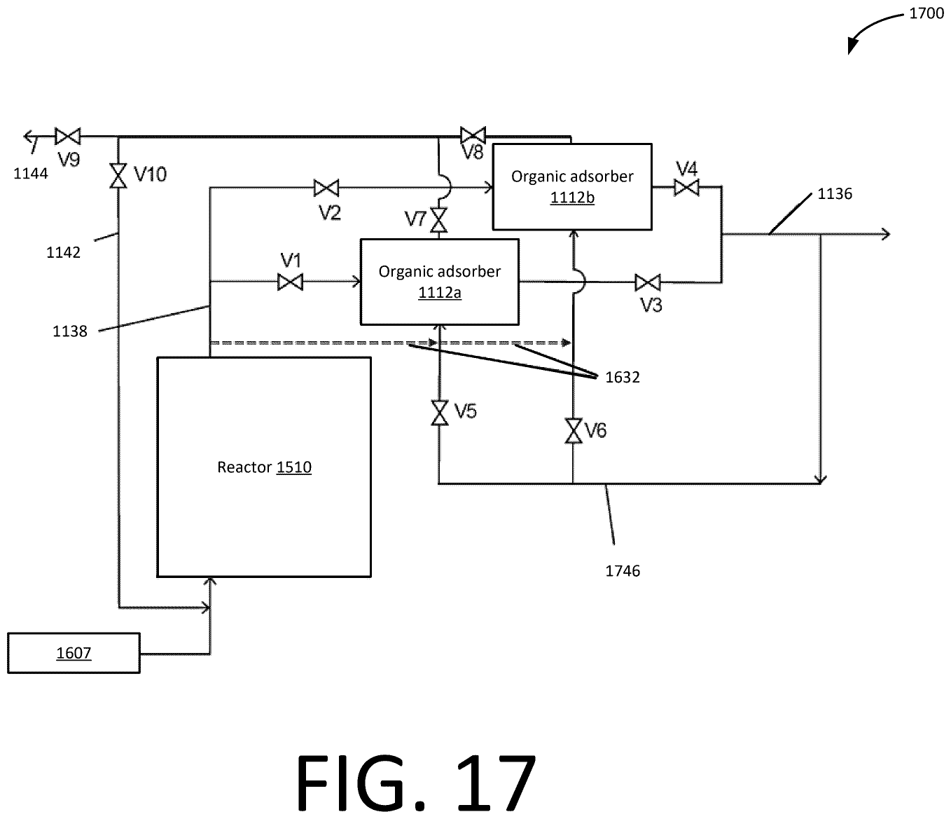

FIG. 17 is a schematic diagram of a system 1700 generally similar to the system(s) (e.g., 1500 and 1600) discussed above with reference to FIGS. 15 and 16. Similar to FIG. 16, for example, the reactor 1510 has a single input stream of reactants 1607. The single stream of reactants 1607 can include one or more chemical compounds that are pre-mixed and/or flow through multiple inputs in parallel to mix within the reactor 1510. In the illustrated embodiment, however, a portion of the cleaned product stream 1136 is diverted (shown by flow 1746) for use as a flushing gas/desorption gas 1746 before being directed into the reactor 1510 and/or to another component for collection.

As also noted above, regeneration processes using hydrocarbon gas or hydrogen as a flushing gas can be employed in a variety of systems in place of other flushing gasses. The use of hydrocarbon and/or hydrogen gas can be especially beneficial, for example, in systems where the presence of oxygen, water, nitrogen, or other components would be problematic (e.g., systems sensitive to combustion, systems with electronics sensitive to water, cost-conscious systems, and/or the like).

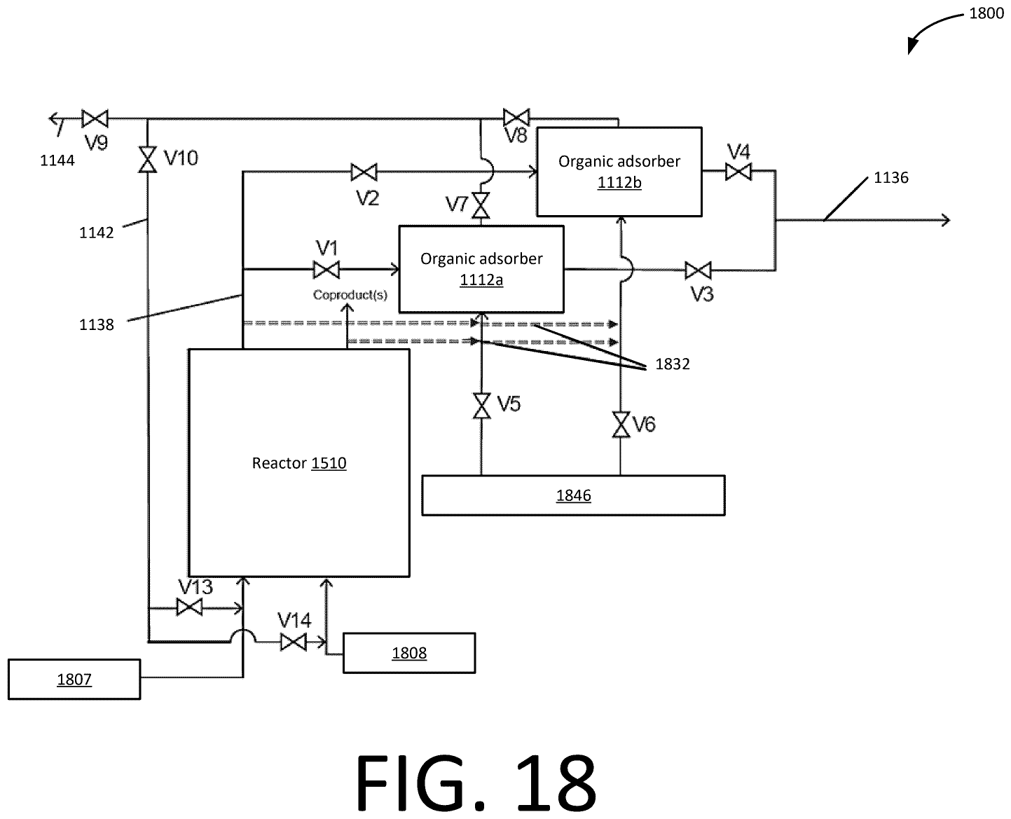

Thus, FIG. 18 is a schematic diagram of a system 1800 with adsorption components 1112 (for example, within a separation component) configured in accordance with some embodiments. As illustrated in FIG. 18, the system 1800 can be generally similar to the systems (e.g., 1500, 1600, and/or 1700) discussed above with reference to FIGS. 15-17. In the illustrated embodiment, however, the system 1800 includes a dedicated source of an alternative flushing gas 1846 (e.g., natural gas from a pipeline, tank, or compressor; methane; mixed hydrocarbons; RNG; biogas; propane; hydrogen; a mixture of hydrogen and one or more hydrocarbon gasses; mixtures of these gases with air, oxygen, and/or inert gas). This can be referred to as a desorption flushing gas source 1846, in some instances. In such embodiments, the effluent gas from the adsorption component 1112 during regeneration can be routed to various suitable endpoints. For example, when the reactor 1510 is able to consume and/or otherwise break down the effluent gas (e.g., in a combustion component in the reactor 1510), the effluent gas can be directed to the reactor 1510 by one or more valves in the system. In another example, the effluent gas can be directed to another suitable channel in the reactor (e.g., a dedicated pyrolysis and/or oxidation channel) to break down and/or destroy the organic compounds. In yet another example, the effluent gas can be directed to a storage component (or other suitable endpoint) via an alternate path to be consumed and/or processed by downstream components (e.g., to another methane tank coupled to a combustion component to generate heat and destroy the organic compounds). Similar to the systems (e.g., 1100, 1200, 1500) shown in FIGS. 11, 12, and 15, and in the systems (e.g., 1600, 1700, 1800) shown in FIGS. 16-18, streams exiting the reactor 1510 can be used to pre-heat the flushing gas (shown as heat 1832) before it enters an adsorption component during regeneration. In some embodiments (not depicted), the reactor 1510 can have a single input stream of reactants. In some embodiments, the reactor 1510 (of system 1800) can have a first input stream 1807 of reactant(s) and a second input stream 1808 of reactant(s). Each input stream (1807, 1808) can have a single reactant and/or a plurality of reactants.

As discussed herein, a system (such as pyrolysis system 100) can have a plurality of separation components (and in some instances one or more heat exchange components) to separate the various components (e.g., solid carbon, hydrogen gas, and various byproduct(s)) of the product stream from a reactor (such as a pyrolysis reactor). Having a plurality of separation components can more effectively separate the components of the product stream as the separation component(s) can be tailored to the type(s) of components, their size, etc. For example, one or more separation components can be solid separators (and, in some instances, each of the solid separators can be organized sequentially to remove different particle sizes), one or more separation components can be liquid separators, one or more separation components can be condensable gas separators, etc. These separation components can be organized sequentially, in some embodiments, in order to further improve the separation. The one or more heat exchange components can adjust the temperature of the product stream and can help improve and facilitate separation in the separation component(s).

In some embodiments, as discussed herein, a system (such as pyrolysis system 100) can have airlocks, a solids collection component, one or more solids processing components (e.g., a solids cooling component, solids separator, a storage component, a loading component, etc.), and/or the like. These various components can help improve the effectiveness of the system and the separation of the components in the product stream (from the reactor).

In some embodiments, as discussed herein, a system can have one or more adsorption components (for example, as part of a separator) in order to help remove organic compounds from the product stream and, in some instances, improve the regeneration process for the one or more adsorption components.

In some embodiments, a system can have various combinations of the components discussed herein. For example, while systems 1100, 1200, 1300, 1400, 1500, 1600, 1700, and 1800 are depicted with a reactor and one or more adsorption components, these systems (e.g., 1100, 1200, 1300, 1400, 1500, 1600, 1700, and/or 1800) can include various other components. As an example, one or more systems (1100, 1200, 1300, 1400, 1500, 1600, 1700, and/or 1800) can include a plurality of separation components, one or more heat exchange components, airlocks, a solids collection component, one or more solids processing components (e.g., a solids cooling component, solids separator, a storage component, a loading component, etc.), and/or the like. As another example, even though reactor 110 from system 100 is not depicted with a pyrolysis channel and a combustion component, the reactor 110 can include a pyrolysis channel and/or a combustion component (for example, the same as and/or similar to pyrolysis channel(s) 1111 and combustion component(s) 1113), in some embodiments.

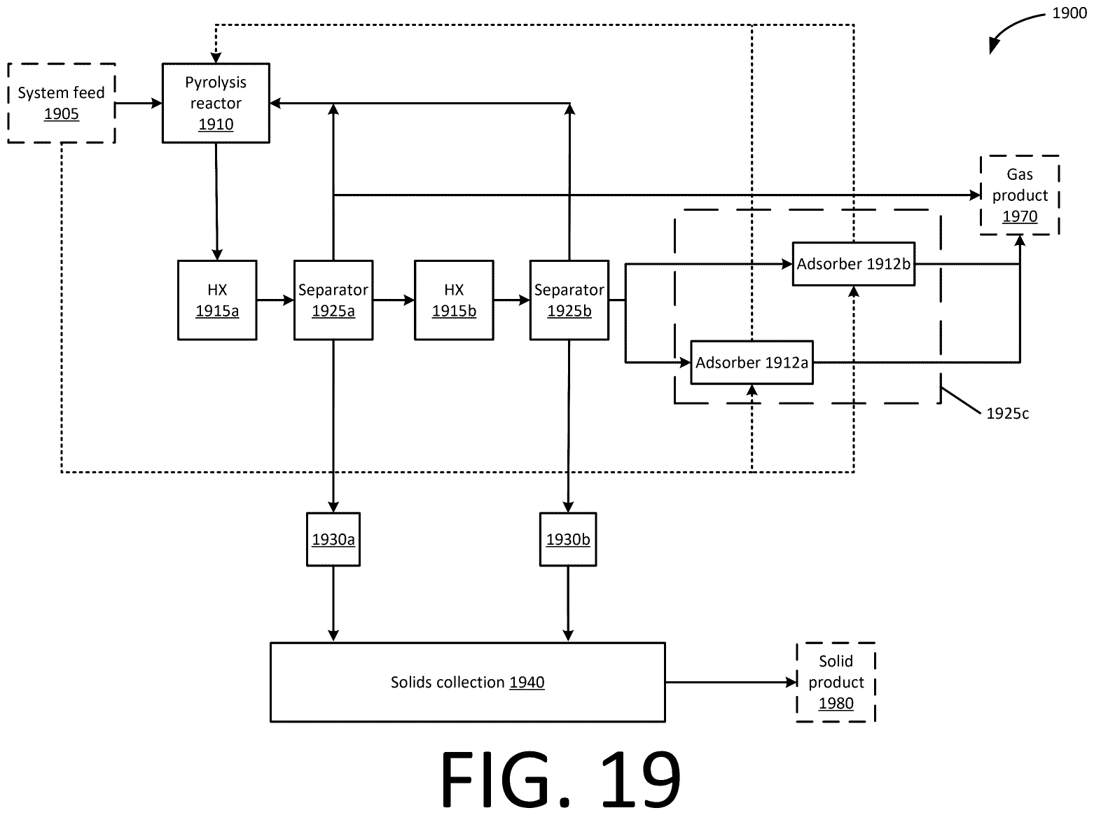

FIG. 19 illustrates an example pyrolysis system 1900 with a variety of different components, according to an embodiment. Specifically, FIG. 19 depicts a pyrolysis system 1900 with alternating heat exchange components 1915 and separation components 1925, with one such separation component including adsorption components 1912, as well as a solids collection component 1940 and airlocks 1930 separating the separation components 1925 and the solids collection component 1940. In some embodiments, components such as the pyrolysis reactor 1910, heat exchange components 1915, separation components 1925, airlocks 1930, solids collection component 1940, etc. can be the same as and/or similar to the pyrolysis reactor 110, heat exchange components 115, separation components 125, airlocks 130, solids collection component 140, etc., respectively, depicted in FIG. 1. In some embodiments, although not depicted in FIG. 19, system 1900 can include additional components (such as solids cooling component 145, solids separator 150, storage 155, loading component(s) 160, etc.) the same as and/or similar to FIG. 1.

In some embodiments, as depicted in FIG. 19, the system feed 1905 (e.g., hydrocarbon reactant, process feedstock, process inlet gas, etc.) can be fed into the reactor 1910. Although system 1900 is depicted as a pyrolysis reactor 1910, the reactor can be other types of reactors (for example, similar to reactor 1510 depicted in FIGS. 15-18). In example pyrolysis system 1900, the system feed 1905 can undergo a pyrolysis reaction within the pyrolysis reactor 1910 (for example, within a pyrolysis chamber/channel of the reactor 1910), and the pyrolysis reactor 1910 can output a product stream that can include, for example, hydrogen gas and solid carbon. While the product stream is primarily composed of hydrogen gas and solid carbon, the product stream can also include other gas products (e.g., unreacted hydrocarbons), various byproducts (e.g., partial reaction byproducts, hydrocarbon byproducts, organic compound byproducts, and/or the like), etc.

Therefore, to help separate the solid carbon, the hydrogen gas, and the other various product stream components, the system 1900 can include a plurality of separation components 1925. FIG. 19 depicts three separation components-1925a, 1925b, and 1925c-however, as discussed herein, the system can include any number of separation components 1925. In some embodiments, each separation component 1925 can be tailored to separate/remove a certain type of particle and/or a certain particle size. For example, the separation components 1925 can be ordered sequentially to remove solids, liquids, condensable gases, and/or mixtures thereof from the product stream. As a more specific example, the first separator/separation component 1925a can be a solids separation component 1925a that is configured to remove solid particles (including the solid carbon) from the product stream. In some embodiments, the first separation component 1925a can be configured to remove solids of a certain particle size (e.g., between about 50 μm and about 100 μm, between about 100 μm and about 500 μm, and/or between about 500 μm and about 25 mm).

In some embodiments, the pyrolysis system 1900 can include a plurality of solids separation components. For example, as discussed above, the first solids separation component 1925a can be configured to remove larger solid particles from the product stream. In this example, a second separation component 1925b can also be a solids separation component, however the second solids separation component 1925b can be configured to remove smaller solid particles (e.g., solids having a particle size between about 1 μm and about 3 μm, between about 3 μm and about 10 μm, and/or between about 10 μm and about 100 μm). In some embodiments, the system 1900 can include a third solids separation component (not depicted) that can be configured to remove even smaller solid particles (e.g., solids having a particle size between about 100 nanometers (nm) and about 1 μm, and/or between about 1 μm and about 3 μm).

In some embodiments, the pyrolysis system 1900 can include a liquid separation component. The liquid separation component can be a separation component such as separator vessel 400, in an exemplary instance. In embodiments where the system 1900 includes a plurality of solid separation components (e.g., separation component 1925a, separation component 1925b, etc.), the liquid separation component can be an additional separation component not depicted in FIG. 19. In embodiments where the system 1900 includes a single solid separation component (e.g., separation component 1925a), the liquid separation component can be a second separation component 1925b. In some embodiments, the system 1900 can include additional liquid separation components (i.e., a plurality of liquid separation components). This can allow the system 1900 to target and/or remove compounds from the product stream that liquify and/or freeze at varying temperatures.

In some embodiments, the pyrolysis system 1900 can include other alternative and/or additional separation components 1925. For example, the system 1900 can include a variety of alternative (or additional) gas-solids separation components 1925, such as electrostatic precipitator, cartridge filter, impingement baffles, ceramic filter, and/or other suitable components that do not require water for the separation.

In some embodiments, as depicted in FIG. 19, the pyrolysis system 1900 can include a separation component (in this instance, separation component 1925c) with adsorption components 1912 (also referred to herein as an adsorption separation component 1925c). The adsorption separation component 1925c can use adsorption to remove organic compounds from the product stream. In some embodiments, as depicted in FIG. 19, the adsorption separation component 1925c can be downstream from one or more separation components 1925. For example, the one or more solid separation components, the one or more liquid separation components, etc. can all be upstream from the adsorption separation component 1925c. In these instances, the adsorption separation component 1925c may be more of a purification component that helps purify the product stream (and the hydrogen gas) after various other components have been separated/removed from the product stream (for example, the solid carbon, byproducts, etc.). For example, the system 1900 can include a plurality of solid separation components (e.g., a first, second, and third solid separation component), one or more liquid separation components (e.g., a fourth separation component that is a liquid separation component, and in some instances a fifth separation component that is also a liquid separation component. In this example, the adsorption separation component 1925c can be the fifth and/or sixth separation component in the sequence of separation components 1925. In some embodiments, the adsorption separation component 1925c can be in any position within the sequence of separation components 1925. The adsorption separation component 1925c can be a separation component such as separation component 900, in some instances.

As discussed herein, adsorption separation component(s) 1925c can remove organic compounds from the product stream, which can help purify the product stream and its corresponding hydrogen gas. The removed organic compounds can be retained in the adsorption component(s) 1912, in some instances. Thus, the adsorption component(s) 1912 can eventually become saturated, therefore requiring regeneration (e.g., emptying, cleaning, desorption, and/or otherwise reset) in order to reset/refresh the adsorption component(s) 1912 and keep them functioning properly. In some embodiments, as depicted in FIG. 19, the system feed 1905 can be used as a flushing gas (shown by the dotted flow path from the system feed 1905 to the adsorption components 1912) and then recycled back to the pyrolysis reactor 1910 (for example, as a reactant). The flushing gas can be a desorption gas that desorbs and carries the organic compounds away from the adsorption component(s) 1912. This can be similar to FIGS. 11 and 14, in some instances. FIG. 19 depicts one example flushing gas for the adsorption component(s) 1912. As discussed herein, other flushing gases can be used. For example, FIGS. 12 and 17 depict systems 1200, 1700 with partially (or fully) purified product gas and/or product stream 1136 (e.g., partially or fully purified hydrogen gas) as the flushing gas 1246, 1746, FIG. 13 depicts a system 1300 with flue gas as the flushing gas 1346, FIG. 15 depicts a system 1400 with combustion fuel 1509 used as flushing gas 1546, FIG. 16 depicts a system 1600 where a portion of reactants 1607 are used as flushing gas 1646, and FIG. 18 depicts a system 1800 with a separate flushing gas source 1846.

Any of these exemplary systems (1100-1800) can be combined with system 1900. For example, although FIG. 19 depicts a portion of the system feed 1905 being used as the flushing gas, system 1900 can (alternatively and/or additionally) use gas product 1970 as flushing gas, flue gas as flushing gas, combustion fuel (for example, from a combustion component within the reactor 1910 and/or another energy source) as flushing gas, a portion of reactants as flushing gas, a separate flushing gas source as flushing gas, etc.

FIG. 19 depicts an adsorption separation component 1925c with a plurality of adsorption components 1912a and 1912b (for example, connected in parallel). This can be similar to separation component 900 and/or system(s) 1100, 1200, 1300, 1500, 1600, 1700, and/or 1800, in some instances. As discussed herein, utilizing a plurality of adsorption components 1912 allows for simultaneous adsorption and desorption processes. For example, one of the adsorption components (1912a or 1912b) can undergo desorption (i.e., with a flushing gas run through the component) while the other adsorption component (1912a or 1912b) performs adsorption operations to adsorb organic compound(s) from the product stream. In this example, the product stream can be run through one adsorption component 1912 while the flushing gas is run through the second adsorption component 1912. This allows for continuous functioning of the system 1900 without having to pause to regenerate an adsorption component 1912.

Although FIG. 19 depicts a plurality of adsorption components 1912, adsorption separation component 1925c can include a single adsorption component 1912, in some instances. This can be the same as and/or similar to system 1400. As discussed herein in relation to system 1400, when a system includes a single adsorption component 1912, flow of the product stream to the adsorption component 1912 can be stopped (e.g., via valve(s)) when the adsorption component 1912 is undergoing regeneration. When the flow of the product stream is stopped, the flow of the flushing gas through the adsorption component 1912 can be started (e.g., via valve(s)), thus starting regeneration of the adsorption component 1912. In some embodiments, when the system includes a single adsorption component 1912, the operation of the reactor 1910 can be stopped and/or shut down when the adsorption component 1912 is undergoing regeneration. In some embodiments, the system 1900 can include a bypass valve to direct the product stream around the adsorption component 1912 and the adsorption separation component 1925c, thus bypassing the adsorption component 1912 when the adsorption component 1912 is undergoing regeneration.

The product stream output from the adsorption separation component 1925c can be partially and/or fully purified gas product (e.g., hydrogen gas) 1970. As discussed herein in relation to other exemplary system(s), the gas product 1970 can be recycled/reused to various components of the system 1900 (e.g., to help power and/or heat one or more components) and/or can be used for other various endpoint uses.

In some embodiments, the pyrolysis system 1900 can include one or more heat exchange components 1915 (such as heat exchangers (HX)) to cool the product stream. As discussed herein, the pyrolysis reactor 1910 can have a very high operating temperature. Therefore, the product stream exiting the pyrolysis reactor 1910 can also be a very high temperature, which in some instances can be too hot for the separation components 1925 and can negatively affect the functioning of the separation components 1925. Therefore, one or more heat exchange components 1915 can be used to cool the product stream so that it does not negatively impact the separation components 1925 and/or other components of the system 1900. Thus, as discussed herein, the heat exchange components 1915 can be operably coupled downstream from the pyrolysis reactor 1910.

In some embodiments, the heat exchange components 1915 and the separation components 1925 can be alternatingly coupled to the product stream from the reactor 1910. For example, as depicted in FIG. 19, the product stream can be coupled to a first heat exchange component 1915a, then a first separation component 1925a downstream from the first heat exchange component 1915a, then a second heat exchange component 1915b downstream from the first separating component 1925a, then a second separation component 1925b downstream from the second heat exchange component 1915b, and so on. In some embodiments, as depicted in FIG. 19, the product stream may be cooled enough by the time it reaches the adsorption separation component 1925c, therefore there may not need to be a heat exchange component 1915 upstream from the adsorption separation component 1925c. In some embodiments, although not depicted in FIG. 19, the system 1900 can include a heat exchange component 1915 between the separation component 1925b and the adsorption separation component 1925c. The heat exchange component(s) 1915 can be the same as and/or similar to heat exchange component(s) 115, in some instances.

In some embodiments, as depicted in FIG. 19, the system 1900 can include a solids collection component 1940 to collect the solid particles (e.g., including solid carbon) that have been separated from the product stream. The solids collection component 1940 can be the same as and/or similar to solids collection component 140 (FIGS. 1 and 5), in some instances. In some embodiments, not depicted, the solids collection component 1940 can direct the solids (and/or oils and/or liquids carried thereby) to a solids cooling component for further cooling. Then the solids can be directed to a solids separator to separate the solid carbon from other particulates, separate carbon particles of different sizes, separate fluid compounds from solid compounds, etc. In some embodiments, the solid product 1980 is the solid product including solid carbon as well as any other solid particles (and/or oils and/or liquids carried thereby). In some embodiments, the solid product 1980 is the solid carbon after it has been separated (for example, by a solids separator) from the other components in the solids collection component 1940.

In some embodiments, as depicted in FIG. 19, the adsorption separation component 1925c may not be connected to/coupled to the solids collection component 1940. This may be because the solid particles have all been removed from the product stream by earlier separation components (e.g., separation components 1925a, 1925b, etc.). Further, the organic compounds removed by the flushing gas may be carried with the flushing gas and recycled in the pyrolysis system 1900. In some embodiments, the adsorption separation component 1925c can be coupled to the solids collection component 1940 (for example, with an airlock 1930 between them, as discussed further herein).

In some embodiments, the pyrolysis system 1900 can include one or more airlocks 1930 between the separation components 1925 and the solids collection component 1940. As discussed herein, the product stream from the pyrolysis reactor 1910 can have a high pressure and it can be desirable to maintain the pressure in the product stream to allow the resulting hydrogen gas (e.g., gas product 1970) to be delivered to an endpoint and/or recycled for use in the system 1900 without requiring additional gas compression equipment. However, the high pressure can negatively impact the solids collection component 1940. Therefore, to help bridge between the desired higher pressure of the product stream and the desired lower pressure of the solids collection component 1940, the system 1900 can include one or more airlocks 1930. In some embodiments, each separation component 1925 coupled to the solids collection component 1940 can have a corresponding airlock 1930 between the separation component 1925 and the solids collection component 1940. For example, separation component 1925a can be connected to/coupled to a corresponding airlock 1930a and separation component 1925b can be connected to/coupled to a corresponding airlock 1930b. Airlocks 1930 are further discussed herein in relation to FIGS. 1 and 3.

A pyrolysis system 1900 with a plurality of separation components, one or more adsorption separation components, one or more heat exchange components, etc. can effectively separate the various components of the product stream (and, in some instances, purify the gas product) while also allowing for continuous operation, even while the adsorption separation component is undergoing regeneration. In some embodiments, system 1900 is a modular system the same as and/or similar to system 700 (FIG. 7). In some embodiments, although not depicted, system 1900 can include one or more valves to control flow to and/or from the various components (e.g., 1910, 1915, 1925, 1912, 1930, 1940, etc.) of the system 1900. Thus, in some instances, when flow (for example, flow of the product stream; flow of the separated solid particles, liquid particles, etc.; flow of the flushing gas; etc.) is being directed through the system 1900, one or more valves may be configured in certain positions in order to direct the flow.

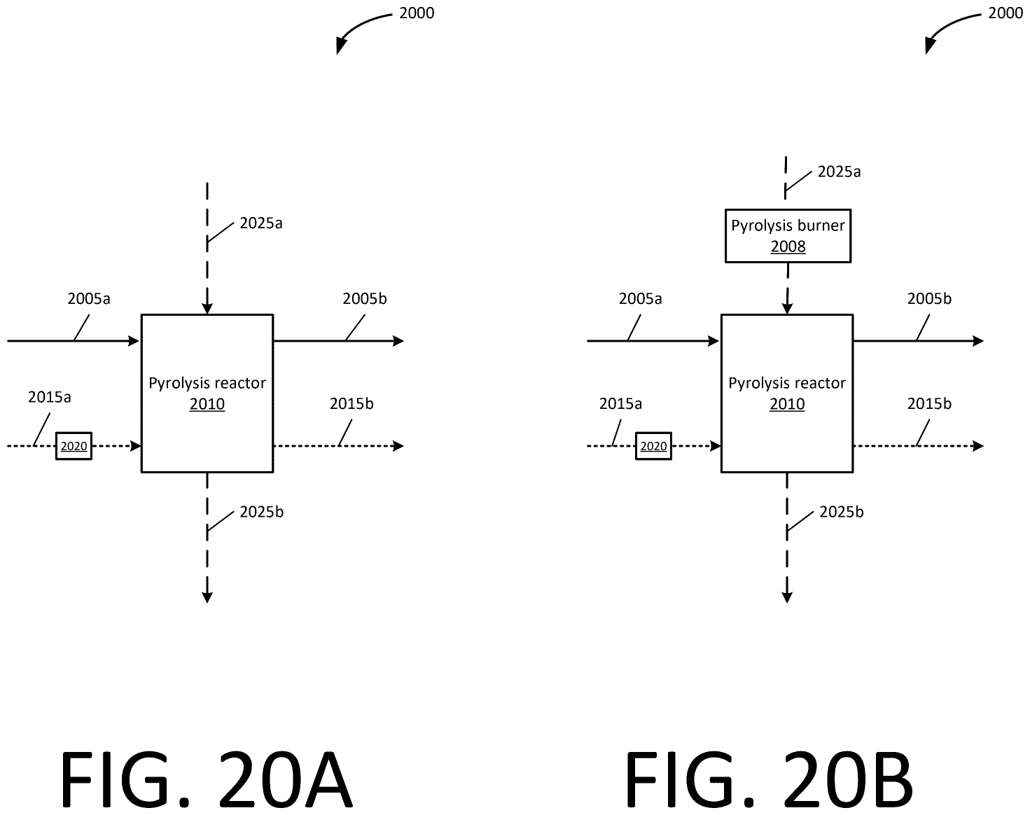

Referring now to FIGS. 20A and 20B, block diagrams of a simple regeneration process flow for a pyrolysis system 2000 are illustrated, according to an embodiment. In some embodiments, although regeneration has been discussed herein in relation to adsorption separation components, regeneration can be done on various other components of a pyrolysis system (such as system 2000, system 1900, system 100, system 700, etc.). For instance, in a pyrolysis reactor, solid carbon (for example, from a pyrolysis reaction) may accumulate on interior elements of the reactor and its outlet systems over time. The carbon may be difficult to remove during normal reactor operations (for example, operations related to the pyrolysis of hydrocarbons). Continued carbon build up in a pyrolysis reactor can block fluid flow, block heat transfer, and/or otherwise interfere with reactor operation. In conventional systems, a pyrolysis reactor may need to be shut down and disassembled, then the accumulated carbon may need to be mechanically removed, and then the reactor may need to be reassembled and restarted in order to function properly. This can be time-consuming and can require work by skilled technicians. In some instances, it can take over 24 hours to disassemble the reactor, remove accumulated carbon, and reassemble the reactor. Further, there may be additional time required to stop the feed gas and cool and purge the system and/or reactor of combustible or reactive material so the reactor can be opened safely. There can also be additional time after removal of the accumulated carbon is completed to purge the system and/or reactor of oxygen, reheat the reactor to target conditions for pyrolysis, and resume operation.

Thus, it may be desirable to remove carbon from these surfaces without complete shut down and/or disassembly of the pyrolysis system. It can also be desirable to remove carbon without interruption of hydrogen production. Removing carbon from a pyrolysis reactor without complete shut down and/or disassembly and without interruption of hydrogen production can increase throughput of the hydrogen product (for example, increasing an annual average throughput of hydrogen product) and improve the ability to provide continuous hydrogen product to downstream consumers.

Existing in-situ carbon removal methods can include fluidization, erosion, and/or mechanical removal. However, these methods may not completely remove all carbon accumulation that impacts pyrolysis reactor operation, and thus these methods may require periodic removal of any remaining carbon deposits using the complete shut down and/or disassembly methods discussed above.

Regeneration, as discussed herein, can include introducing a regeneration gas to a component (in this instance, a pyrolysis reactor) to remove the carbon and regenerate (e.g., restore full functioning to) the reactor. To remove carbon deposits from the reactor, the regeneration gas can include oxygen, which can then react with the carbon in order to oxidize the carbon and remove it from the reactor or alter carbon structural properties in order to enhance removal by methods discussed herein (e.g., fluidization, erosion, mechanical removal, etc.). FIGS. 20A and 20B depict example pyrolysis system(s) 2000 with regeneration capabilities. For example, as discussed herein, the pyrolysis reactor 2010 can have accumulated solid carbon within the reactor 2010. To regenerate the carbon, system 2000 can include a regeneration feed 2015 that feeds a regeneration gas 2015a into the pyrolysis reactor 2010. In some embodiments, in order to effectively regenerate the solid carbon, the regeneration gas 2015a can contain oxygen and can be an oxidative species such as oxygen, air, steam, a mixture of air and steam, carbon dioxide, etc. Further, when regenerating the solid carbon in the reactor 2010, the reactor can be at an elevated temperature. The combination of an elevated temperature (e.g., in the range of 500 to 750° C.; 750 to 1000° C.; 1000 to 1250° C.; 1250 to 1500° C.; etc.) and oxygen within the pyrolysis reactor 2010 can result in oxidation of the residual solid carbon (within the reactor 2010) to form carbon monoxide, carbon dioxide, hydrogen gas, water, and/or other products (for example, through water-gas and/or water-gas shift reactions).

When the solid carbon is reacted with oxygen and/or oxygen-containing compounds (such as steam or other oxygen-containing compounds), at elevated temperature(s), the resulting carbon monoxide and/or carbon dioxide product (referred to herein as regeneration product(s)) 2015b can flow out of the reactor 2010 in the vapor phase. The regeneration feed 2015 and/or regeneration flow 2015 can refer to the inlet and/or outlet of the regeneration gas(es). The regeneration inlet flow 2015a can be controlled by a valve 2020 and can refer to the oxygen containing regeneration gas 2015a that is fed into the reactor 2010. The regeneration outlet flow 2015b can refer to the regeneration product(s) (e.g., carbon monoxide, carbon dioxide, etc.) in the vapor phase that flow out of the reactor 2010 after regeneration. In some embodiments, the regeneration product(s) 2015b can be recycled into the pyrolysis process and/or pyrolysis reactor 2010 for further use; combusted in a dedicated and/or shared vapor combustor, flare, or thermal oxidizer; and/or vented directly to the atmosphere. In some embodiments, prior to atmospheric venting, the regeneration product(s) 2015b can undergo treatment to reduce concentration of oxygen, carbon monoxide, carbon dioxide, nitrogen, hydrocarbon species (e.g., methane, ethane, ethylene, etc.), and/or trace contaminants such as oxides of nitrogen. Treatment devices can include a dust filter, solid adsorbent bed, controlled combustion, catalyst bed, selective catalytic reduction (SCR), wet scrubber with or without selective chemical adsorbents, electrostatic precipitator, etc. The regeneration product(s) 2015b after required treatment(s) can be combined with other pyrolysis product streams in a single vent stack, in some embodiments. Vent stack location, including orientation and elevation, can be selected to comply with applicable standards, safety, industrial hygiene, environmental regulations, and/or good engineering practices.

In some embodiments, system 2000 can be a part of a larger pyrolysis system such as pyrolysis system 100 and/or 1900. In these embodiments, the regeneration product(s) 2015b can be fed into various component(s) (e.g., a heat exchange component 1915, a separation component 1925, etc.) (in some embodiments, this can occur after the regeneration product(s) 2015b have been treated), can be fed into a separate component (e.g., a regeneration separation component, a regeneration product endpoint, etc.), and/or can be fed into any other applicable endpoint. In some embodiments, when system 2000 is part of a larger system (such as pyrolysis system 1900) with an adsorption separation component (such as adsorption separation component 1925), the regeneration product(s) 2015b can be used by the adsorption separation component 1925 as flushing gas. In some instances, this can be the same as and/or similar to the alternative flushing gas 1846 depicted in FIG. 18.

In some embodiments, the regeneration gas(es) 2015a can include feeding a plurality of gases into the reactor 2010. For example, in some instances, both air and steam can be regeneration gases 2015a that are fed into the reactor 2010. In these instances, both water-gas and water-gas shift reactions can be performed simultaneously (at the elevated temperature range(s) discussed herein) and can form carbon monoxide, carbon dioxide, hydrogen gas, and water. The carbon monoxide, carbon dioxide, hydrogen gas, and water can be the regeneration product(s), in this instance. In some embodiments, it may be preferred to operate the reactor 2010 (at least during regeneration) at low to moderate pressure(s) in the ranges of 0 to 1 barg, 1 barg to 1 barg, 2 barg to 3 barg, and/or 3 barg to 5 barg, though operation with higher pressures may also be accommodated.

A pyrolysis reaction, as discussed herein, can break down materials (for example, hydrocarbon(s)) using heat instead of oxygen. Therefore, it is not desirable to have oxygen in the reactor 2010 during pyrolysis reactions. In some instances, the oxygen may be removed from the reactor 2010 through the regeneration product(s) 2015b exiting the reactor 2010. In some instances, the system 2000 can further include a purge feed (e.g., an inert gas purge) that flushes inert gas through the reactor 2010 to remove any remaining oxygen before resuming pyrolysis reactions.

System 2000 illustrates some example support systems to enable pyrolysis reactor 2010 regeneration. For example, in addition to a regeneration feed 2015, the system 2000 can include a pyrolysis feed 2005 and a fuel feed 2025. The pyrolysis feed 2005 can include a system feed 2005a (for example, the same as and/or similar to system feed 1905) of hydrocarbon(s) being fed into the reactor 2010, and a pyrolysis product stream 2005b (for example, containing solid carbon and hydrogen gas) that exits the reactor 2010. In some embodiments, as discussed herein, the pyrolysis reactor 2010 may need to perform pyrolysis reactions at a very high temperature. To heat the reactor 2010, a burner 2008 and a fuel feed 2025 can be utilized. In some embodiments (such as FIG. 20A), the burner can be within the reactor 2010 and/or the reactor 2010 can have alternative methods of heating. In some instances, (for example, in instances where the reactor 2010 has an alternative method of heating, etc.) the system 2000 may not include a fuel feed 2025. In some embodiments (such as FIG. 20B), the system can include a burner 2008 that can be separate from but connected to the reactor 2010. In some instances, the fuel feed 2025 can include a fuel gas input 2025a and a flue gas output 2025b. In some embodiments, as discussed herein, when a system includes an adsorption separation component (such as system 1300, 1900, etc.), the flue gas output 2025b can be recycled/used as a flushing gas (for example, the same as and/or similar to flushing gas 1346) for the adsorption component(s) within the adsorption separation component. In some embodiments, when the system 2000 includes a single pyrolysis reactor 2010, only one of the regeneration gas(es) 2015a and the system feed 2005a can be fed into the reactor 2010 at a time. Put differently, only one of regeneration and pyrolysis can be done at a time within the reactor 2010. This is because simultaneous regeneration and pyrolysis within a single reactor 2010 (e.g., a single reactor chamber) can expose the pyrolysis reaction to oxygen, which is undesirable for the pyrolysis system 2000. Instead, valves (such as valve 2020) and/or other components (such as a controller, etc.) can be used to control the flows of the feeds 2005 and/or 2015 to ensure that the oxygen from the regeneration gas(es) 2015a are not exposed to the pyrolysis reaction.

In some embodiments, system 2000 can include various component(s) to help improve functioning of the pyrolysis system 2000 and facilitate effective regeneration within the system 2000. For example, the system 2000 can include control valve(s) (in some instances, including valve 2020). The control valve(s) can include ball valve(s), globe valve(s), gate valve(s), etc. with actuator(s) driven by compressed air, an electric motor, hydraulic fluid, etc. In some instances, control valve(s) can be positioned in order to control at least the inlet flows of the fuel feed 2025, pyrolysis feed 2005, and/or regeneration feed 2015. In some instances, system 2000 can include enhanced instrumentation to optimize the system. The enhanced instrumentation can include temperature monitoring devices internal to the reactor, onstream regeneration product composition analysis, etc. In some embodiments, a temperature indicator can be positioned along the outlet stream of the regeneration product(s) 2015b. The temperature indicator can be a thermocouple inserted in a thermowell and/or attached to the outlet pipe surface (for example, by weld, magnet, adhesive, flexible strap, etc.) to measure temperatures (for example, in the ranges 500 to 750° C., 750 to 1000° C., 1000 to 1250° C., 1250 to 1500° C., etc. In some embodiments, the system 2000 can include gas analysis, which may include, but is not limited to, infrared laser spectrometer; zirconia oxygen analyzer; gas density meter; dust monitor; gas chromatograph to detect concentration of hydrogen, oxygen, carbon monoxide, carbon dioxide, nitrogen, hydrocarbon species (methane, ethane, ethylene, etc.), and/or trace contaminants such as oxides of nitrogen; etc. In some embodiments, additional manual sampling connections can be provided on the regeneration product outlet 2015b. Manual sampling can be performed by gas collection into pressurized cylinders for laboratory analysis, tested in-situ with portable gas analyzers and/or colorimetric tubes, etc.

In some embodiments (not depicted), a heat exchanger (such as a recuperator) can be provided in the regeneration product 2015b line to recover heat for process use and/or to generate a hot utility stream (such as steam, tempered water, hot oil, etc.). This can increase system thermal efficiency and/or reduce temperature at an exhaust atmospheric vent (i.e., a vent to release the regeneration product 2015b into the atmosphere), if present. In some instances, various feeds (e.g., 2005, 2015, and/or 2025), components, heat, etc. can be recycled into the process and/or the pyrolysis system 2000. For example, process recycle dispositions can include the pyrolysis reactor burner 2008, where residual combustible compounds can be burned to generate process heat.

As discussed herein, regeneration of the pyrolysis reactor 2010 can help remove residual solid carbon from the reactor 2010, therefore helping maintain and/or improve the functioning of the reactor 2010 and preventing blocked fluid flow, blocked heat transfer, etc. due to built up carbon. However, in some instances, pyrolysis reactions may need to be paused during regeneration operations to prevent the pyrolysis reaction from being exposed to oxygen (for example, from regeneration gas(es) 2015a). This can occur, for example, in systems where there is a single pyrolysis reactor 2010, such as system 2000. It may be desirable, in some instances, to perform regeneration without pausing pyrolysis reaction(s) and hydrogen gas generation. Therefore, in some embodiments, a pyrolysis system can have a plurality of pyrolysis reactors, thus having the capability to execute simultaneous pyrolysis reaction(s) and regeneration reaction(s).

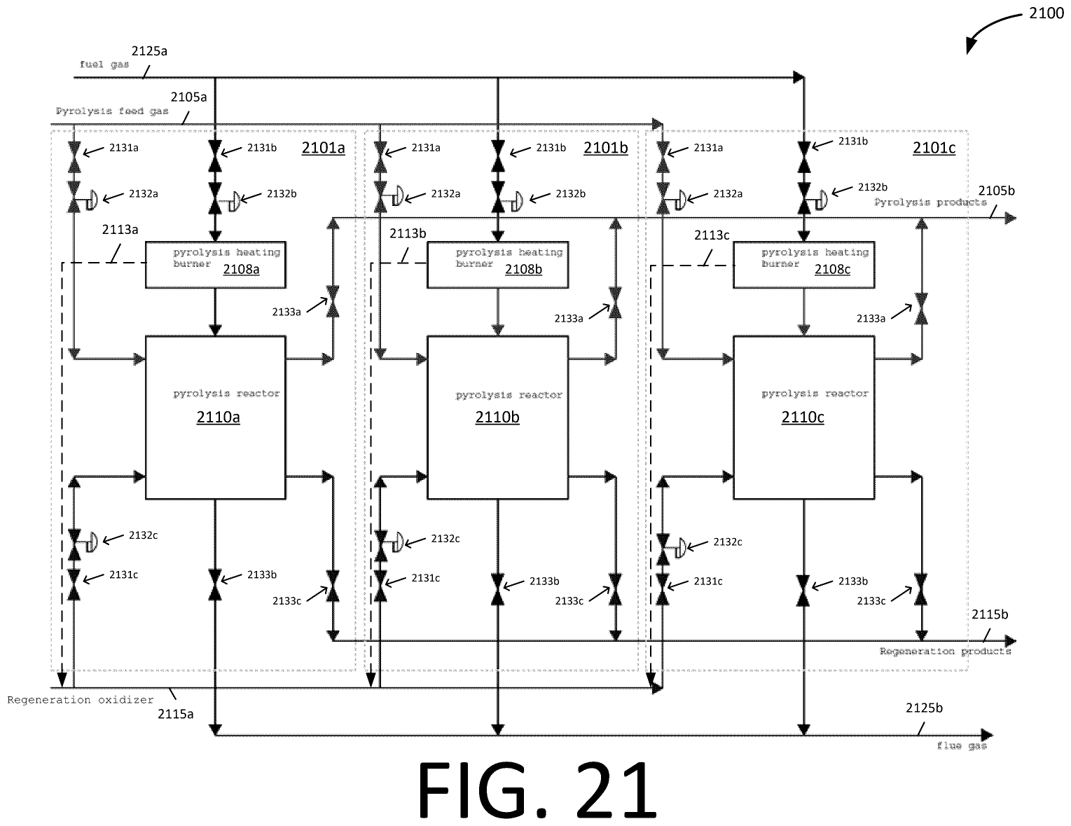

FIG. 21 is a schematic diagram of one such example pyrolysis system 2100 with regeneration capabilities and a plurality of reactors 2110, according to an embodiment. System 2100 includes three pyrolysis reactors-2110a, 2110b, and 2110c (referred to collectively as pyrolysis reactors 2110). Although FIG. 21 is depicted with three reactors 2110, system 2100 can include any plurality of reactors (i.e., any number (more than one) of reactors). Similar to pyrolysis system 2000, pyrolysis system 2100 includes a regeneration feed 2115, a pyrolysis feed 2105 (also referred to as a system feed 2105), and a fuel feed 2125. The regeneration feed 2115 can direct regeneration gas 2115a (for example, regeneration oxidizer 2115a, as depicted in FIG. 21) into the reactors 2110 to regenerate the reactors 2110 and remove residual solid carbon from the reactors 2110. After regeneration, regeneration products 2115b can be directed from the reactors 2110 to other components in the system 2100 and/or other various endpoints as a combustion fuel or customer feed. As an example, in instances where the regeneration oxidizer 2115a (i.e., regeneration input) is water and the regeneration products 2115b include syngas (i.e., hydrogen gas, carbon monoxide, and carbon dioxide), the regeneration products 2115b can be recycled back into the burner(s) 2108 and/or separated and put into the product stream.

The pyrolysis feed 2105 can direct feed gas 2105a (also referred to herein as system feed 2105a) into the reactors 2110 to undergo pyrolysis and generate a product stream (including at least hydrogen gas and solid carbon). The pyrolysis products 2105b can be directed from the reactors 2110 to other components of the system 2100 and/or a larger system. For example, the pyrolysis products 2105b can be directed to one or more heat exchange components, one or more separation components, etc. The fuel feed 2125 can direct fuel gas 2125a to pyrolysis heating burners 2108 in order to heat the pyrolysis reactors 2110. Flue gas 2125b can be output from the reactors 2110. The fuel feed 2125, pyrolysis feed 2105, and/or regeneration feed 2115 can be the same as and/or similar to fuel feed 2025, pyrolysis feed 2005, and/or regeneration feed 2015, respectively.

In some embodiments, system 2100 can include component(s) to control the system feed 2105 (such as system feed input 2105a) to achieve stable pyrolysis reactions, to achieve adequate product quality, and to manage equipment degradation and failure mechanisms. These component(s) can also control regeneration feed 2115 (such as regeneration gas input 2115a) and operating temperature in order to react the residual carbon, manage equipment with temperatures that do not exceed 500 to 750° C.; 750 to 1000° C.; 1000 to 1250° C.; 1250 to 1500° C.; etc., and maintain pressures in the ranges of 0 to 1 barg, 1 barg to 1 barg, 2 barg to 3 barg, 3 barg to 5 barg, 5 barg to 10 barg, 10 barg to 15 barg, etc. Using distribution devices (e.g., nozzles, swirlers, baffles, etc.) can promote turbulence or can direct regeneration gas 2115a to areas where carbon removal is most needed (for example, with the goal of making these processes more effective). Thus, in some instances, system 2100 can include distribution device(s) to direct regeneration gas(es) 2115a.

In some embodiments, the pyrolysis system 2100 can include a plurality of modules 2101. Each module 2101 can include a pyrolysis reactor 2110 and various corresponding components. For example, a first module 2101a includes a pyrolysis reactor 2110a, a corresponding pyrolysis heating burner 2108a, and various corresponding valve(s) 2131, 2132, and/or 2133. Similarly, a second module 2101b includes a pyrolysis reactor 2110b, a pyrolysis heating burner 2108b, and various valve(s) 2131, 2132, and/or 2133; and a third module 2101c includes a pyrolysis reactor 2110c, a pyrolysis heating burner 2108c, and various valve(s) 2131, 2132, and/or 2133. Each module 2101 can be in a regeneration mode, a pyrolysis mode, etc. and can include components that keep necessary streams/feeds separate from the other modules 2101. For example, if module 2101a is in a regeneration mode (i.e., regenerating reactor 2110a) and module 2101b is in a pyrolysis mode (i.e., performing pyrolysis reaction(s) within the reactor 2110b), the regeneration feed 2115 (i.e., regeneration gas 2115a and regeneration products 2115b) being fed through module 2101a and reactor 2110a needs to be kept separate from module 2101b (and its corresponding reactor 2110b), as a pyrolysis reaction should not be exposed to oxygen. Thus, each module 2101 can have the necessary components to keep various feeds (2125, 2105, and/or 2115) separate from various modules 2101, when necessary.

In some instances, steam from the pyrolysis heating burner(s) 2108 can be recycled back into the system 2100. For instance, as depicted in FIG. 21, steam generated from each pyrolysis heating burner 2108 can be added into the regeneration gas stream 2115a and/or used as the regeneration gas stream 2115a. This is shown by lines 2113a, 2113b, and 2113c. As an example, the steam produced by pyrolysis heating burner 2108a can be recycled (shown by flow 2113a) back into the regeneration gas stream 2115a and/or used as the regeneration gas stream 2115a; the steam produced by pyrolysis heating burner 2108b can be recycled (shown by flow 2113b) back into the regeneration gas stream 2115a and/or used as the regeneration gas stream 2115a; and/or pyrolysis heating burner 2108c can be recycled (shown by flow 2113c) back into the regeneration gas stream 2115a and/or used as the regeneration gas stream 2115a.

During regeneration, in instances where the regeneration gas 2115a is oxygen, the reaction of oxygen and carbon is exothermic (i.e., produces heat) and, in instances where the regeneration gas 2115a is steam, the reaction of steam and carbon is endothermic (i.e., consumes heat). Both reactions can increase total gas flow from the reactor(s) 2110 as carbon is converted to carbon monoxide and/or carbon dioxide. Thus, it can be desirable to control regeneration operating conditions to account for the endothermic and/or exothermic reactions and resulting effects. An example specific technique/mechanism that can control regeneration operating conditions includes addition of an inert gas (e.g., nitrogen) to increase fluid velocities inside the reactor without contributing to the regeneration reaction(s). The addition of the inert gas can also reduce exothermic reaction temperatures through dilution. Another example technique can include varying the rate of regeneration gas 2115a (e.g., oxygen, steam, etc.) being added to the reactor(s) 2110 in order to maintain temperature, gas flow rate, and/or product (effluent) gas composition within target parameters. In instances where both steam and oxygen are used as regeneration gas 2115a, if steam and oxygen are added at the same time, their ratio can be adjusted to balance exothermic and endothermic reactions and further control temperature, product gas composition, and/or other parameters. Steam and oxygen can also, or alternatively, be added at separate times during a same regeneration cycle as pulses or sequential processing stages.

The above techniques/mechanisms can require module(s) 2101 in regeneration mode to be adjusted independently from module(s) 2101 in pyrolysis mode. Adjustable parameters include regeneration gas 2115a, fuel gas 2125a, pyrolysis feed gas 2105a, and/or pyrolysis product 2105b pressure. Adjustment of these parameters can occur using control valves (e.g., including valve(s) 2131, 2132, and/or 2133) and/or instruments such as those discussed herein in relation to system 2000. In some instances, the valves and/or instruments can be located inside the boundaries of each independent modules 2101. In some embodiments, the valves in system 2100 include tight shut off valve(s) 2131, modulating valve(s) 2132, and other valves 2133. Tight shut off valves 2131a can be tight shut off valves for the pyrolysis feed 2105a, tight shut off valves 2131b can be tight shut off valves for the fuel gas 2125a, and tight shut off valves 2131c can be tight shut off valves for the regeneration gas 2115a. In some embodiments, each module 2101 can have at least one of each tight shut off valve 2131a, 2131b, and 2131c. Modulating valves 2132a can be modulating valves for the pyrolysis feed 2105a, modulating valves 2132b can be modulating valves for the fuel gas 2125a, and modulating valves 2132c can be modulating valves for the regeneration gas 2115a. In some embodiments, each module 2101 can have at least one of each modulating valve 2132a, 2132b, and 2132c. Valves 2133 can be valves controlling the outlet flows (and/or shutting off flow) from the reactor. For example, valves 2133a can control the pyrolysis product flow 2105b output from the reactors 2110. Valves 2133b can control the flue gas flow 2125b from the reactors 2110. Valves 2133c can control the regeneration product flow 2115b from the reactors 2110. In some embodiments, each module 2101 can have at least one of each valve 2133a, 2133b, and 2133c.

In a system with multiple reactors 2110, such as system 2100, regeneration within a reactor 2110 can result in an oxidizing atmosphere in module(s) 2101 adjacent to module(s) 2101 that contain a combustible gas above its autoignition temperature (i.e., module(s) 2101 in pyrolysis mode). Gas mixing between module(s) 2101 in regeneration mode and module(s) 2101 in pyrolysis mode could create an explosive mixture. Further, flow control devices (such as valves 2131, valves 2133, and/or other flow control devices) may be designed to modulate flow and may not be capable of tight shut off. Thus, as discussed herein and depicted in FIG. 21, system 2100 can include additional devices with tight shut off (e.g., tight shut off valves 2131) to prevent gas mixing. In some embodiments, tight shut off valves 2131 can include any combination of gate, ball, segmented ball, and/or tight closure butterfly. In some instances, depending on process conditions, specialty high temperature valves can be selected to tolerate temperatures of 500 to 700° C., 700 to 900° C., 900 to 1000° C., etc. The specialty high temperature valves may include customized features in order to form a valve that reliably operates at these temperatures. These features can include materials of construction, active cooling, specially engineered internal tolerances, etc. The tight shut off valves 2131, modulating valves 2132, and/or valves 2133 can be specialty high temperature valves, in some instances. In some embodiments, the valves (e.g., 2131, 2132, and/or 2133) may need to be able to seal against a differential pressure of 0.5 barg to 1 barg, 1 barg to 2 barg, 2 barg to 3 barg, 3 barg to 5 barg, 5 barg to 10 barg, 10 barg to 15 barg, etc. Customized features may be needed in order to form a valve that reliably operates at these absolute pressures and pressure differentials. These customized features can include materials of construction, active cooling, specially engineered internal tolerances, live loaded seals, multiple and/or tandem seals, high integrity scrapers, incorporating components made from materials softer than steel (such as graphite), etc.

In some embodiments, as discussed herein, system 2100 is designed to ensure that the valves (e.g., 2131, 2132, and 2133) are operated in a manner that prevents an explosive mixture. As discussed herein, an explosive mixture can occur when a module 2101 in pyrolysis mode is exposed to regeneration gas 2115a (which includes oxygen). This could occur if pyrolysis feed 2105a and regeneration gas 2115a were fed into the same reactor 2110/module 2101 and/or if a module 2101 in regeneration mode was not properly sealed (for example, using at least tight shut off valves 2131) from module(s) 2101 in pyrolysis mode. Operating the valves 2131, 2132, and 2133 in a manner that prevents an explosive mixture can also significantly reduce the probability of hazardous conditions occurring due to valve component failure and/or operator error.

In some embodiments, a controlled sequence can be used where valves (2131, 2132, 2133) are only permitted to actuate in an order that does not allow the regeneration module(s) 2101 (i.e., module(s) 2101 in a regeneration mode) and pyrolysis module(s) 2101 (i.e., module(s) 2101 in a pyrolysis mode) to mix. Feedback from monitoring instruments on the system's state may be used to permit a valve (2131, 2132, and/or 2133) to actuate. Instrument(s) can monitor flow, pressure, temperature, valve position, gas composition, etc. In some embodiments, switches can be attached to system 2100's tight shut off valves 2131 to indicate their position. Valve combinations that allow hazardous mixing are prohibited. Valve actuation is not allowed if it results in a prohibited combination. In some embodiments, limit switches can be used as a direct-contact mechanical type and/or magnetic proximity sensor. In some embodiments, other instruments (such as those discussed in relation to system 2000) can be used within system 2100. Depending on the desired degree of risk mitigation, the system 2100 can be rated to a safety integrity level per international standards and/or accepted engineering practices. Higher integrity levels (e.g., certified instruments, redundant instruments, etc.) reduce the probability of system failure, but hardware and software requirements can become more stringent.

In some embodiments, as discussed herein, pyrolysis system(s) 2000 and/or 2100 can enable pyrolysis reactor regeneration. These systems 2000 and/or 2100 can consist of control valves and instrumentation to introduce oxygen (e.g., in the form of regeneration gas) into each reactor section that would be regenerated, to control the operating temperature and/or oxygen flow rate to meet target regeneration conditions, and/or to indicate the status of the regeneration cycle (for example, whether a regeneration process has been satisfactorily completed). These systems 2000 and/or 2100 can include regeneration gas exhaust piping (and an exhaust system) that connects the reactor effluent to a suitable disposition during regeneration. The exhaust system can include treatment devices to remove entrained solids and/or undesirable combustion products. In some embodiments, for variants that simultaneously regenerate and produce carbon, the system (such as system 2100) can include an independent pyrolysis feed, product, process heating controls, and instrumentation for each distinct reactor module; isolation device(s) to separate module(s) in regeneration mode from module(s) in pyrolysis mode (in some instances, having the isolation device(s) separate from the control devices to ensure zero-leakage between modules); and/or safety interlock system(s) to prevent combination of oxygen and combustible gases.

In some embodiments, as discussed herein, pyrolysis system 2100 is a reactor system 2100 that is separated into two or more modules 2101 (FIG. 21 depicts three modules 2101a, 2101b, and 2101c) so that pyrolysis mode can be maintained in one or more modules 2101 (thus maintaining hydrogen gas generation) while one or more modules 2101 are undergoing regeneration (i.e., are in regeneration mode). In some embodiments, the system 2100 can include sufficient instrumentation and controls to determine when a module 2101 in pyrolysis mode requires regeneration and/or when a module 2101 in regeneration mode has completed the desired extent of carbon removal (from the reactor 2110).

In some embodiments, although pyrolysis system(s) 2000 and/or 2100 are depicted as individual systems, pyrolysis system(s) 2000 and/or 2100 can be a part of and/or combined with any of the systems (e.g., 100, 700, 900, 1100, 1200, 1300, 1400, 1500, 1600, 1700, 1800, and/or 1900) discussed herein. For example, any of the systems discussed herein could include a plurality of reactors and reactor modules (as depicted in FIG. 21), in order to allow for regeneration of one or more of the reactors while at least one reactor is still executing pyrolysis reaction(s) and generating hydrogen gas. As another example, any of the systems discussed herein could include a regeneration feed 2115 and various valve(s) (e.g., 2020, 2131, 2132, and/or 2133) to control whether a regeneration feed 2015, 2115 and/or a system feed 2005, 2105 are flowing through the reactor 2010, 2110 (i.e., whether the reactor 2010, 2110 is in regeneration mode or pyrolysis mode).

Although regeneration of reactor(s) has been discussed herein (for example, in relation to FIGS. 20A, 20B, and 21), the regeneration may actually occur within a pyrolysis chamber of a pyrolysis reactor. For example, a pyrolysis reactor may include other components in addition to a pyrolysis chamber. The pyrolysis chamber may be the actual chamber where pyrolysis occurs and, as such, where carbon accumulates within the reactor. Thus, regenerating the reactor may include running regeneration gas(es) through the pyrolysis chamber, thus regenerating the pyrolysis chamber and its corresponding reactor.

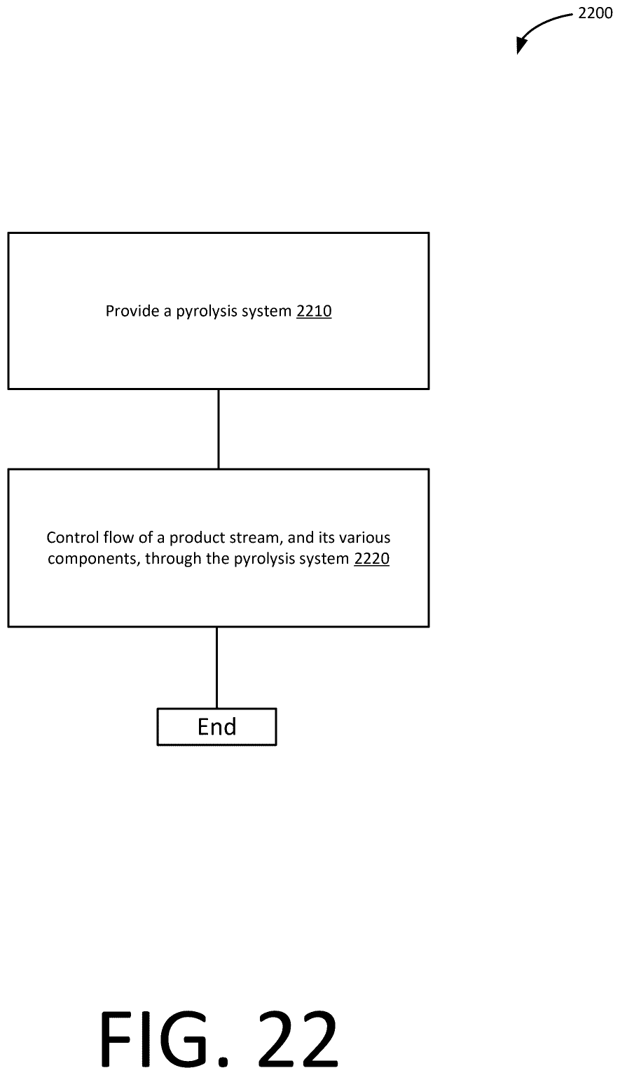

FIG. 22 depicts a method 2200 of separating components of a product stream from a reactor, according to an embodiment. In some embodiments, method 2200 can be executed by a system such as system 100, 700, 900, 1100, 1200, 1300, 1400, 1500, 1600, 1700, 1800, 1900, 2000, and/or 2100. In some embodiments, system(s) 100, 700, 900, 1100, 1200, 1300, 1400, 1500, 1600, 1700, 1800, 1900, 2000, and/or 2100 can include one or more controllers, and the method 2200 can be executed by the controller(s) of the system. While example operations for method 2200 are discussed below, method 2200 can include any separation methods and/or techniques discussed herein.

In some embodiments, method 2200 includes operation 2210 to provide a pyrolysis system. In some instances, this can be a system such as system 100, 700, 900, 1100, 1200, 1300, 1400, 1500, 1600, 1700, 1800, 1900, 2000, and/or 2100. In some embodiments, the pyrolysis system can include a pyrolysis reactor, a plurality of separation components, one or more heat exchange components, and/or a solids collection component. In some embodiments, alternatively or in addition to, the pyrolysis system can include an adsorption separation component with one or more adsorption components. In some embodiments, alternatively or in addition to, the pyrolysis system can include a regeneration feed to regenerate the reactor and, in some instances, a plurality of reactors (and corresponding reactor modules) in order to simultaneously regenerate one or more reactors and generate hydrogen gas (from pyrolysis) in a separate one or more reactors. As discussed herein, the plurality of separation components can separate/remove various components (e.g., solid carbon, byproducts, etc.) from the product stream. In some instances, one or more of the separation components can be organized in series based on particle size (e.g., organized in order of decreasing particle size). Alternatively, or in addition to, one or more separation components can be organized in series based on particle type (e.g., organized in order of solid particle removal, liquid particle removal, etc.). The one or more heat exchange components can, in some instances, cool the product stream to temperature(s) suitable for the separation component(s). The adsorption separation component(s) can, in some instances, remove/desorb organic compound(s) from the product stream, thus helping purify and/or filter the remaining product stream (entirely and/or primarily containing hydrogen gas).

In some embodiments, method 2200 includes operation 2220 to control a flow of the product stream through the pyrolysis system. As discussed herein, the product stream, and its components, can be directed through various components of the pyrolysis system in order to effectively separate the components of the product stream (e.g., hydrogen gas, solid carbon, byproducts, organic compound(s), etc.), recycle component(s) of the product stream throughout the pyrolysis system, etc.

In some embodiments, as discussed herein, the plurality of separation components can include at least a first separation component and a second separation component, and the one or more heat exchange components can include at least a first heat exchange component and a second heat exchange component. In these embodiments, operation 2220 of controlling the flow of the product stream can include transmitting the product stream to the first heat exchange component, where the first heat exchange component cools the product stream to a first temperature that is suitable for the first separation component. Operation 2220 can also include transmitting the product stream from the first heat exchange component to the first separation component, where the first separation component removes a first portion of the carbon from the product stream, and where the first portion of the carbon is carbon particles having a size greater than or equal to a first size. In some instances, operation 2220 can also include transmitting the first portion of the carbon to the solids collection component. The product stream can also be transmitted from the first separation component to the second heat exchange component, where the second heat exchange component cools the product stream to a second temperature that is suitable for the second separation component. In some embodiments, operation 2220 can also include transmitting the product stream from the second heat exchange component to the second separation component, where the second separation component removes a second portion of the carbon from the product stream, and where the second portion of the carbon is carbon particles having a size greater than or equal to a second size, the second size smaller than the first size. In some embodiments, the second portion of the carbon is transmitted to the solids collection component. In some embodiments, as discussed herein, various component(s) of the product stream can be recycled/reused throughout the pyrolysis system. Therefore, in some instances, operation 2220 can include transmitting at least a portion of remaining product stream, where the remaining product stream comprises hydrogen gas, to the pyrolysis reactor.

In some embodiments, as discussed herein, the pyrolysis system can include components such as a solids separator, solids storage, loading component(s), etc. Therefore, in some embodiments, controlling the flow of the product stream (operation 2220) can include directing/transmitting solid components through the solids separator, solids storage, loading component(s), etc. In some embodiments, solids components of the product stream can be recycled/reused throughout the pyrolysis system. Therefore, in some instances, operation 2220 can include transmitting at least a portion of remaining product stream, where the remaining product stream comprises solids, to the pyrolysis reactor.

In some embodiments, as discussed herein, the plurality of separation components can include an adsorption separation component, and the adsorption separation component can include an adsorption component and one or more valves. In these embodiments, controlling the flow of the product stream (operation 2220) can include, when the one or more valves are in a first position, transmitting the product stream to the adsorption component, where the adsorption component adsorbs one or more organic compounds from the product stream. When the one or more valves are in a second position, flushing gas can be transmitted to the adsorption component, where the flushing gas can desorb the organic compound(s) from the adsorption gas. In various embodiments, as discussed herein, the flushing gas can be a process gas (i.e., gas present in the process flow of the pyrolysis system). For example, the process gas(es) can include hydrocarbon reactants (e.g., natural gas, methane, and/or the like), hydrogen gas in the product stream, flue gas from a combustion component (e.g., containing nitrogen gas and steam), mixtures thereof, and/or various other suitable gasses. In some embodiments, operation 2220 and/or method 2200 can include steps the same as and/or similar to method 1000 (FIG. 10).

In some embodiments, operation 2220 of controlling the flow of the product stream through the pyrolysis system can include both separating various components (e.g., solid particles and liquids) from the product stream using one or more separation components, and then separating gas component(s) (e.g., organic compounds) from the product stream using one or more adsorption separation components. The resulting product stream can be hydrogen gas that can be recycled throughout the pyrolysis system and/or directed to a hydrogen gas endpoint use. The separated solid particles and/or liquids (including the carbon) can be directed to a solids collection component (and, in some instances, to additional carbon processing and/or storage components). In some embodiments, the pyrolysis system can include airlocks between the separation component(s) and the solids collection component, and operation 2220 can include controlling valve(s) of the airlocks to prevent the solids collection component from being exposed to too high of pressure. In some embodiments, once solids and/or liquids are separated/removed from the product stream, the remaining product stream (i.e., a gas product stream) can be transmitted/directed to the adsorption separation component(s) to remove the organic compound(s) from the gas product stream, resulting in a hydrogen gas product stream. Process gas(es) can also be directed/transmitted to the adsorption separation component(s) to regenerate the adsorption component(s) and desorb the organic compound(s).

In some embodiments, method 2200 can include an operation (not depicted) to control inlet flow(s) into the pyrolysis reactor. For example, when the pyrolysis system includes regeneration capabilities, controlling inlet flow(s) can include controlling one or more valves to ensure that a pyrolysis feed (i.e., system feed) and regeneration feed are separate and are not fed into the reactor at a same time. As discussed herein, it can be explosive if a pyrolysis reaction is exposed to oxygen (which can be a part of the regeneration feed). Therefore, when performing regeneration on a reactor, one or more valve(s) can be controlled so that they are in position(s) that fully shut off flow of a system feed through the reactor and open a flow of regeneration gas(es) through the reactor. Once regeneration is complete, the valve(s) can be controlled such that they are in position(s) that fully shut of flow of regeneration gas(es) through the reactor and open a flow of a system feed through the reactor.

In some embodiments, when the pyrolysis system includes a plurality of reactors and reactor modules, controlling inlet flow(s) can include controlling one or more valves (and/or other components) so that a first reactor is in a pyrolysis mode and a second reactor is in a regeneration mode, and that the first reactor and second reactor (and their corresponding modules and components) are not allowed to mix. For example, if a first reactor module, and a corresponding first reactor, are in a regeneration mode, a tight shut off valve (e.g., 2131a) for the system feed may be fully closed, in order to prevent flow of the system feed into the first reactor during regeneration. In this example, a tight shut off valve (e.g., 2131c) for the regeneration gas(es) may be open in order to flow regeneration gas(es) through the first reactor so that regeneration of the first reactor occurs. Continuing this example, a second reactor module, and a corresponding second reactor, may be in a pyrolysis mode so that hydrogen gas production is not stopped, even if a reactor (the first reactor, in this example) is undergoing regeneration. Thus, in this example, a tight shut off valve (e.g., 2131a) for the system feed may be open, in order to allow flow of the system feed into the second reactor during regeneration, and a tight shut off valve (e.g., 2131c) for the regeneration gas(es) may be fully closed, in order to prevent flow of the regeneration gas(es) into the second reactor.

The reactors referred to herein (such as reactor(s) 110, 710, 1110, 1510, 1910, 2010, and/or 2110) can be a variety of reactor types. For instance, as a non-limiting example, the reactor(s) (e.g., 110, 710, 1110, 1510, 1910, 2010, and/or 2110) can be pyrolysis reactor(s) such as thermal pyrolysis reactor(s), fluidized bed reactor(s), stationary catalyst reactor(s), molten metal or salt bubble reactor(s), plasma reactor(s), electrically heated or microwave heated reactor(s), and/or other types of reactor(s).

Advantages of embodiments disclosed herein include effectively separating the various components of the product stream (e.g., using a plurality of separation components) while preventing (e.g., using one or more heat exchange components) harm to the separation components due to a high temperature of the product stream; improving the pyrolysis system's thermal efficiency (e.g., by recycling gas from the product stream to the pyrolysis reactor or use of recuperative heat exchangers external to the pyrolysis reactor); preventing saturation of adsorption component(s) (e.g., by regenerating and/or desorbing the adsorption component(s)) while preventing waste (e.g., by using process gas(es) as flue gas, thus creating a closed loop system); removing carbon from a pyrolysis reactor without complete shut down and/or disassembly and without interruption of hydrogen production; etc.

To facilitate an understanding of the subject matter described herein, many aspects are described in terms of sequences of actions. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the application. The use of any and all examples, or exemplary language (e.g., “such as”) provided herein, is intended merely to better illustrate the subject matter and does not pose a limitation on the scope of the subject matter. The use of the term “based on” and other like phrases indicating a condition for bringing about a result, both in any claims and in the written description, is not intended to foreclose any other conditions that bring about that result. No language in the specification should be construed as indicating any non-claimed element as essential to the practice any claimed inventions.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of this disclosure. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Thus, embodiments of a pyrolysis system for separating and processing components of a product stream are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A pyrolysis system comprising:
a pyrolysis reactor comprising a pyrolysis chamber configured to generate a product stream from a system feed, wherein the system feed comprises a hydrocarbon reactant, and wherein the product stream comprises hydrogen gas and carbon;
a plurality of separation components configured to separate the product stream, wherein the plurality of separation components are downstream from the pyrolysis reactor;
one or more heat exchange components coupled to one or more of the plurality of separation components; and
a solids collection component configured to collect non-gas products separated from the product stream by the plurality of separation components, wherein the non-gas products comprise at least the carbon.

2. The pyrolysis system of claim 1, wherein the one or more heat exchange components and the plurality of separation components are alternatingly coupled to the product stream.

3. The pyrolysis system of claim 2, wherein the alternatingly coupled one or more heat exchange components and plurality of separation components comprises:
a first heat exchange component;
a first separation component downstream from the first heat exchange component;
a second heat exchange component downstream from the first separation component; and
a second separation component downstream from the second heat exchange component.

4. The pyrolysis system of claim 3, wherein:
the first heat exchange component is configured to cool the product stream to a first temperature that is suitable for the first separation component; and
the second heat exchange component is configured to cool the product stream to a second temperature that is suitable for the second separation component.

5. The pyrolysis system of claim 1, wherein one or more of the plurality of separation components are configured to transmit at least a first portion of the hydrogen gas back to the pyrolysis reactor.

6. The pyrolysis system of claim 1, wherein the plurality of separation components are configured to sequentially separate the carbon by decreasing sizes of carbon particles.

7. The pyrolysis system of claim 1, wherein the plurality of separation components comprise one or more of a gravity settler, a cyclone separator, a pulse jet baghouse filter, a high temperature filter, and a separator vessel to collect condensable liquids.

8. The pyrolysis system of claim 1, wherein the one or more heat exchange components comprise a plurality of heat exchange components, and wherein the plurality of heat exchange components are positioned in sequence to cool the hydrogen rich product from high temperature to low temperature and may recuperatively heat pyrolysis feed or other low temperature inputs to enhance pyrolysis system thermal efficiency.

9. The pyrolysis system of claim 1, further comprising one or more airlock valve arrangements between the plurality of separation components and the solids collection component.

10. The pyrolysis system of claim 1, further comprising:
a solids cooling component configured to cool a mixture containing solids to a suitable temperature for a gas-solids separator, wherein the solids cooling component is coupled to the solids collection component; and
the gas-solids separator downstream from the solids cooling component, wherein the gas-solids separator is configured to direct various portions of the mixture to at least one of the pyrolysis reactor, a resulting gas product, and an endpoint.

11. The pyrolysis system of claim 1, wherein the plurality of separation components comprises an adsorption separation component, the adsorption separation component comprising:
a first adsorption component comprising one or more adsorptive materials that are configured to remove one or more organic compounds from the product stream; and
one or more valves, wherein the one or more valves are configured to control a flow of the product stream and/or a flushing gas through the first adsorption component.

12. The pyrolysis system of claim 11, wherein the adsorption separation component further comprises:
a second adsorption component comprising the one or more adsorptive materials that are configured to remove the one or more organic compounds from the product stream, wherein the first adsorption component and the second adsorption component are in parallel; and
wherein the one or more valves are a plurality of valves, and wherein the plurality of valves are further configured to control the flow of the product stream and/or the flushing gas through the second adsorption component.

13. The pyrolysis system of claim 11, wherein the flushing gas comprises at least one of the system feed, the hydrogen gas, flue gas, combustion fuel, and a portion of one or more reactants that are a precursor for making the product stream.

14. The pyrolysis system of claim 1, further comprising a regeneration feed, wherein the pyrolysis reactor is configured to react a regeneration input with residual carbon in the pyrolysis chamber to generate a regeneration effluent stream that is output from the pyrolysis reactor, and wherein only one of the system feed and the regeneration feed can be in the pyrolysis reactor at a time.

15. The pyrolysis system of claim 14, wherein:
the regeneration input is water;
the regeneration effluent stream comprises hydrogen gas, carbon monoxide, and carbon dioxide; and
at least a portion of the regeneration effluent stream is transmitted to a burner coupled to the pyrolysis reactor and/or transmitted to the product stream.

16. The pyrolysis system of claim 14, further comprising:
a second pyrolysis reactor;
a first tight shut off valve operatively coupled to the system feed and the pyrolysis reactor;
a second tight shut off valve operatively coupled to the regeneration feed and the pyrolysis reactor;
a third tight shut off valve operatively coupled to the system feed and the second pyrolysis reactor; and
a fourth tight shut off valve operatively coupled to the regeneration feed and the second pyrolysis reactor, wherein at a same time:
the first tight shut off valve is configured in a closed position to shut off the system feed from the pyrolysis reactor,
the second tight shut off valve is configured in an open position to flow the regeneration feed through the pyrolysis reactor,
the third tight shut off valve is configured in the open position to flow the system feed through the second pyrolysis reactor; and
the fourth tight shut off valve is configured in the closed position to shut off the regeneration feed from the second pyrolysis reactor.

17. The pyrolysis system of claim 1, comprising subassembly containers, the subassembly containers comprising:
a pyrolysis reactor container comprising the pyrolysis reactor;
a product conditioning container comprising the plurality of separation components and the one or more heat exchange components; and
a solids handling container comprising the solids collection component.

18. A pyrolysis system comprising:
a pyrolysis reactor comprising a pyrolysis chamber configured to generate a product stream from a system feed, wherein the product stream comprises hydrogen gas, one or more organic compounds, and carbon; and
a plurality of separation components downstream from the pyrolysis reactor, wherein the plurality of separation components comprises:
one or more separation components, wherein a first separation component separates the carbon from the product stream, resulting in a gas product stream; and
an adsorption separation component, wherein the adsorption separation component comprises:
a first adsorption component comprising one or more adsorptive materials that are configured to remove the one or more organic compounds from the gas product stream,
a second adsorption component comprising one or more adsorptive materials that are configured to remove the one or more organic compounds from the gas product stream, and
a plurality of valves operably coupled to the first adsorption component and the second adsorption component, wherein the plurality of valves are configured to control a flow of the gas product stream and a flushing gas through the first adsorption component and the second adsorption component, and wherein the flushing gas is a process gas.

19. The pyrolysis system of claim 18, wherein the plurality of valves are configured to:
direct the flushing gas through the first adsorption component and/or the second adsorption component, wherein an output of the first adsorption component and/or the second adsorption component is a desorbed stream, the desorbed stream comprising the flushing gas and the one or more organic compounds.

20. The pyrolysis system of claim 19, wherein the plurality of valves are further configured to:
direct the desorbed stream back to the pyrolysis reactor, wherein the pyrolysis reactor is configured to use the desorbed stream in a chemical reaction, back to a burner coupled to the pyrolysis reactor and/or to an oxidizer.

21. A pyrolysis system comprising:
a pyrolysis reactor comprising a pyrolysis chamber configured to generate a product stream from a system feed, wherein the system feed comprises a hydrocarbon reactant, and wherein the product stream comprises hydrogen gas and carbon;
a regeneration feed, wherein the pyrolysis reactor is configured to react a regeneration input with residual carbon in the pyrolysis chamber to generate a regeneration effluent stream that is output from the pyrolysis reactor, and wherein only one of the system feed and the regeneration feed can be in the pyrolysis reactor at a time;
a plurality of valves configured to control a flow of the system feed into the pyrolysis reactor and a flow of the regeneration input into the pyrolysis reactor;
a burner coupled to the pyrolysis reactor;
one or more separation components downstream from the pyrolysis reactor, wherein at least one of the one or more separation components is configured to separate the carbon from the product stream.

22. The pyrolysis system of claim 21, wherein the plurality of valves comprise:
a first tight shut off valve and a first modulating valve operatively coupled to the system feed and the pyrolysis reactor; and
a second tight shut off valve and a second modulating valve operatively coupled to the regeneration feed and the pyrolysis reactor, wherein, when the second tight shut off valve is in an open position, the first tight shut off valve is in a closed position.

23. The pyrolysis system of claim 21, wherein steam generated from the burner is added into the regeneration input and/or used as the regeneration input.

24. The pyrolysis system of claim 21, further comprising:
a second pyrolysis reactor comprising a second pyrolysis chamber configured to generate the product stream from the system feed;
a second plurality of valves configured to control the flow of the system feed into the second pyrolysis reactor and the flow of the regeneration input into the pyrolysis reactor; and
a second burner coupled to the pyrolysis reactor.

25. The pyrolysis system of claim 24, wherein:
at a first time, the pyrolysis reactor is in a regeneration mode, wherein the plurality of valves are configured to close flow of the system feed into the pyrolysis reactor and open flow of the regeneration input into the pyrolysis reactor;
at the first time, the second pyrolysis reactor is in a pyrolysis mode, wherein the second plurality of valves are configured to open flow of the system feed into the second pyrolysis reactor and close flow of the regeneration input into the second pyrolysis reactor;
at a second time, the pyrolysis reactor is in the pyrolysis mode, wherein the plurality of valves are configured to open flow of the system feed into the pyrolysis reactor and close flow of the regeneration input into the pyrolysis reactor; and
at the second time, the second pyrolysis reactor is in the regeneration mode, wherein the second plurality of valves are configured to close flow of the system feed into the second pyrolysis reactor and open flow of the regeneration input into the second pyrolysis reactor.

26. A method of separating components of a product stream, the method comprising:
providing a pyrolysis system, the pyrolysis system comprising:
a pyrolysis reactor comprising a pyrolysis chamber configured to generate the product stream from a system feed, wherein the product stream comprises hydrogen gas and carbon,
a plurality of separation components configured to separate the product stream, wherein the plurality of separation components are downstream from the pyrolysis reactor,
one or more heat exchange components coupled to one or more of the plurality of separation components, and
a solids collection component coupled to one or more of the plurality of separation components; and
controlling a flow of the product stream through the pyrolysis system.

27. The method of claim 26, wherein:
the plurality of separation components comprises a first separation component and a second separation component;
the one or more heat exchange components comprises a first heat exchange component and a second heat exchange component; and
controlling the flow of the product stream comprises:
transmitting the product stream to the first heat exchange component, wherein the first heat exchange component cools the product stream to a first temperature that is suitable for the first separation component;
transmitting the product stream from the first heat exchange component to the first separation component, wherein the first separation component removes a first portion of the carbon from the product stream, and wherein the first portion of the carbon is carbon particles having a size greater than or equal to a first size;
transmitting the first portion of the carbon to the solids collection component;
transmitting the product stream from the first separation component to the second heat exchange component, wherein the second heat exchange component cools the product stream to a second temperature that is suitable for the second separation component;
transmitting the product stream from the second heat exchange component to the second separation component, wherein the second separation component removes a second portion of the carbon from the product stream, and wherein the second portion of the carbon is carbon particles having a size greater than or equal to a second size, the second size smaller than the first size;
transmitting the second portion of the carbon to the solids collection component; and
transmitting at least a portion of remaining product stream, wherein the remaining product stream comprises hydrogen gas, to the pyrolysis reactor.

28. The method of claim 26, wherein:
the plurality of separation components comprises an adsorption separation component, the adsorption separation component comprising an adsorption component and one or more valves; and
controlling the flow of the product stream comprises:
when the one or more valves are in a first position, transmitting the product stream to the adsorption component, wherein the adsorption component adsorbs one or more organic compounds from the product stream, and
when the one or more valves are in a second position, transmitting flushing gas to the adsorption component, wherein the flushing gas desorbs the one or more organic compounds from the adsorption component, and wherein the flushing gas is a process gas.

29. The method of claim 26, wherein the pyrolysis system further comprises a regeneration feed to react with residual carbon in the pyrolysis chamber, the method further comprising:
controlling inlet flows into the pyrolysis reactor, wherein controlling the inlet flows comprises:
controlling one or more valves to ensure that the system feed and the regeneration feed are separate and are not fed into the pyrolysis reactor at a same time.
